(19) United States
(12) Patent Application Publication
(10) Pub. No.: US 2026/0265085 A1
(43) Pub. Date: Sep. 10, 2026

(54) POROUS ORGANIC MATERIALS FOR IODINE REMEDIATION IN WATER

(71) Applicant: Trustees of Dartmouth College, Hanover, NH (US)

(72) Inventors: Chenfeng KE, St. Louis, MO (US); Mingshi ZHANG, West Lebanon, NH (US)

(21) Appl. No.: 18/873,500

(22) PCT Filed: Jun. 20, 2023
(86) PCT No.: PCT/US2023/068756

§ 371 Date: Dec. 10, 2024

Related U.S. Application Data
(60) Provisional application No. 63/353,413, filed on Jun. 17, 2022.

(51) Int. Cl. C02F 1/28; B01J 41/05; B01J 41/13; C02F 101/12; C08G 73/06; C08G 75/045

(52) U.S. Cl. CPC C02F 1/285; B01J 41/05; B01J 41/13; C08G 73/0644; C08G 75/045; C02F 2101/12

(57) ABSTRACT

An ionic porous organic framework (H_{C}OF-7) is provided to remove iodine residues (I₂ and I⁻), demonstrating high breakthrough volumes and wide working temperatures. The organic frameworks may be made from various components/monomers having the structures: “A groups,” and “B groups.” The A groups can be linked to B groups, and the A groups can be linked to other A groups via a counterion (e.g., NO₃⁻) or crosslinking groups having the structure:

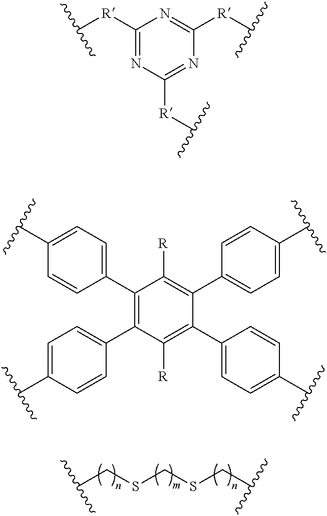

### CROSS REFERENCE TO RELATED APPLICATIONS

This application claims priority to U.S. Provisional Application No. 63/353,413, filed Jun. 17, 2022, the disclosure of which is incorporated herein by reference.

### STATEMENT REGARDING FEDERALLY SPONSORED RESEARCH

This invention was made with government support under grant 1844920 awarded by the National Science Foundation. The government has certain rights in the invention.

### BACKGROUND OF THE DISCLOSURE

Access to clean water has been a continuous demand for public health for thousands of years in human society, and civil engineered water treatment plants have been constructed worldwide for water purification. However, the need for disinfected water is still critical in areas such as remote places, extreme environments, locations with severe poverty, and outer space stations. In these places, iodine (I₂) is an effective broad-spectrum antimicrobial reagent used for water disinfection. For example, the United States Environmental Protection Agency recommends iodine as the emergency biocide for drinking water. The International Space Station employs iodine (in the form of I₂/KI) in the portable water dispenser (PWD) system for disinfection. The residual iodine in water (5-16 mg/L or ppm) after the treatment needs to be removed due to its negative metabolic effects and its astringent taste. These iodine residues are currently removed by a composite column packed with active charcoal/ion-exchange resin. However, the narrow working temperature of these columns (e.g., below 50° C. for the resin used for I⁻ exchange) and the limited iodine/iodide breakthrough capacity stipulates the development of porous materials with wide working temperature (up to 90° C.), good iodine removal efficiency at low concentrations (~5 ppm), and high breakthrough capacities.

Iodine is widely used as an antimicrobial reagent for water disinfection in the wilderness and outer space, but residual iodine and iodide need to be removed for health reasons. Currently, it is challenging to remove low concentrations of iodine and iodide in water (~5 ppm). Furthermore, the remediation of iodine and iodide across a broad temperature range (up to 90° C.) has not previously been investigated.

Recently, a series of porous materials such as metal-organic frameworks (MOFs), covalent organic frameworks (COFs), and porous organic polymers (POPs) have been developed for iodine removal. In most cases, these porous materials demonstrated high capacitive iodine adsorptions at high iodine concentrations in the vapor phase, and limited progress had been achieved for low iodine residues. High capacitive iodine removal in the aqueous environment using hydrogen-bonded crosslinked organic frameworks, COFs, and POPs at ambient conditions has been previously shown. In these investigations, I⁻ is introduced to stabilize I₂ in water via the I₂+I⁻ [symbol] I₃⁻ equilibrium, but porous organic materials remove iodine (I₂) only at high concentrations (>>100 ppm) from water. These concentrations are much higher than the iodine residual levels (5-16 ppm) in treated drinking water.

### SUMMARY OF THE DISCLOSURE

The present disclosure provides a nitrate dimer-directed synthesis of a single-crystalline ionic hydrogen-bonded crosslinked organic framework (H_{C}OF-7). H_{C}OF-7 removes iodine and iodide species in water efficiently through halogen bonding and anion exchange, reducing the total iodine concentration to 0.22 ppm at room temperature. Packed H_{C}OF-7 columns were employed for iodine/iodide breakthrough experiments between 23 and 90° C., and large breakthrough volumes were recorded (>18.3 L/g). The high iodine/iodide removal benchmarks recorded under practical conditions make H_{C}OF-7 a promising adsorbent for water treatment.

The present disclosure also uses melaminium moieties to construct an ionic H_{C}OF-7 for simultaneous iodine and iodide removal. H_{C}OF-7 adsorbs iodine through halogen bonding interactions and iodide via anion exchange. First, molecular precursor 1 possessing four allyl-melamine arms was synthesized and co-crystallized with nitric acid to form 1·4H⁺·4NO₃⁻. Then, these melaminium-based single crystals were converted to single-crystalline ionic H_{C}OF-7 (FIG. 1) through a photo-irradiated thiol-ene single-crystal to single-crystal (SCSC) transformation. The porous architecture was stabilized after thiol-ene crosslinking. The crystal structure of H_{C}OF-7 revealed that it is the first porous organic network connected through nitrate dimers. These nitrate dimers are hydrogen-bonded with melaminium moieties in H_{C}OF-7. H_{C}OF-7 removes I₂ and/or I⁻ species in aqueous solutions, and the NO₃⁻/I⁻ anion exchange is more effective when I₂·H_{C}OF-7 is used. At a 5 ppm dosing concentration of I₂/I⁻, H_{C}OF-7 reduced the residual I₂/I⁻ concentrations to 0.22 ppm at 23° C. and 0.45 ppm at 90° C., demonstrating excellent iodine/iodide removal efficiencies at a wide range of temperatures. H_{C}OF-7 columns showed high breakthrough volumes when iodinated water (5 ppm of I₂/I⁻) was passed through, recorded as 20.0 L/g at 23° C. and 18.3 L/g at 90° C. These benchmarks are significantly higher than any reported porous framework materials or porous polymers, demonstrating H_{C}OF-7's promising potential for practical considerations.

Also provided is an ionic hydrogen-bonded crosslinked organic framework H_{C}OF-7 through anion dimer-directed assembly followed by thiol-ene single-crystal to single-crystal transformation. H_{C}OF-7 shows significantly enhanced chemical stability compared to its molecular precursor crystal, which is attributed to the added ethanedithioether crosslinks. This ionic H_{C}OF-7 possesses 1D porous channels, strong iodine-binding melaminium moieties, and nitrate dimers for anion exchange. As a result, H_{C}OF-7 uptakes iodine and iodide collectively in the aqueous environment under a wide range of working temperatures (23-90° C.). H_{C}OF-7 demonstrates excellent total iodine residue removal capability at low concentrations of iodine and iodide—the total residual iodine concentration was measured as low as 0.22 ppm from an intake of 5 ppm iodine/iodide solution. Packed H_{C}OF-7 columns showed large breakthrough volumes (18.3 to 20.3 L/g) in the dynamic adsorption experiments at different temperatures. The benchmarks for iodine and iodide removal were set using porous organic framework materials at different temperatures. This feature is particularly important for potential uses in extreme environments like the wild field or space stations.

### BRIEF DESCRIPTION OF THE FIGURES

For a fuller understanding of the nature and objects of the disclosure, reference should be made to the following detailed description taken in conjunction with the accompanying figures.

FIG. 1. Schematic representation of a synergistic I₂/I⁻ removal in water using an ionic H_{C}OF-7.

FIG. 2. (a) The chemical structure of 1, (b) its solid-state structure, and (c) super-structure. (d) The chemical structure of 1·4H⁺·4NO₃⁻, (e) its solid-state structure, and (f) super-structure. (g) The nitrate dimer-directed hydrogen-bonding joint formed between two repulsive nitrate anions and four melaminium arms. (h) The flu topology of 1·4H⁺·4NO₃⁻_{crystal}. (i) Highlighted void space of 1·4H⁺·4NO₃⁻ crystal.

FIG. 3. (a) Synthesis of H_{C}OF-7 via an SCSC thiol-ene crosslinking. (b) Stacked FT-IR spectra of 1, 1·4H⁺·4NO₃⁻_{crystal}, and H_{C}OF-7. (c) Stacked Raman spectra of 1·4H⁺·4NO₃⁻_{crystal} and H_{C}OF-7. (d) Stacked ¹³C solution NMR spectrum of 1·4H⁺·4NO₃⁻ in DMSO-d₆ (bottom, 150 MHz, 298 K) and solid-state ¹³C cross-polarization magic angle spinning NMR spectrum of H_{C}OF-7 (100 MHz, 298 K). (e) Simulated and experimental PXRD profiles of 1·4H⁺·4NO₃⁻_{crystal} and H_{C}OF-7, respectively.

FIG. 4. (a) Crystal structure of H_{C}OF-7 with dithioether crosslinkages and nitrate dimer highlighted in ball-stick model. (b) Overlaid structures of 1·4H⁺·4NO₃⁻_{crystal} and H_{C}OF-7. Hydrogen atoms are omitted for clarity. (c) Covalent connections in H_{C}OF-7. Nitrate anions and hydrogens are omitted for clarity. (d) Highlighted void spaces of H_{C}OF-7.

FIG. 5. (a) Time-dependent iodine/triiodide adsorption of H_{C}OF-7 measured at different temperatures (23, 40, 50, 90° C.) using UV-Vis spectroscopy by monitoring the absorption band at 292 nm. Inset: fitted reaction rate versus the inverse temperature. (b) The weight-increased amounts of H_{C}OF-7, CHOP-7, and activated carbon after total uptake measured at different temperatures. (c) The I⁻ exchange efficiency measured using H_{C}OF-7 and 12·H_{C}OF-7 samples (0.1-0.3 g/g of I₂ per H_{C}OF-7). The confidence coefficient p was obtained using Tukey's honest significance test. (d) Measured concentrations of total residual iodine (input: I₂+KI, 3.5+1.5 ppm) before and after adsorption using H_{C}OF-7 (6 mg) in deionized (DI) water in the presence of NO₃⁻ (5 ppm), H₂PO₄⁻ (5 ppm), SO₄²⁻ (20 ppm), Cl⁻ (80 ppm), HCO₃⁻ (60 ppm), and their mixture. (e) Experimental setup of the temperature-controlled iodine/iodide breakthrough analysis. Iodinated DI or tap water (I₂+KI, 3.5+1.5 ppm) was pumped into a customized steel pre-column (d: 50×1: 220 mm) and heated to the desired temperatures under continuous flow (5 mL/min). After passing through the H_{C}OF-7 column (d: 4.5×1: 27 mm), the deiodinated water was collected by a fraction collector. (f) The total residual iodine (I₂+I⁻) concentrations measured in the breakthrough experiments. Each column was packed with 240 mg of H_{C}OF-7, activated carbon, or mixed-bed activated carbon/anion exchange resin.

FIG. 6. (a-c) The pcu topology of 1_{crystal} crystal along the a-, b-, and c-axis, respectively. Monomer 1 monomer is defined as a six-connected node for constructing the hydrogen-bonded network.

FIG. 7. (a) Molecular structure of 1_{crystal} (b) The head-to-head and side-to-side hydrogen-bonding interactions of DAT functional groups with chemical formula diagram. (c) The hydrogen-bonding connection between 1 (d) The 2×2×2 packing of 1_{crystal} viewed along the a-axis (void space: 10.8%).

FIG. 8. ¹H NMR spectra (500 MHz, DMSO-d₆, 298 K) of 1 and 1·4H⁺·4NO₃⁻_{crystal}.

FIG. 9. TGA profiles of 1, 1·4H⁺·4NO₃⁻_{crystal}, and H_{C}OF-7 (heating rate: 10° C./min) under an N₂ atmosphere.

FIG. 10. PXRD profiles of the simulated 1·4H⁺·4NO₃⁻_{crystal} and the experimental data of 1·4H⁺·4NO₃⁻_{crystal} after being immersed in different solvents for 24 h and dried in the open air for I₂ h.

FIG. 11. (a) Overlaid molecular structures and (b) the 1×1×1 packing of 1_{crystal} and 1·4H⁺·4NO₃⁻_{crystal}.

FIG. 12. (a) Asymmetric unit and (b) the molecular structure of 1·4H⁺·4NO₃⁻_{crystal} (c-f) The allyl groups with the distance between 4 to 10 Ain 1·4H⁺·4NO₃⁻ crystal, which could possibly be crosslinked by EDT.

FIG. 13. (a) Molecular structure of 1·4H⁺·4NO₃⁻_{crystal} (b) The 2×2×2 packing of 1·4H⁺·4NO₃⁻_{crystal} viewed along the a-axis with crosslinking active sites highlighted as red balls. (Void space: 35.6%) (c) The nitrate dimer connecting four 1·4H⁺ monomers with nitrate dimer highlighted. (d) The mode of interactions between nitrate dimer with melaminium functional groups. (e) The nitrate dimer connecting a 2D chain in 1·4H⁺·4NO₃⁻ crystal.

FIG. 14. (a-c) The flu topology of 1·4H⁺·4NO₃⁻_{crystal} along the a-, b-, and c-axis, respectively. The nitrate dimer is defined as a four-connected linker and 1·4H⁺ as a six-connected node for constructing the hydrogen-bonded network.

FIG. 15. ¹H NMR spectra (500 MHz, DMSO-d₆, 298 K) of 1·4H⁺·4NO₃⁻ crystal after solvent exchange by THE and cyclohexane.

FIG. 16. ¹H NMR spectra (500 MHz, DMSO-d₆, 298 K) of 1·4H⁺·4NO₃⁻_{crystal} after EDT diffusion. The ratio of [1·4H⁺]:[EDT]:[consumed allyl]:[unreacted allyl] is measured as 1:2.2:3:5.

FIG. 17. ¹H NMR spectrum of H_{C}OF-7 soluble residue after crosslinking. Single crystals of H_{C}OF-7 (~5 mg) were added to 0.5 mL boiling DMSO-d₆ to extract any unreacted species. Only trace organic residues were noticed in the ¹H NMR spectrum.

FIG. 18. PXRD profiles of H_{C}OF-7 after being immersed in various solvents for 24 h, followed by vacuuming (8.0 Pa) for 24 h.

FIG. 19. (a) The asymmetric unit of H_{C}OF-7 containing half of the 1-like moiety, two nitrate anions, one and half of cyclohexane, and dithioether linkages. Three of the four alkylthioether chains are disordered over two positions, and the disordered components are labelled. (b) Distances of a partially assigned thioether linkage (one S and one C atoms) to the nearby alkyl carbon atoms in the H_{C}OF-7 crystal structure. The C—C distance between the C34A-C19 is 6.65 Å. Since these carbon atoms are located on the pore surface, they are disordered over several positions. Although there was no discovery of discrete electron densities to bridge the partially assigned thioether linkage, the short distance between C34A and C49 (3.75 Å) suggests a disordered linkage connecting C19 and C34A.

FIG. 20. Different crosslinking connections in H_{C}OF-7. (a) A fraction of the EDT is intramolecularly connected. (b) Intermolecular connections in H_{C}OF-7, where one arm extends the network along the 100 axis (blue colored) and another extends along the 001 axis (cyan colored). (c) The packing structure of H_{C}OF-7 viewed along the 100 axis. EDT is shown in the ball-and-stick model, and other atoms are shown in capped stick model. Hydrogen atoms, solvent molecules, and anions are omitted for clarity.

FIG. 21. (a-c) The (4⁴·8¹⁶·12⁸)(4)₄ topology of H_{C}OF-7 along the a-, b-, and c-axis, respectively. The protonated pentaphenyl core and the dithioether moieties are defined as an eight-connected node and two-connected linkers, respectively.

FIG. 22. FT-IR spectra of compound 1, 1-EDT polymer, CHOP-7, and H_{C}OF-7.

FIG. 23. (a) TGA profiles of 1 and 1-EDT polymer (heating rate: 10° C. /min) under an N₂ atmosphere. (b) TGA profiles of CHOP-7 and H_{C}OF-7 (heating rate: 10° C. /min) under an N₂ atmosphere.

FIG. 24. CO₂ sorption isotherm of H_{C}OF-7 recorded at 298 K.

FIG. 25. MeOH sorption isotherm of H_{C}OF-7 recorded at 298 K.

FIG. 26. (a) UV/Vis spectra of the standard iodide solution after 10 min reaction time with Leuco-crystal violet and N-chlorosuccinimide. (b) The linear fit of absorbance at 592 nm of standard iodide solution after 10 min of reaction time with Leuco-crystal violet and N-Chlorosuccinimide.

FIG. 27. UV/Vis spectra of the 0.07 mM KI solution, 0.07 mM KNO₃ solution, and the mixture of (0.07 mM KI+0.07 mM KNO₃).

FIG. 28. The UV/Vis spectra of an I₂ solution (0.59 mM, H₂O/MeOH=99:1) in the presence of 0-12 equivalents of KI.

FIG. 29. The UV/Vis absorbances of I₂ (0.59 mM) with 0-12 equivalent of KI measured at 292 nm and 354 nm. The equilibrium constant calculated as 816 M⁻¹ and 782 M⁻¹ at 292 nm and 354 nm, respectively. The averaged equilibrium constant is 792±20 M⁻¹.

FIG. 30. The time-dependent UV/Vis absorbance at 292 nm of I₂/I⁻ aqueous solution (0.12 mM 12, 0.5 mM KI, 292 nm) in the presence of 10 mg H_{C}OF-7 under different temperatures.

FIG. 31. (a) Time-dependent UV/Vis spectra of I₂/KI solution (I₂: 0.12 mM, KI: 0.50 mM, 15 mL) in presence of H_{C}OF-7 (10 mg) under 23° C. (b) Pseudo-first-order fitting of total iodine adsorption at 23° C. by monitoring the absorption band at 292 nm, k=(2.59±0.01)×10⁻⁴ s⁻¹.

FIG. 32. (a) Time-dependent UV/Vis spectra of 12/KI solution (I₂: 0.12 mM, KI: 0.50 mM, 15 mL) in presence of H_{C}OF-7 (10 mg) under 40° C. (b) Pseudo-first-order fitting of total iodine adsorption at 40° C. by monitoring the absorption band at 292 nm, k=(9.06±0.14)×10⁻⁴ s⁻¹.

FIG. 33. (a) Time-dependent UV/Vis spectra of I₂/KI solution (I₂: 0.12 mM, KI: 0.50 mM, 15 mL) in presence of H_{C}OF-7 (10 mg) under 50° C. (b) Pseudo-first-order fitting of total iodine adsorption at 50° C. by monitoring the absorption band at 292 nm, k=(1.34±0.03)×10⁻³ s⁻¹.

FIG. 34. (a) Time-dependent UV/Vis spectra of I₂/KI solution (I₂: 0.12 mM, KI: 0.50 mM, 15 mL) in presence of H_{C}OF-7 (10 mg) under 90° C. (b) Pseudo-first-order fitting of total iodine adsorption at 90° C. by monitoring the absorption band at 292 nm, k=(3.94+0.10)×10⁻³ s⁻¹.

FIG. 35. Arrhenius-equation fitted data of total iodine adsorption (Eₐ=35.3±6.0 kJ/mol).

FIG. 36. (a) time-dependent UV/Vis spectra of an I₂ aqueous solution (0.59 mM) in presence of H_{C}OF-7 (10 mg). (b) Fitted pseudo-first-order plot for I₂ adsorption monitored at 460 nm, k=(6.65+0.30)×10⁻⁴ s⁻¹.

FIG. 37. (a) Time-dependent UV/Vis spectra of I₂/KI aqueous solution (0.59 mM 12+0.59 mM KI) in presence of H_{C}OF-7 (10 mg). (b) Fitted pseudo-first-order plot for iodine (I₂ and I₃⁻) adsorption monitored at 460 nm, k=(6.11+0.23)×10⁻⁴ s⁻¹. (c) Fitted pseudo-first-order plot for iodine (I₂ and I₃⁻) monitored at 400 nm, k=(6.20+0.12)×10⁻⁴ s⁻¹.

FIG. 38. (a) Time-dependent UV/Vis spectra of I₂/KI aqueous solution (0.59 mM 12+1.18 mM KI) in presence of H_{C}OF-7 (10 mg). (b) Fitted pseudo-first-order plot for iodine (I₂ and I₃⁻) adsorption monitored at 460 nm, k=(5.93+0.21)×10⁻⁴ s⁻¹. (c) Fitted pseudo-first-order plot for iodine (I₂ and I₃⁻) monitored at 400 nm, k=(6.30+0.05)×10⁻⁴ s⁻¹.

FIG. 39. (a) Time-dependent UV/Vis spectra of I₂/KI aqueous solution (0.59 mM 12+7.08 mM KI) in presence of H_{C}OF-7 (10 mg). (b) Fitted pseudo-first-order plot for iodine (I₂ and I₃⁻) adsorption monitored at 460 nm, k=(2.97±0.06)×10⁻⁴ s⁻¹. (c) Fitted pseudo-first-order plot for iodine (I₂ and I₃⁻) adsorption monitored at 400 nm, k=(2.93±0.06)×10⁻⁴ s⁻¹.

FIG. 40. (a) UV/Vis spectra of I₂ aqueous solution (0.79 mM) before and after H_{C}OF-7 (5 mg) addition using a 1 cm cuvette. (b-d) UV/Vis spectra of 12/KI aqueous solution (0.79 mM 12, b: 1.58 mM KI, c: 3.95 mM KI, d: 9.48 mM KI) before and after H_{C}OF-7 (5 mg) addition using a 0.1 cm cuvette.

FIG. 41. UV/Vis spectra of 3.5 mM KI solutions before and after I⁻ exchange in the presence of H_{C}OF-7 (5 mg). The solutions were diluted 50 times before the measurements.

FIG. 42. I⁻ exchange amount for H_{C}OF-7 (5 mg) in 3.5 mM KI solutions at 23° C., 50° C., and 90° C.

FIG. 43. FT-IR spectra of (a) H_{C}OF-7, (b) H_{C}OF-7 after 12/KI adsorption, (c) H_{C}OF-7 after 12/KI removal and deprotonation, and (d) H_{C}OF-7 after HNO₃ re-protonation.

FIG. 44. PXRD profiles of (a) H_{C}OF-7, (b) H_{C}OF-7 after I₂/KI adsorption, and (c) H_{C}OF-7 after I₂/KI removal and HNO₃ re-protonation.

FIG. 45. UV/Vis spectra of 0.1, 0.2 and 0.3 g/L of I₂ solution (5 mL) before and after H_{C}OF-7 (5 mg) adsorption.

FIG. 46. UV/Vis spectra of the 3.5 mM KI solution before and after adsorbing by H_{C}OF-7, I₂·HOF-7 (0.1 g/g), I₂·HOF-7 (0.2 g/g), I₂·H_{C}OF-7 (0.3 g/g) at 23° C. The samples were diluted 50 times before the measurement.

FIG. 47. Raman spectra of (a) H_{C}OF-7, (b) H_{C}OF-7 after soaking in 12/KI solution (I₂: 0.87 M, KI: 1.02 M, 3 mL) for 72 h, and (c) H_{C}OF-7 after exposed to I₂ vapor (45° C.) for 72 h.

FIG. 48. PXRD profiles of as-synthesized H_{C}OF, H_{C}OF-7 after ball milling, and H_{C}OF-7 after the (3.5 ppm 12+1.5 ppm I⁻) breakthrough experiment and after I⁻ (3.5 mM) exchange.

FIG. 49. Red: the total residual iodine [I₂+I⁻ ] concentrations after the adsorption of H_{C}OF-7 (6 mg) from a mixture of 12/KI aqueous solutions (3.5 mg/L 12+1.5 mg/L I⁻) at different temperatures. Blue: the total residual iodine [I₂+I⁻ ] concentrations after the adsorption of H_{C}OF-7 (6 mg) from KI aqueous solutions (1.5 mg/L I⁻) at different temperatures. Black: the total residual iodine [I₂+I⁻ ] concentrations after adsorption of CHOP-7 (10 mg) from a mixture of 12/KI aqueous solutions (3.5 mg/L 12+1.5 mg/L I⁻) at different temperatures.

FIG. 50. ¹H NMR spectra (500 MHz, DMSO-d₆) of compound 2 (17.2 mM, 0.5 mL DMSO-d₆) titrated with a DMSO-d₆ solution of iodine (0.858 M). From bottom to top: 2 only, 2+14.0 equivalents of iodine.

FIG. 51. ¹H NMR spectra (500 MHz, CD₃CN/DMSO-d₆ 4:1) of compound 2 (8.6 mM, 0.4 mL CD₃CN+0.1 mL DMSO-d₆) compound 2·4H⁺·4NO₃⁻ (8.6 mM, 0.4 mL CD₃CN+0.1 mL DMSO-d₆).

FIG. 52. ¹H NMR spectra (500 MHz, CD₃CN/DMSO-d₆ 4:1) of compound 2·4H⁺·4NO₃⁻ (8.6 mM, 0.4 mL CD₃CN+0.1 mL DMSO-d₆) titrated with a DMSO-d₆ solution of iodine (0.429 M). From bottom to top: 2 only, 2+18.0 equivalents of iodine.

FIG. 53. Measured concentrations of total residual iodine (input: 5 ppm of I₂+I⁻) before and after static adsorption using H_{C}OF-7 (6 mg) in deionized (DI) water in the presence of NO₃⁻ (5 ppm), H₂PO₄⁻ (5 ppm), SO₄²⁻ (20 ppm), Cl⁻ (80 ppm), HCO₃⁻(60 ppm), and their mixture.

FIG. 54. Image of iodine solution (35 mg/L I₂+15 mg/L I⁻) before and after through H_{C}OF-7 column.

FIG. 55. Images of H_{C}OF-7 column before and after the iodine residue removal breakthrough experiment.

FIG. 56. The total residual iodine (I₂+I⁻) concentration of a used I₂/I⁻ H_{C}OF-7 column upon 1 L of tap water passing through at 23° C. flow speed: 5 mL/min.

FIG. 57. ¹H NMR spectrum of S1 in DMSO-d₆ (500 MHz) recorded at 298 K.

FIG. 58. ¹³C NMR spectrum of S1 in DMSO-d₆ (150 MHz) recorded at 298 K.

FIG. 59. ¹H NMR spectrum of S2 in DMSO-d₆ (500 MHz) recorded at 298 K.

FIG. 60. ¹³C NMR spectrum of S2 in DMSO-d₆ (150 MHz) recorded at 298 K.

FIG. 61. ESI-HRMS spectrum of S2.

FIG. 62. ¹H NMR spectrum of S3 in DMSO-d₆ (500 MHz) recorded at 298 K.

FIG. 63. ¹³C NMR spectrum of S3 in DMSO-d₆ (150 MHz) recorded at 298 K.

FIG. 64. ESI-HRMS spectrum of S3.

FIG. 65. ¹H NMR spectrum of 1 in DMSO-d₆ (500 MHz) recorded at 298 K.

FIG. 66. ¹³C NMR spectrum of 1 in DMSO-d₆ (150 MHz) recorded at 298 K.

FIG. 67. ESI-HRMS spectrum of 1.

FIG. 68. ¹H NMR spectrum of 14H⁺·4NO₃⁻_{crystal} in DMSO-d₆ (500 MHz) recorded at 298 K.

FIG. 69. ¹³C NMR spectrum of 1·4H⁺·4NO₃⁻_{crystal} in DMSO-d₆ (150 MHz) recorded at 298 K.

FIG. 70. ¹H NMR spectrum of 2 in DMSO-d₆ (500 MHz) recorded at 298 K.

FIG. 71. ¹H-¹³C HSQC NMR spectrum (500 MHz, DMSO-d₆) of 1 recorded at 298 K.

FIG. 72. A schematic representation of iodine disinfection and residual iodine removal using ionic H_{C}OF-7.

FIG. 73. Iodine uptake amount for H_{C}OF-7, activated carbon and H_{C}OP-7 at different temperatures. H_{C}OP-7 is also referred to as “CHOP-7” herein.

FIG. 74. The residual concentration of [I₂+I⁻ ] after H_{C}OF-7 adsorption from a mixture of (3.5 mg/L 12+1.5 mg/L I⁻) solution and 1.5 mg/L I⁻ aqueous solution at different temperatures.

FIG. 75. The residual concentration of [I₂+I⁻ ] after H_{C}OF-7 and H_{C}OP-7 adsorption from a mixture of (3.5 mg/L 12+1.5 mg/L I⁻) solution at different temperatures.

FIG. 76. I⁻ uptake amount for H_{C}OF-7 at different temperatures.

FIG. 77. Iodine adsorption for H_{C}OF-7 at different initial concentrations.

FIG. 78. Langmuir model fitting of iodine adsorption for H_{C}OF-7 (qₘₐₓ=722.2 mg/g, K=4.19×10⁻³ L/mg).

FIG. 79. Raman spectrum of H_{C}OF-7 after I₂ and I⁻ uptake.

FIG. 80. The residual concentrations of total iodine (I₂+I⁻) in water after passing through the H_{C}OF-7, activated carbon, and the mixture-bed columns measured using the Leuco-crystal violet method. Iodinated water (I₂+KI, 3.5+1.5 ppm) was pumped into a customized steel precolumn (d: 50×1: 220 mm) and heated to the desired temperatures under continuous flow (5 mL/min).

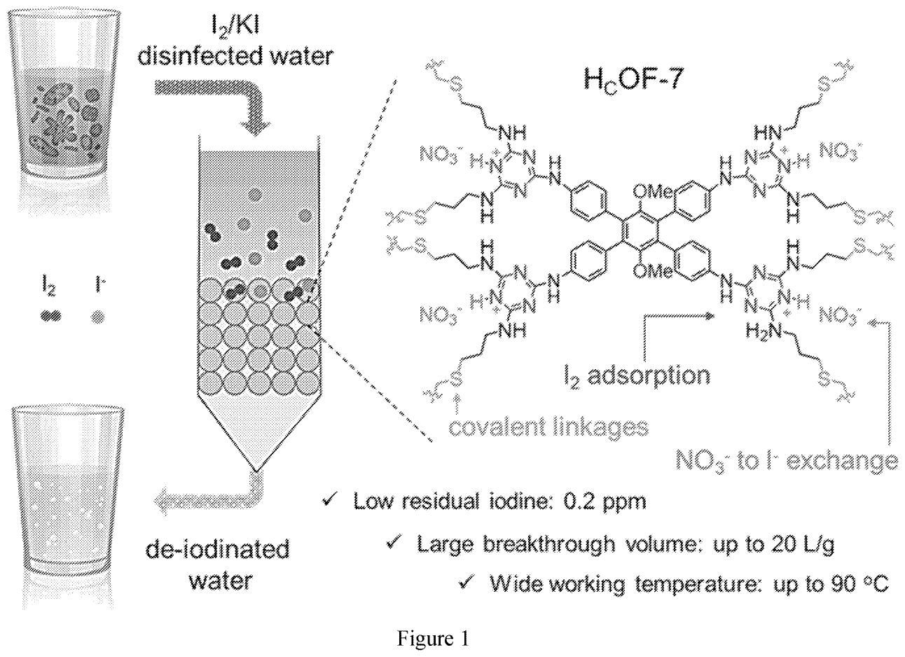

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups include:

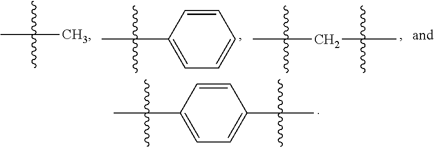

As used herein, unless otherwise indicated, the term “aliphatic groups” refers to branched or unbranched hydrocarbon groups that, optionally, contain one or more degrees of unsaturation. Degrees of unsaturation include, but are not limited to, alkenyl groups, alkynyl groups, and aliphatic cyclic groups. Aliphatic groups may be a C₁ to C₂₀ aliphatic group, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀). Aliphatic groups may be unsubstituted or substituted with one or more substituents. Examples of substituents include, but are not limited to, heteroatoms (e.g., —O, —S, —N, —P), halogens (—F, —Cl, —Br, and —I), aliphatic groups (e.g., alkyl groups, alkenyl groups, alkynyl groups, and the like), halogenated aliphatic groups (e.g., trifluoromethyl group and the like), aryl groups, halogenated aryl groups, alkoxide groups, amine groups, nitro groups, carboxylate groups, carboxylic acids, ether groups, thioether or sulfide groups, alcohol groups, alkyne groups (e.g., acetylenyl groups and the like), and the like, and combinations thereof. Aliphatic groups may be alkyl groups, alkenyl groups, alkynyl groups, or carbocyclic groups, and the like.

As used herein, unless otherwise indicated, the term “alkyl group” refers to branched or unbranched saturated hydrocarbon groups. Examples of alkyl groups include, but are not limited to, methyl groups, ethyl groups, propyl groups, butyl groups, isopropyl groups, tert-butyl groups, and the like. For example, the alkyl group is C₁ to C₂₀, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀). The alkyl group may be unsubstituted or substituted with one or more substituents. Examples of substituents include, but are not limited to, various substituents such as, for example, halogens (—F, —Cl, —Br, and —I), aliphatic groups (e.g., alkyl groups, alkenyl groups, alkynyl groups, and the like), aryl groups, alkoxide groups, carboxylate groups, carboxylic acids, ether groups, amine groups, and the like, and combinations thereof.

The present disclosure provides organic frameworks. The organic frameworks comprise, consistent essentially of, or consist of a plurality of linked monomers. The monomers may be linked covalently and/or ionically. Also disclosed are articles comprising the organic frameworks, methods of making the organic frameworks, and methods of using the organic frameworks. The organic frameworks may be used to remove I₂ and I⁻ from a medium (e.g., water).

Iodine is widely used as an antimicrobial reagent for water disinfection in extreme environments (e.g., wild fields and outer space), but the residual iodine needs to be removed for health reasons. However, it is challenging to remove these residues due to the low concentration of iodine and iodides (~5 ppm), especially across a broad temperature range (up to 90° C.). This work provided the development of a single-crystalline ionic hydrogen-bonded crosslinked organic framework (H_{C}OF-7), which was synthesized through a nitrate dimer-templated crystallization, followed by single-crystal to single-crystal crosslinking. H_{C}OF-7 removes iodine and iodide species in water through halogen bonding interactions and anion exchange. Furthermore, the adsorbed iodine in H_{C}OF-7 promotes the anion exchange, effectively reducing the total iodine residues from 5 to 0.22 ppm at room temperature. The packed H_{C}OF-7 columns were employed for iodine breakthrough experiments between 23-90° C., and large breakthrough volumes were recorded (20.3-18.3-L/g), respectively. These results provide design principles for a collective removal of neutral and anionic iodine residues in the aqueous environment at low concentrations. This work also sets up benchmarks using porous framework materials for drinking water disinfection and iodine removal for practical uses.

In an aspect, the present disclosure provides organic frameworks. The organic frameworks may be crystalline and be a plurality of single crystals. The organic frameworks have a hydrogen-bonded network that may help define the dimensions of the apertures defined by the monomeric units of the organic frameworks.

The organic frameworks may be made from various components/monomers. For example, a monomer may comprise a plurality of the following group:

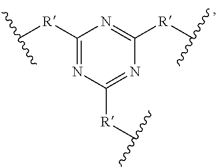

which may be referred to as “A groups,” where R′ is —NH— or —O—. One or more A groups may be covalently attached to:

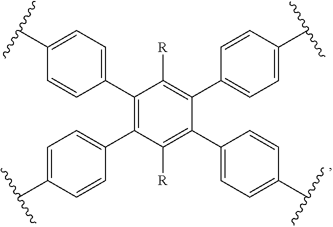

which may be referred to as “B groups,” where each R may individually be chosen from hydrogen, methoxy groups, ethoxy groups, alkoxy groups, alkylamino groups, alkyl ester groups, and alkyl groups. For example, the B groups may have the following structure:

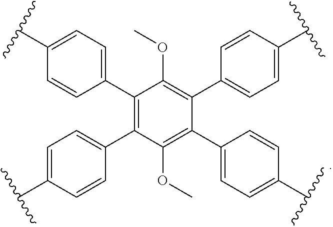 [SMILES: *c1ccc(-c2c(OC)c(-c3ccc(*)cc3)c(-c3ccc(*)cc3)c(OC)c2-c2ccc(*)cc2)cc1]

The A groups may further be covalently attached to one or more other A groups (which are attached to other B groups) via a crosslinking group and/or ionically bound via a counterion (e.g., NO₃⁻). The crosslinking group may have the following structure:

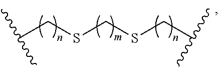

wherein n is 2 to 8 and m is 1 to 8. In various embodiments, the crosslinking groups have the following structure:

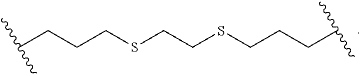 [SMILES: *CCCSCCSCCC*]

Other non-limiting examples of crosslinking groups include:

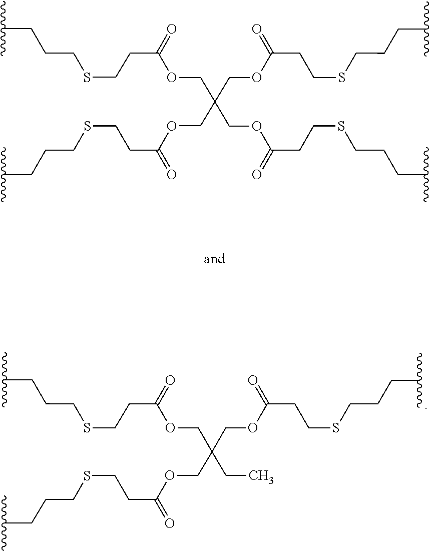 [SMILES: *CCCSCCC(=O)OCC(COC(=O)CCSCCC*)(COC(=O)CCSCCC*)COC(=O)CCSCCC* ; *CCCSCCC(=O)OCC(CC)(COC(=O)CCSCCC*)COC(=O)CCSCCC*]

Each A group may be attached by one or two crosslinking groups to other A groups. The counterions may be exchanged with other counterions after covalent crosslinking.

In various embodiments, the A groups may be crosslinked by various ions. For example, the monomers are ionically crosslinked prior to covalent crosslinking. The ions may be anions. For example, the ions are NO₃⁻ groups. Other examples of anions include, but are not limited to, SO₄²⁻, CO₃²⁻, HSO₄⁻, HCO₃⁻, H₂PO₄⁻, HPO₄²⁻, PO₄³⁻, Cl⁻, F⁻, and Br⁻. These ions may be replaced or exchanged following covalent crosslinking. For example, ions (e.g., nitrate ions) may be replaced with I₂ and/or I⁻ following covalent crosslinking.

The orientation of the monomers in the organic framework defines one or more apertures. The apertures may have various dimensions (e.g., a longest linear dimension, such as, for example, a diameter). The apertures may or may not be uniformly shaped. For example, each aperture may have a longest linear dimension may be 3-15 Å, including all 0.1 Å values and ranges therebetween (e.g., 3, 4, 5, 6, 7, 8, 9, 10, 11, 12, 13, 14, or 15 Å). In various embodiments, one or more of the apertures have are about 6 Å×I₂ Å. Ions may be in the void of the aperture. The size of the aperture may be controlled during crystallization of the monomers. For example, crystallization with different solvents will result in different sized apertures. Different ions may affect the size of the aperture.

The organic framework may be crystalline. The crystals may be single crystals. The crystal system may be a triclinic crystal system. It may have a P-1 space group. In other embodiments, the crystal system may be a monoclinic crystal system and have a P2₁/cspace group. The crystal system and space group is determined by the solvent used during crystallization. In various embodiments, the organic frameworks of the present disclosure do not comprise amorphous domains. In various embodiments, the organic frameworks are at least 90% (e.g., 90%, 91%, 92%, 93%, 94%, 95%, 96%, 97%, 98% and 99%). In various embodiments, the organic frameworks are greater than 99% crystalline. In other embodiments, such as, for example, CHOP-7 embodiments, the organic frameworks may be up to 100% amorphous, or they may be 100% amorphous.

In an aspect, the present disclosure provides methods of making organic frameworks of the present disclosure. The methods for making the organic frameworks are described herein.

In various embodiments, a method for making an organic framework comprises reacting

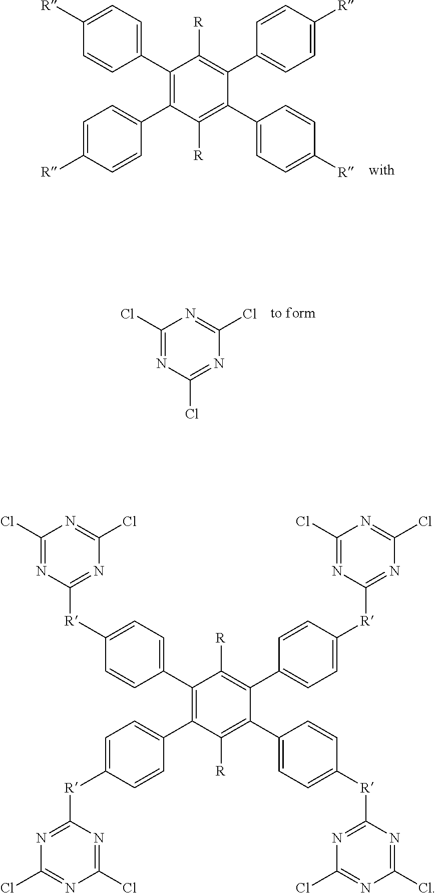

The reaction may be performed under basic conditions (e.g., a reaction mixture comprising K₂CO₃ in THE at 0° C.). R may be individually chosen from hydrogen, methoxy groups, ethoxy groups, alkoxy groups, alkylamino groups, alkyl ester groups, and alkyl groups. Each R′ may independently be —NH— or —O—. Each R″ may independently be —NH₂ and —OH. The method further comprises reacting

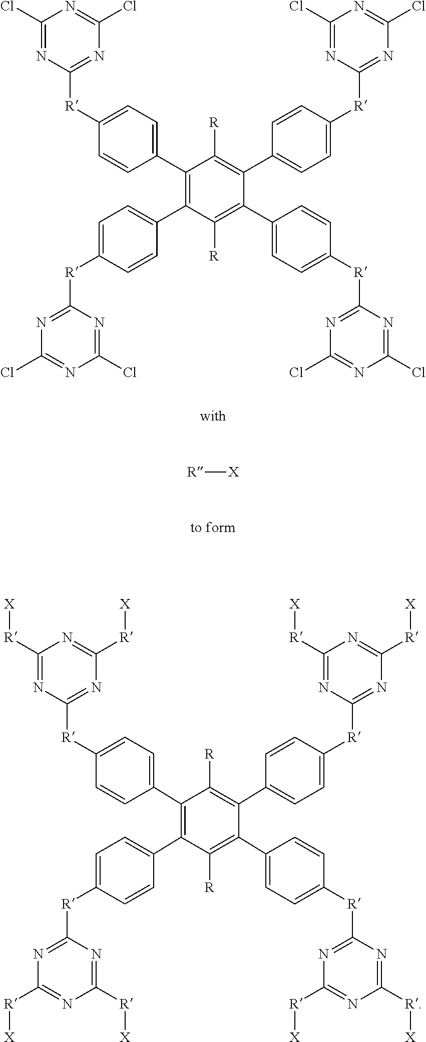

R″ may independently be —NH₂ or —OH, and each X is an aliphatic group. For example, X may be chosen from

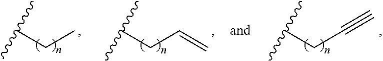

where n is 1, 2, or 3. The reaction may be performed under basic conditions (e.g., a reaction mixture comprising DIPEA at 120° C.). The method further comprises contacting

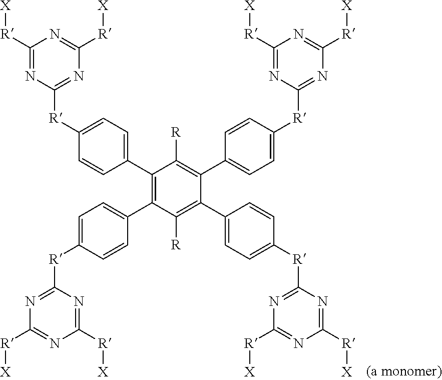

with a solvent to generate complexation of ions and/or solvent groups to the monomers. For example, the monomer is contacted with an acid (e.g., nitric acid) such that the resulting conjugate base ions (e.g., nitrate ions) are complexed to the monomers. The monomers may then be ionically crosslinked. Following by this, the ionically crosslinked monomers are covalently crosslinked by contacting with a linking group, such as, for example,

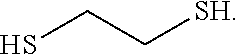

In some embodiments, for example, the method for making an organic framework comprises reacting

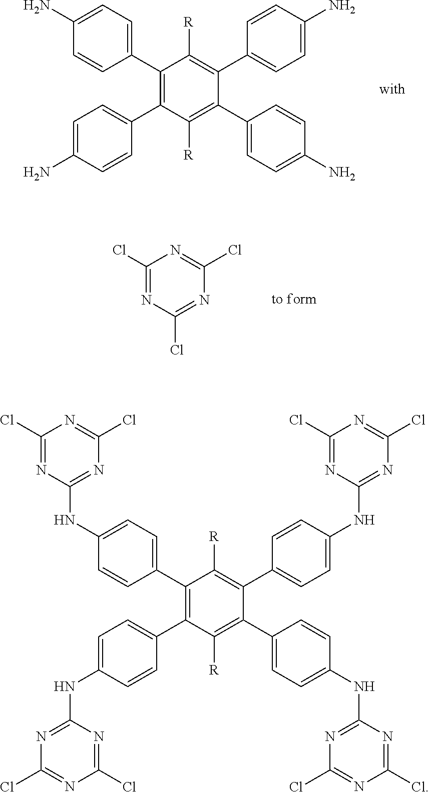

The reaction may be performed under basic conditions (e.g., a reaction mixture comprising K₂CO₃ in THE at 0° C.). R may be individually chosen from hydrogen, methoxy groups, ethoxy groups, alkoxy groups, alkylamino groups, alkyl ester groups, and alkyl groups. The method further comprises reacting

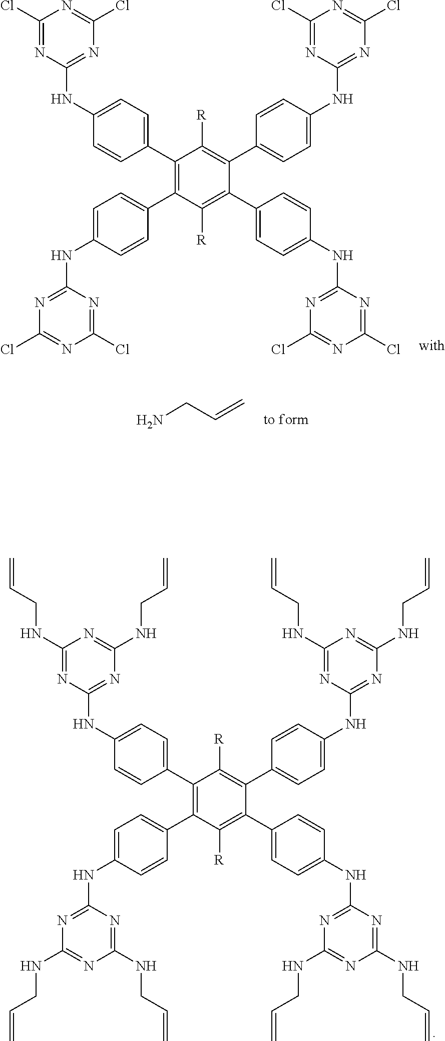

The reaction may be performed under basic conditions (e.g., a reaction mixture comprising DIPEA at 120° C.). The method further comprises contacting

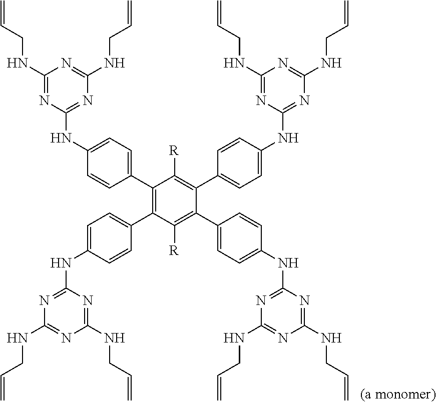

with a solvent to generate complexation of ions and/or solvent groups to the monomers. For example, the monomer is contacted with an acid (e.g., nitric acid) such that the resulting conjugate base ions (e.g., nitrate ions) are complexed to the monomers. The monomers may then be ionically crosslinked. Following by this, the ionically crosslinked monomers are covalently crosslinked by contacting with a linking group, such as, for example,

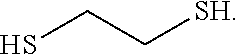

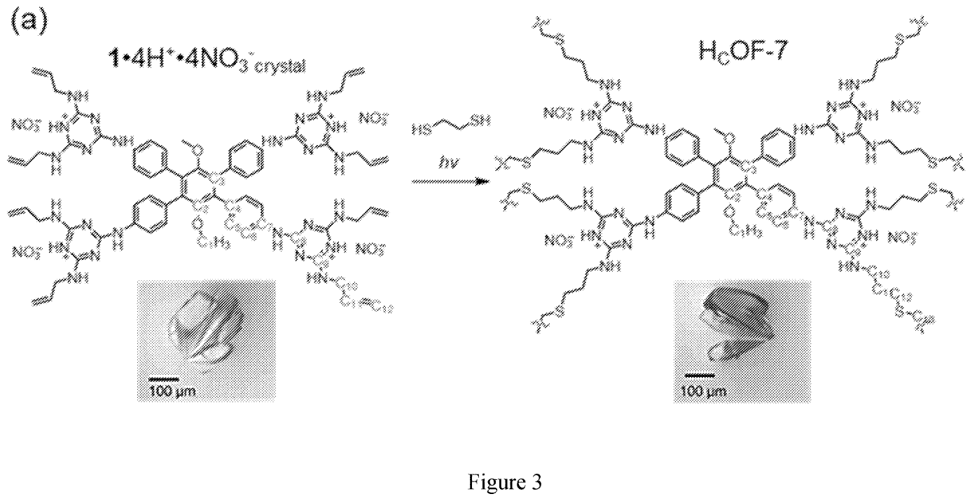

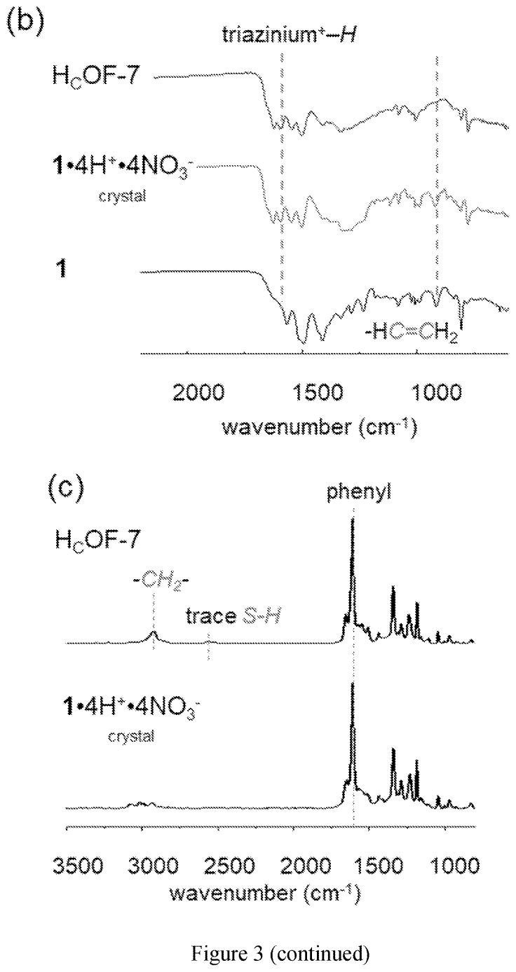

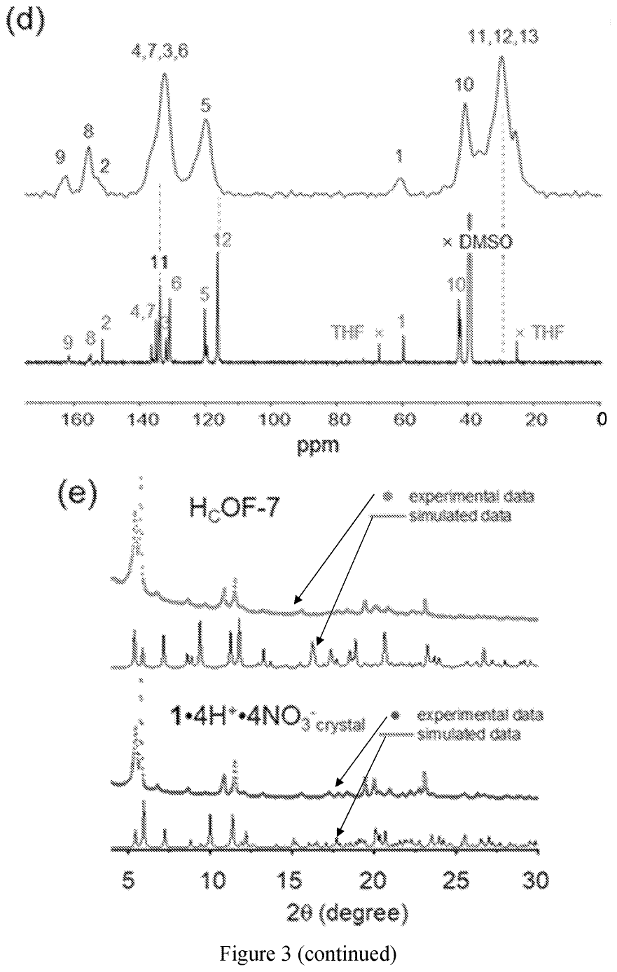

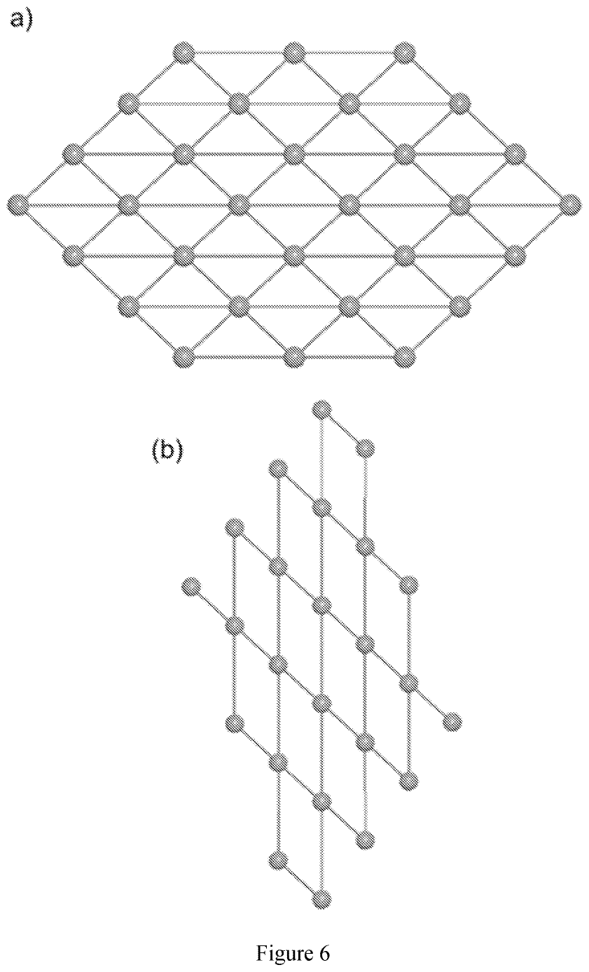

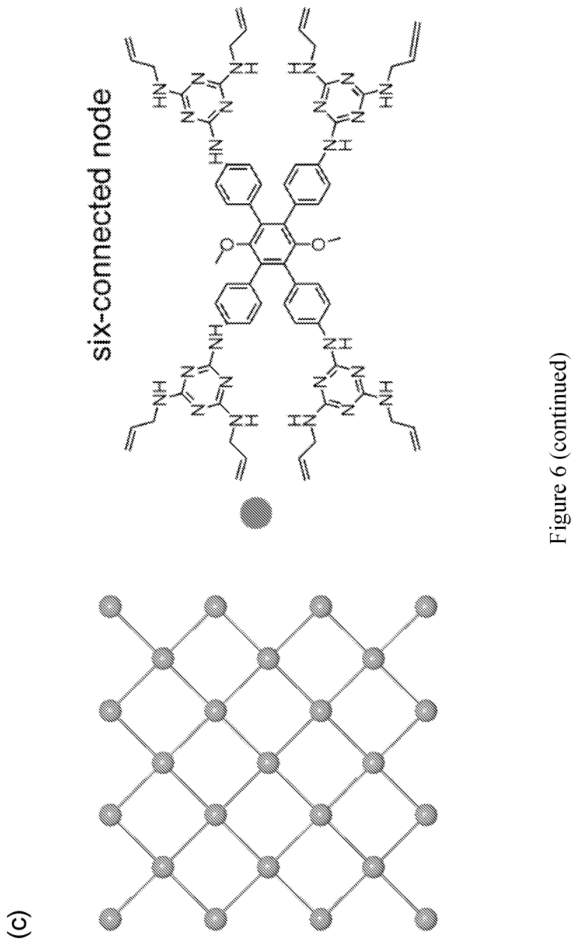

The resulting organic framework is depicted in FIG. 3a and 6.

Various acids may be used in a method of preparing an organic framework of the present disclosure. Examples of acids include, but are not limited to, H₂SO₄, H₂CO₃, H₂SO₄, H₃PO₄, HNO₃⁻, HCl, HF, and HBr.

Various crosslinkers may be used in a method of making an organic framework of the present disclosure. Examples of crosslinkers include, but are not limited to, propane dithiol, butanedithiol,

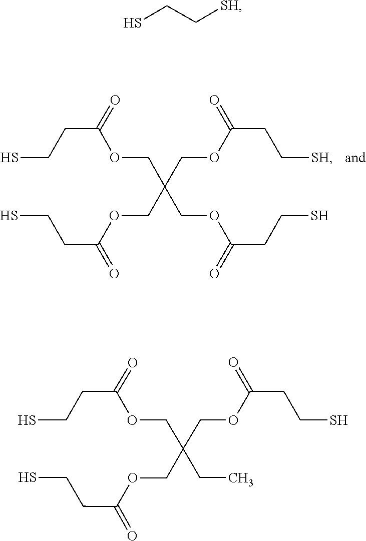

In an aspect, the present disclosure provides articles of manufacture. The article of manufacture comprises one or more organic frameworks of the present disclosure. The article of manufacture may be referred to as an article. The article may be a filtration funnel, a centrifuge tube, a chromatography column, a vessel, a reaction vessel, a filtration cartridge, a filtration membrane, a fritted funnel, a syringe, or the like.

In an aspect, the present disclosure provides a method for removing iodine (e.g., I₂, I⁻, and/or I₃⁻) from an aqueous medium, such as, for example, from water.

The method may comprise contacting water with an organic framework of the present disclosure. The organic framework may be a plurality of single crystals. The water may be contacted with an article comprising the organic framework. The organic framework may be disposed on a surface of the organic framework. The contacting may be done at a temperature greater than room temperature (e.g., 40° C. or greater, 50° C. or greater, 60° C. or greater, 70° C. or greater, 80° C. or greater, 85° C. or greater, or at least 90° C.). Following contact with the organic frameworks of the present disclosure, the potability of the contacted water is expected to increase.

In various embodiments, the organic frameworks of the present disclosure may be used to capture or exchange radioactive iodine. For example, radioactive iodine may be released into water and/or soil as I₂ or I⁻. The contaminated matter (e.g., soil, water, and/or the like) may be contacted with an organic framework or article of the present disclosure.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

The following Statements provide various embodiments of the present disclosure.

Statement 1. An organic framework comprising a plurality of linked monomers comprising one or more

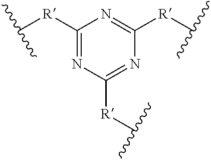

(“A group”) and the organic framework is at least 95% (e.g., 95%, 96%, 97%, 98%, 99%, or 100%) crystalline.
Statement 2. An organic framework according to Statement 1, wherein the monomers further comprise:

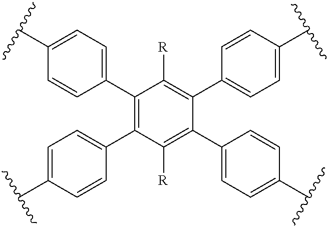

(“B group”), wherein each R is individually chosen from hydrogen, methoxy groups, ethoxy groups, alkoxy groups, alkylamino groups, alkyl ester groups, and alkyl groups; and each B group is covalently bonded to one or more A group.
Statement 3. An organic framework according to Statements 1 or 2, wherein the B group has the following structure:

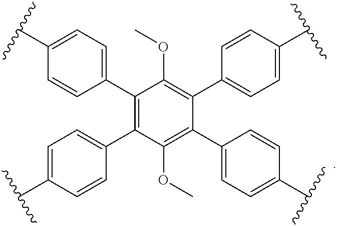 [SMILES: *c1ccc(-c2c(OC)c(-c3ccc(*)cc3)c(-c3ccc(*)cc3)c(OC)c2-c2ccc(*)cc2)cc1]

Statement 4. An organic framework according to Statement 3, comprising (e.g., wherein the monomer has the following structure):

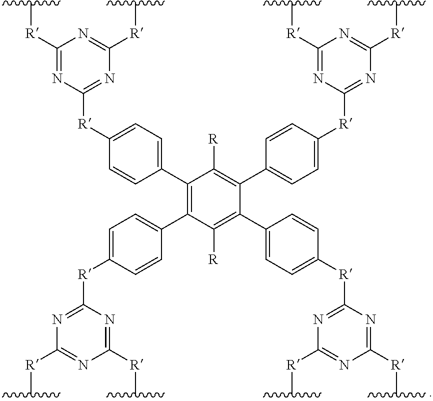

Statement 5. An organic framework according to Statement 4, comprising (e.g., wherein the monomer has the following structure):

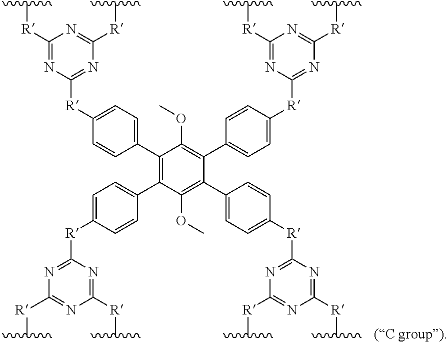

Statement 6. An organic framework according to Statement 5, wherein one or more C groups are connected to other C groups via a crosslinking group.
Statement 7. An organic framework according to Statement 5, comprising (e.g., wherein monomer has the following structure):

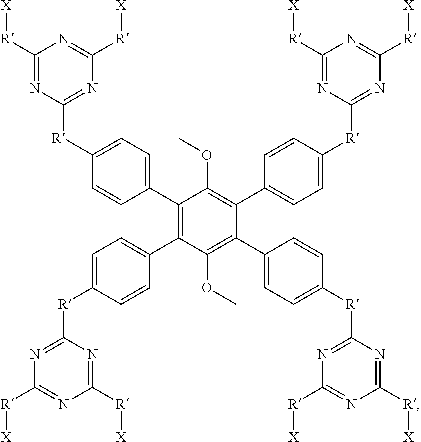

wherein each X is independently chosen from

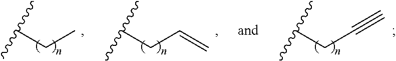

and; and n is 1, 2, or 3.
Statement 8. An organic framework according to Statement 7, wherein the monomers are crosslinked via NO₃⁻ ions.
Statement 9. An organic framework according to Statement 6, wherein the crosslinked C groups have NO₃⁻ bound thereto.
Statement 10. An organic framework according to Statement 6, wherein the crosslinked C groups have I₂ and/or I⁻ and/or I₃⁻ bound thereto.
Statement 11. An organic framework according to Statement 6, wherein the crosslinking group has the following structure:

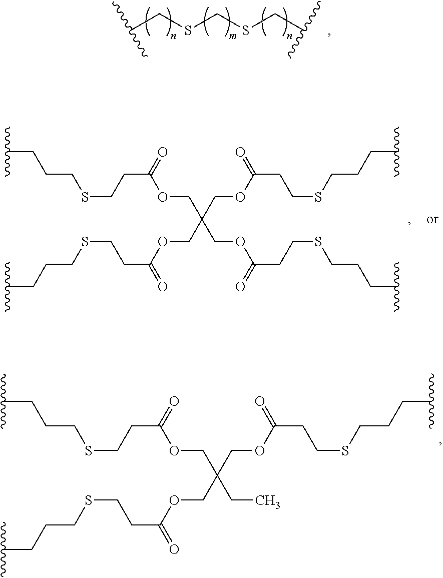

wherein n is 2 to 8 and m is 1 to 8.
Statement 12. An organic framework according to Statement 11, wherein the crosslinking group has the following structure:

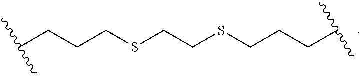 [SMILES: *CCCSCCSCCC*]

Statement 13. An organic framework according to any one of the preceding Statements, wherein the organic framework defines one or more apertures.
Statement 14. An organic framework according to Statement 13, wherein the aperture has a longest linear dimension of 3-15 Å, including all 0.1 Å values and ranges therebetween (e.g., 3, 4, 5, 6, 7, 8, 9, 10, 11, 12, 13, 14, or 15 Å).
Statement 15. An organic framework according to Statement 13, wherein the aperture is about or is 6 Å×I₂ Å.
Statement 16. An organic framework made by a process comprising:
reacting

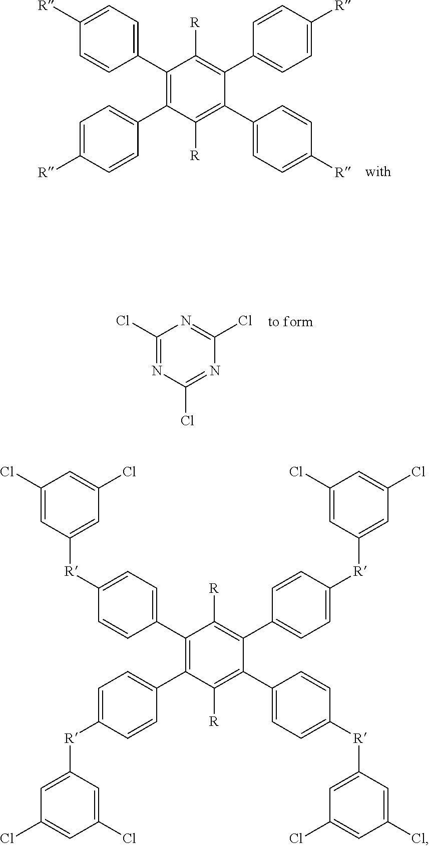

wherein R is hydrogen, methoxy groups, ethoxy groups, alkoxy groups, alkylamino groups, alkyl ester groups, or alkyl groups, and R″ is —NH₂ or —OH;
reacting

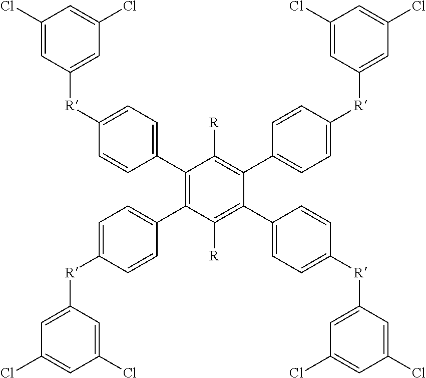

with R″—X, wherein X is chosen from

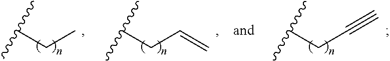

and n is 1, 2, or 3, to form

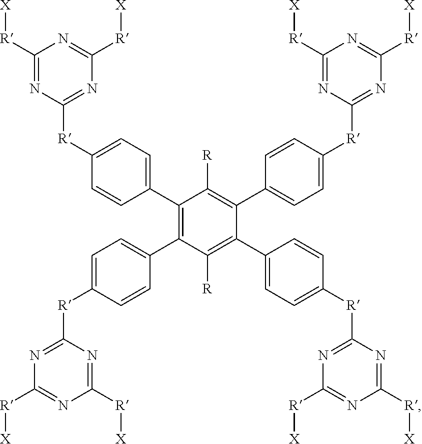

wherein R′ is —NH— or —O—, X is chosen from

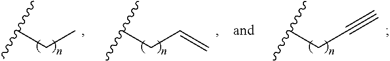

and n is 1, 2, or 3;
contacting

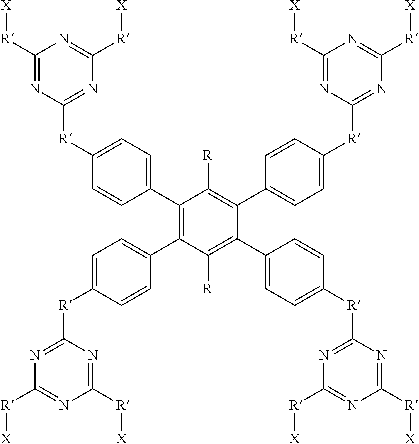

with an acid (e.g., nitric acid), such that conjugate base ions of the acid (e.g., nitrate ions) complex to

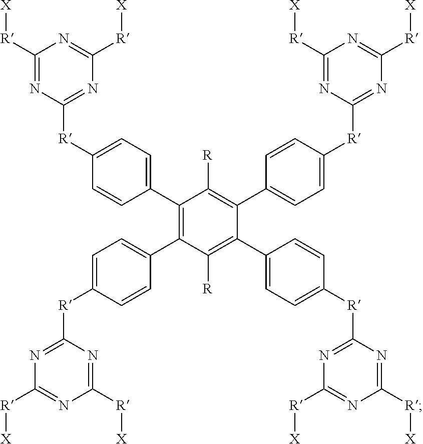

and
reacting the ion-complexed

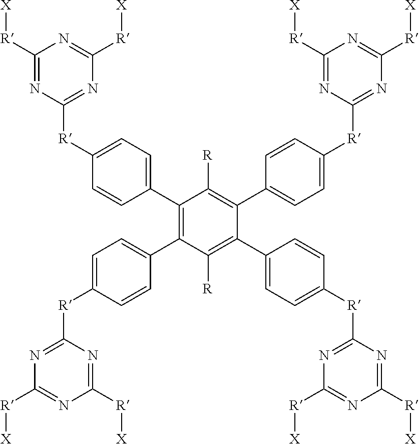

with a crosslinker

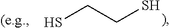

wherein a crosslinked organic framework is formed.
   Statement 17. An organic framework according to Statement 16, wherein the acid is H₂SO₄, H₂CO₃, H₂SO₄, H₃PO₄, HNO₃⁻, HCl, HF, or HBr.
   Statement 18. An organic framework according to Statement 16 or Statement 17, wherein R is a methoxy group.
   Statement 19. An article of manufacture comprising an organic framework according to any one of the preceding Statements.
   Statement 20. An article of manufacture according to Statement 19, wherein the article is a vessel, a column, a centrifuge tube, a filter, a fritted funnel, a syringe, or a filtration membrane.
   Statement 21. A method for removing I₂ and/or I⁻ comprising contacting a medium comprising I₂ and/or I⁻ with an organic framework according to any one of Statements 1-18.
   Statement 22. A method according to Statement 21, wherein the medium is water.
   Statement 23. A method according to Statement 21 or Statement 22, wherein the organic framework is a plurality of single crystals.
   Statement 24. A method according to any one of Statements 21-23, wherein an article comprises or has disposed on a surface thereof the organic framework.
   Statement 25. A method according to any one of Statements 21-2, wherein the contacting is performed at a temperature greater than room temperature.
   Statement 26. A method according to any one of Statements 21-25, wherein the temperature is 40° C. or greater.
   Statement 27. A method according to any one of Statements 21-26, wherein the temperature is 50° C. or greater.
   Statement 28. The method according to any one of Statements 21-27, wherein the temperature is 85° C. or greater.
   Statement 29. A method according to any one of Statements 21-28, wherein the temperature is at least 90° C.

The following example is presented to illustrate the present disclosure. It is not intended to be limiting in any matter.

### Example 1

This example provides a description of organic frameworks of the present disclosure and methods of making and using same.

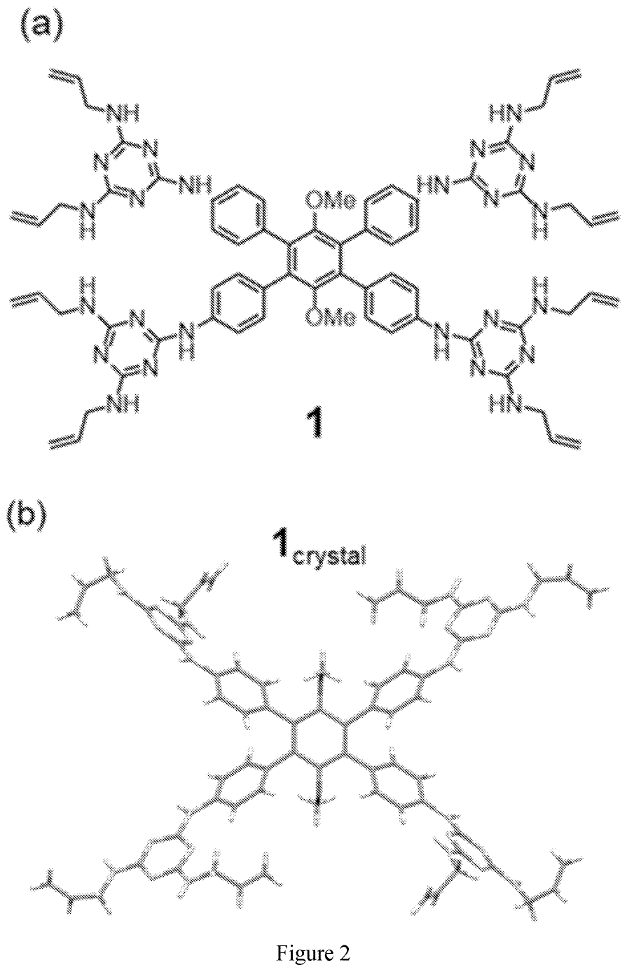

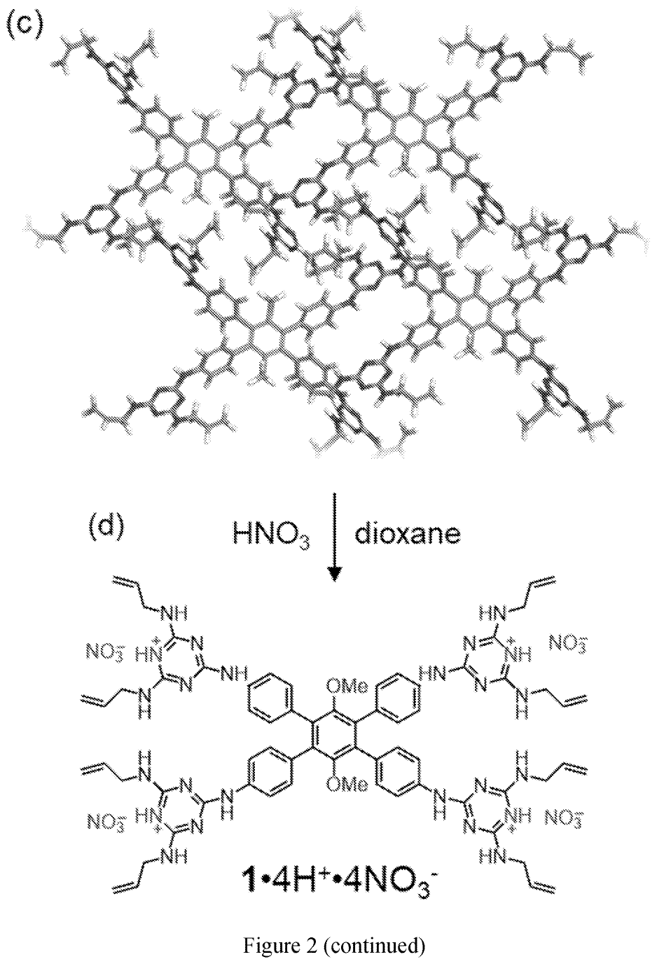

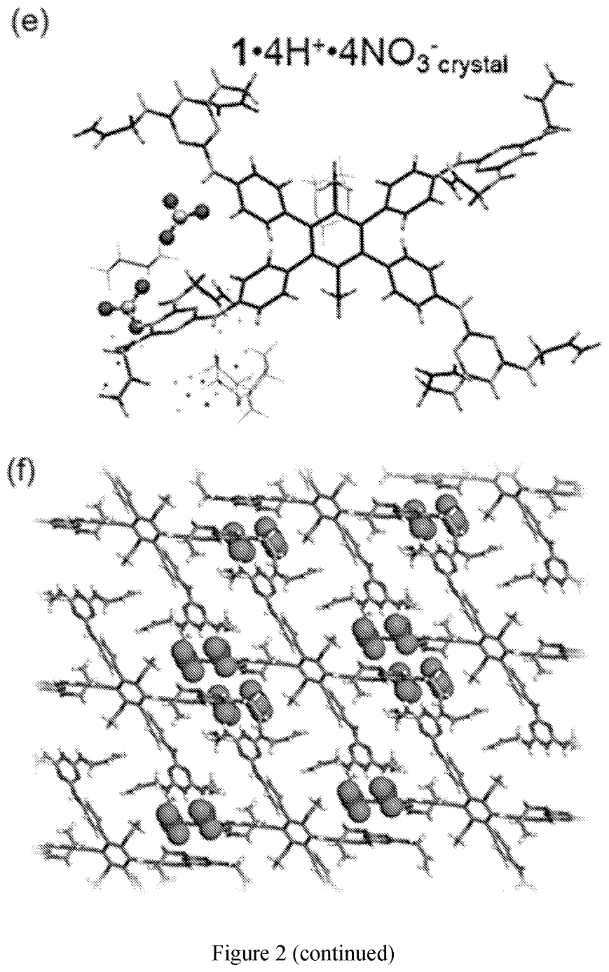

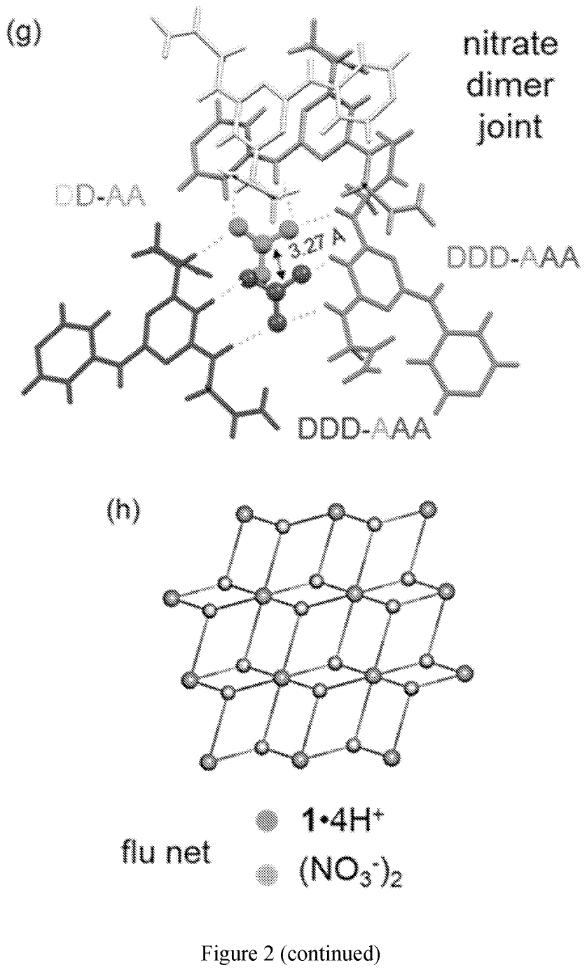

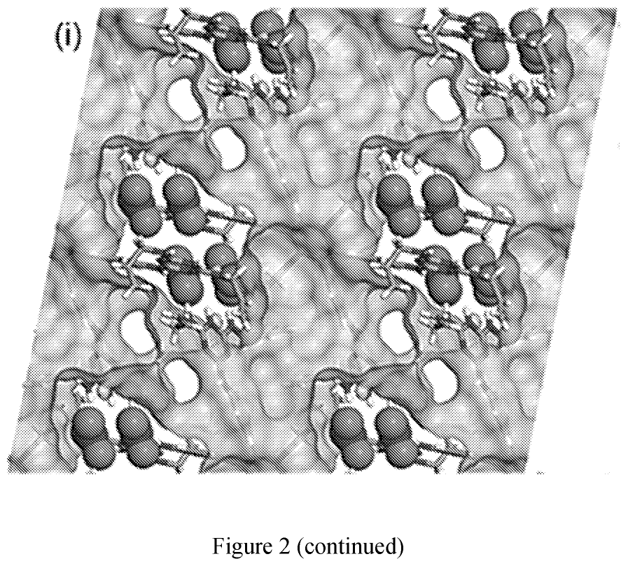

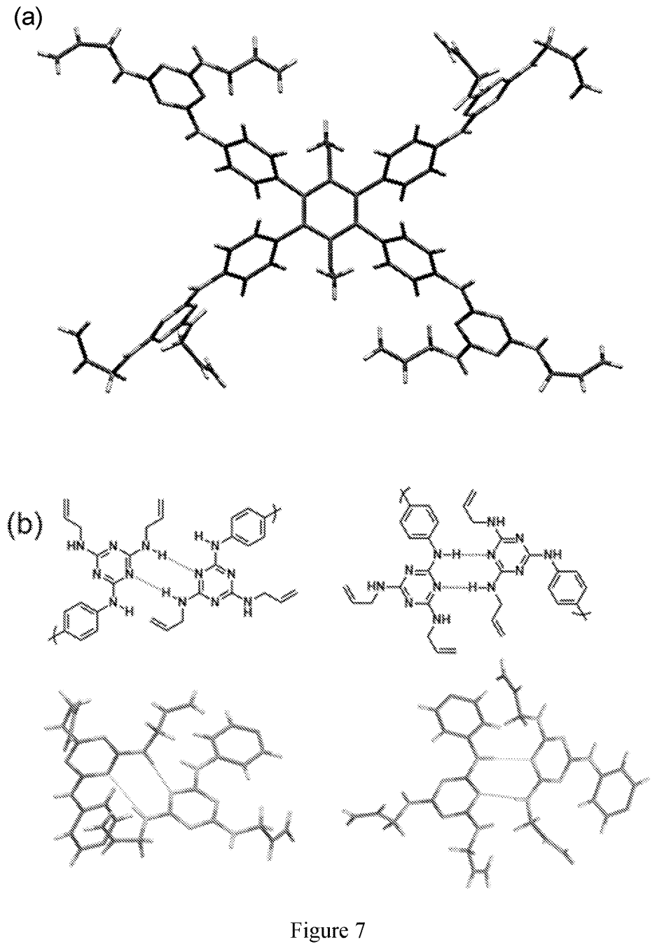

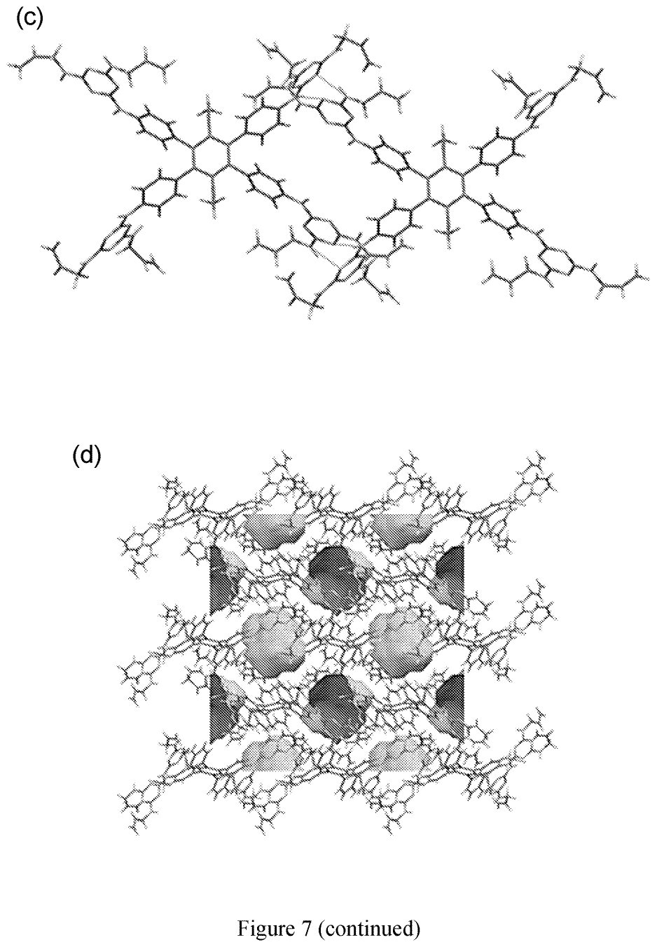

Monomer 1 was designed with a 1,2,4,5-tetraphenylbenzene core to increase the steric barrier for the four surrounding phenyl groups, forcing them to rotate perpendicularly to the center dimethoxy-benzene moiety to prevent π-π stacking in the solid-state (FIG. 2a). Monomer 1 was synthesized in four steps in a high yield without column chromatography purification (Scheme 1). Single crystals of 1 were obtained by diffusing methanol into the DMSO solution of 1 at room temperature for 5 days. Single-crystal X-ray diffraction (SCXRD) analysis (FIG. 2b-c) showed that 1 crystallized in a monoclinic P21/n space group (a=15.0148, b=14.7706, c=16.4854 Å, α=γ=90°, β=103.120°). The dihedral angles between the four phenyl rings and the center dimethoxy-benzene moiety are measured between 53° and 63° (FIG. 2b), which are larger than those in the tetraphenylethylene core of prior H_{C}OFs. In the solid state, each monomer forms 16 intermolecular hydrogen bonds (N···NH distances: 2.99-3.09 Å) with the neighboring monomers, affording a hydrogen-bonded network (FIG. 2c) of pcu topology (FIG. 6). 1_{crystal} possesses 11% isolated voids occupied by disordered solvents (FIG. 7).

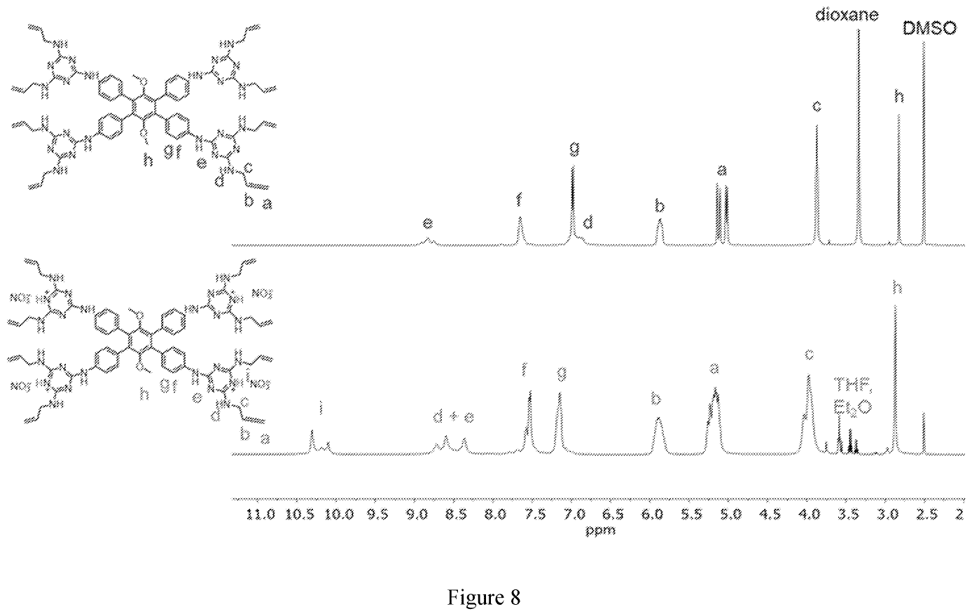

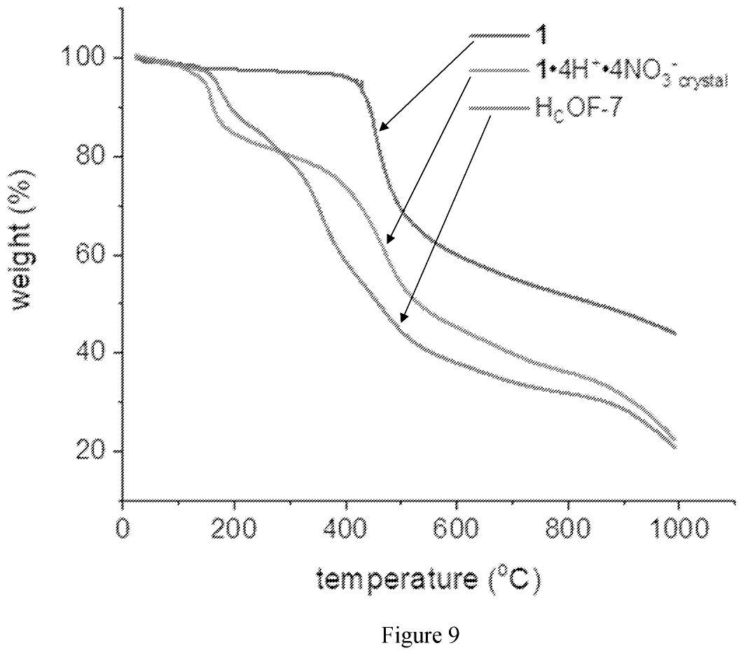

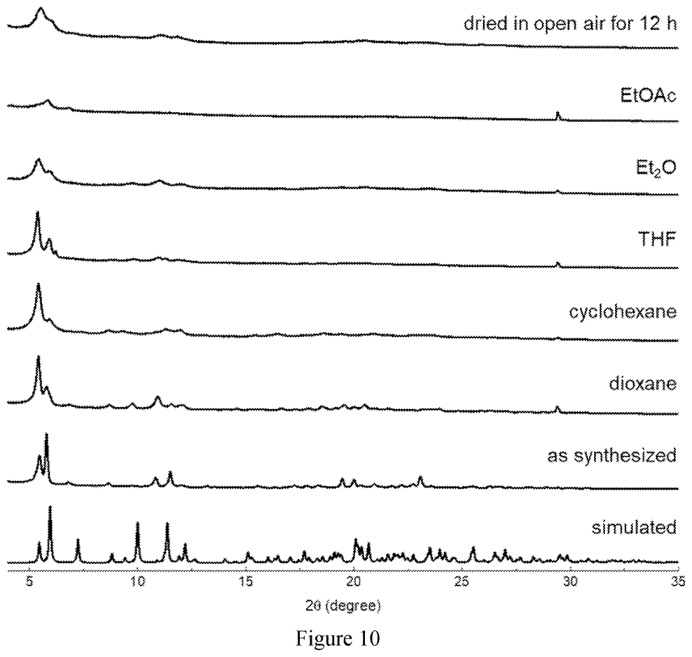

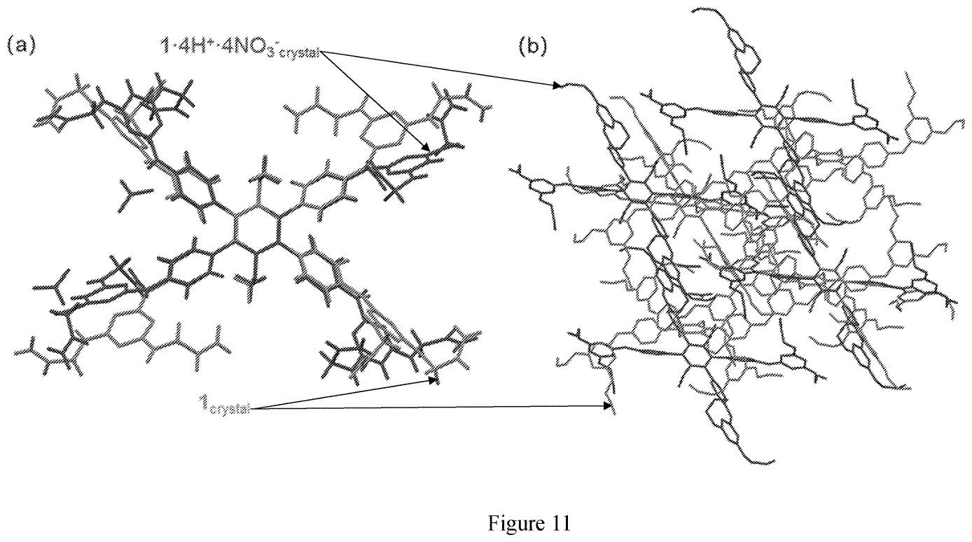

Protonation of the melamine groups of 1 using nitric acid afforded 1·4H⁺·4NO₃⁻, and the proton resonance of the melaminium NH was found at 10.3 ppm in the ¹H NMR spectrum (FIG. 8). Thermogravimetric analysis (TGA) showed a mass loss of 17% at around 160° C., attributed to nitrate loss in 1·4H⁺·4NO₃⁻ (FIG. 9). Single crystals of 1·4H⁺·4NO₃⁻ were obtained by crystallizing 1 in the presence of nitric acid (FIG. 2d). 1·4H⁺·4NO₃⁻_{crystal} crystallized in a triclinic P1̅ space group (FIG. 2e-i, a=10.3457, b=15.3155, c=16.9364 Å, α=77.121°, β=77.174°, γ=81.156°). Each melaminium moiety of 1·4H⁺·4NO₃⁻ acts as a hydrogen-bonding donor, which binds two anionic nitrates with O···HN hydrogen bonds ranging between 2.78 to 2.94 Å. The nitrate anion dimer is only 3.27 Å apart (N···N distance, FIG. 2g), which measures the shortest nitrate-to-nitrate distance in solid-state assemblies, thus suggesting a large Coulombic repulsion between the two nitrates. The donor-donor-donor (DDD) and acceptor-acceptor-acceptor (AAA) arrays formed between melaminiums and nitrate dimer are non-planar with an angle of 111.3°. One nitrate is further stabilized by two additional side-on Ph-NH-melaminium and NH-allyl hydrogen bonds (FIG. 2g, yellow and green colored moieties), forming a third DD-AA array. This observation, in conjunction with other reported nitrate dimer assemblies, suggests that the nitrate-melamine assembly is sensitive to the molecular geometry of the melamine-containing molecule and its solid structure. Compared to HCO₃⁻, H₂PO₄⁻ or HSO₄⁻ anion dimers/clusters, the lack of hydrogen bonds between the two nitrates makes them less stable and directional in organizing the hydrogen-bonded networks. Consequently, the nitrate dimers should be more active in anion exchange to reduce their Coulombic repulsion. 1·4H⁺·4NO₃⁻_{crystal} has limited stability since it lost crystallinity when exposed to diethylether, ethylacetate, or open-air (FIG. 10). It also dissolves in dichloromethane, acetone, acetonitrile, and methanol.

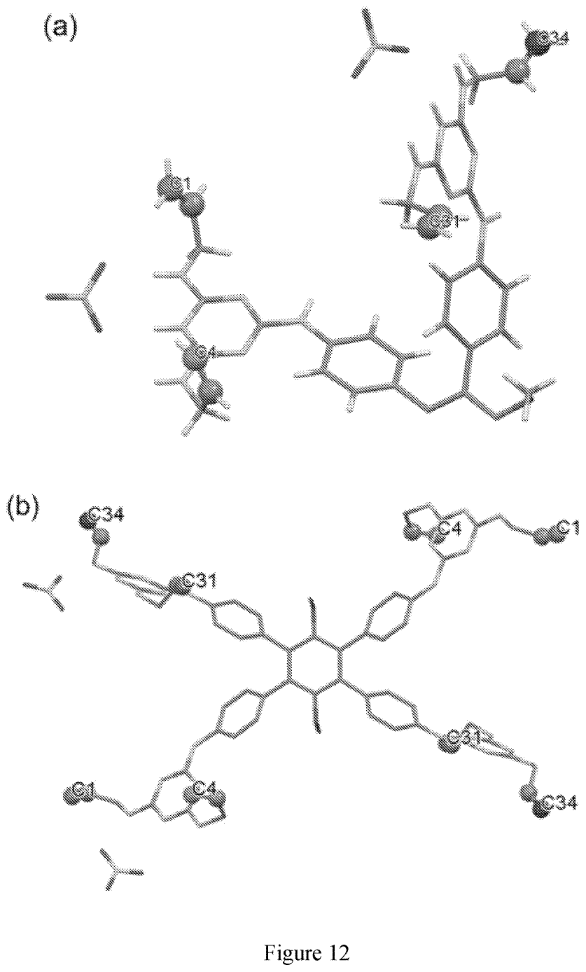

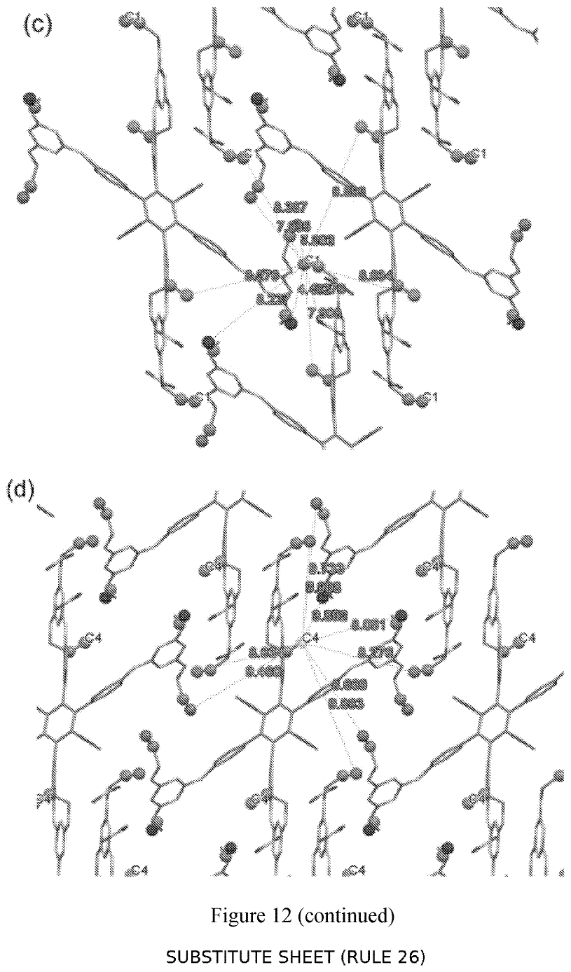

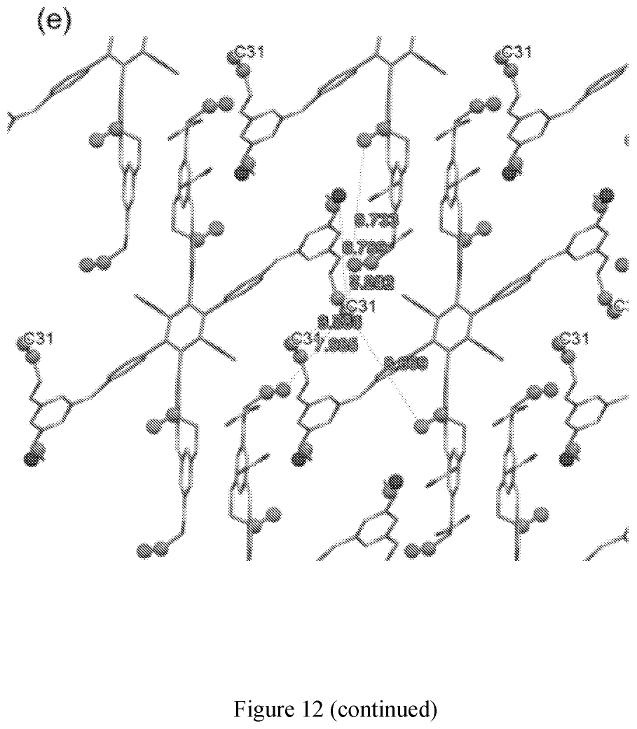

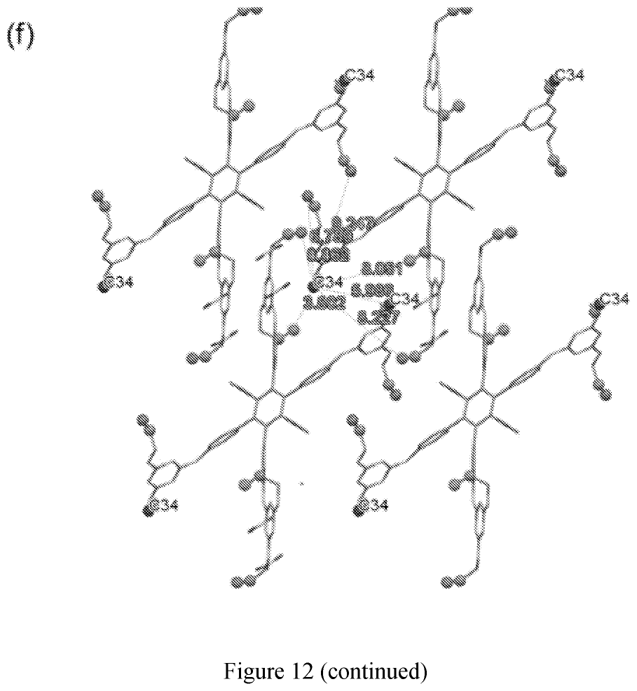

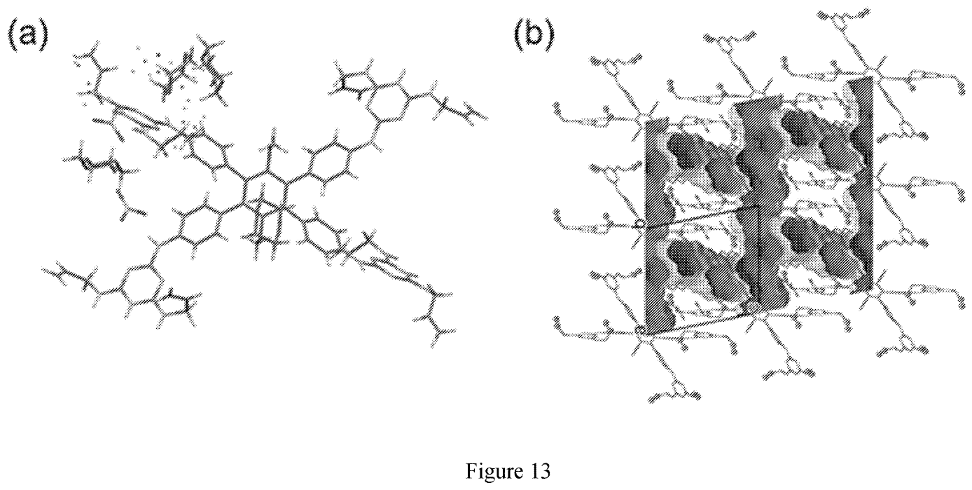

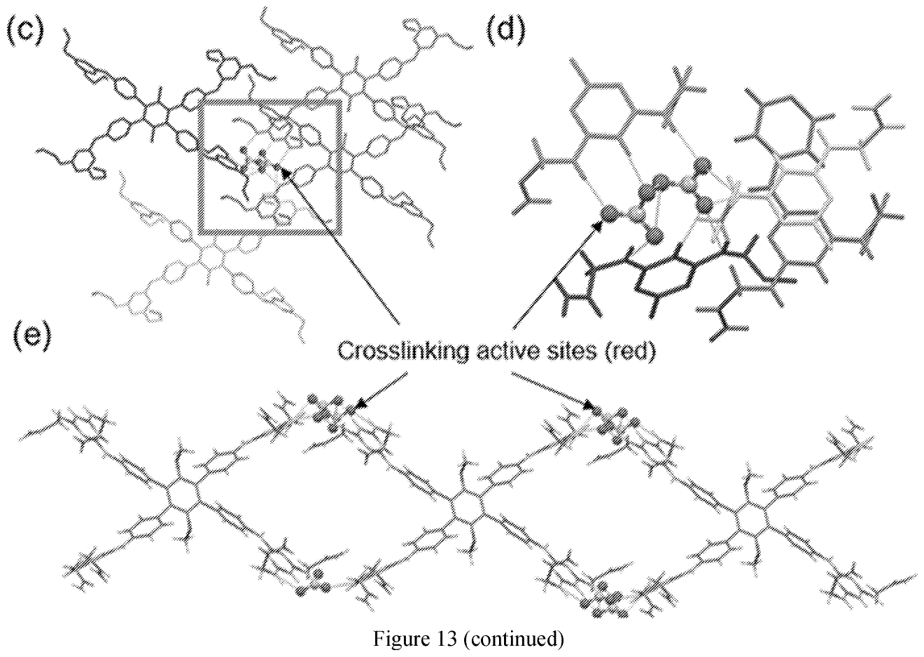

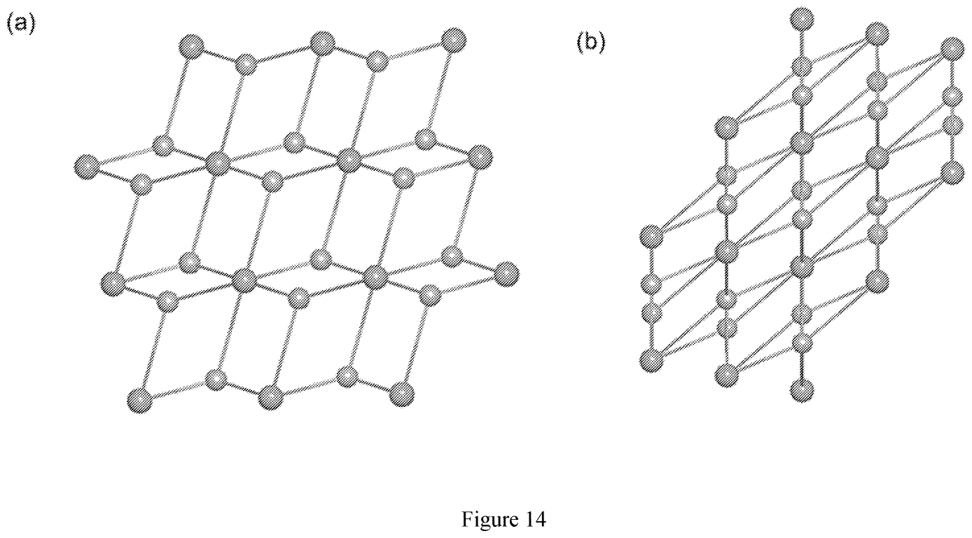

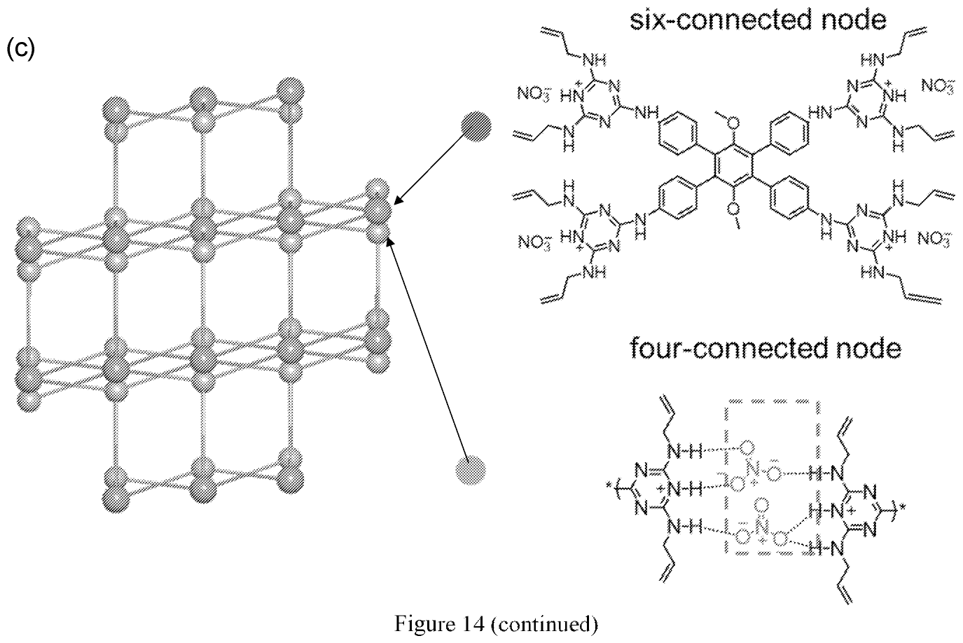

The nitrate dimer may be a four-connected linker and 1·4H⁺ may be a six-connected node for the construction of the hydrogen-bonded network. The topology of 1·4H⁺·4NO₃⁻_{crystal} is assigned as a 3D network {4¹²·6¹²·8⁴}₂ of flu topology (FIG. 2h). The void space of 1·4H⁺·4NO₃⁻_{crystal} is calculated as 35% (FIG. 2i), filled by 1,4-dioxanes. There are interconnected 1D channels along the a-, b-, and c-axis, and their aperture sizes are measured as 3.9×19.4, 6.8×7.6, and 4.6×5.9 Å, respectively. The olefin groups of the diallyl-melaminium moieties are decorated on the accessible pore surface with various distances between 5 to 9 Å (FIG. 12 and Table 2), which are suitable for crosslinking using 1,2-ethanedithiol (EDT).

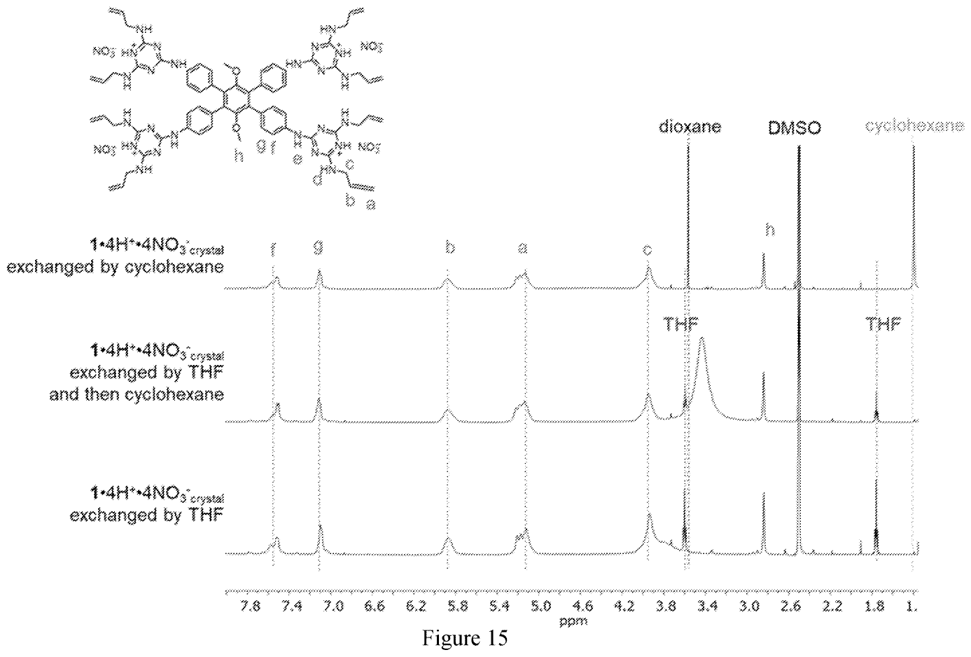

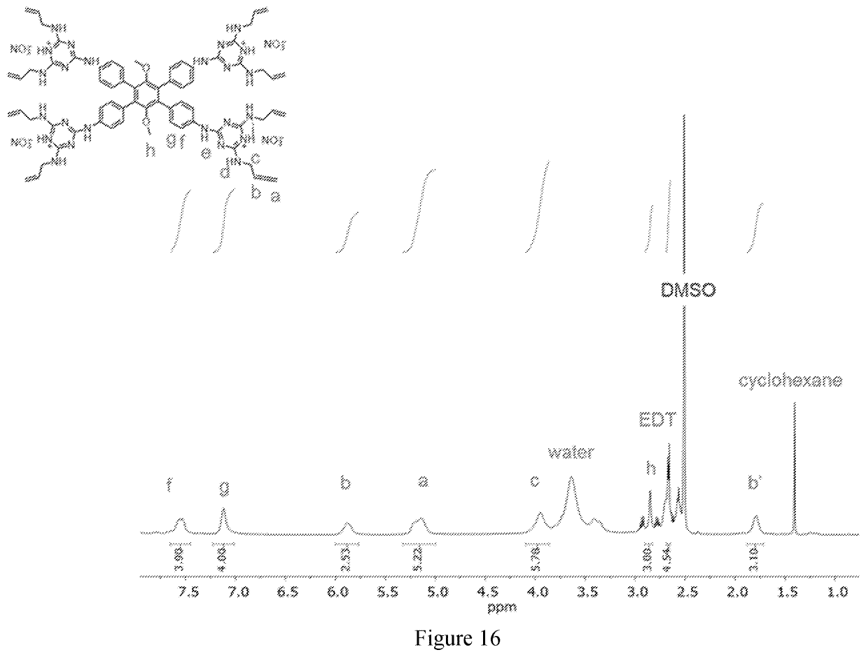

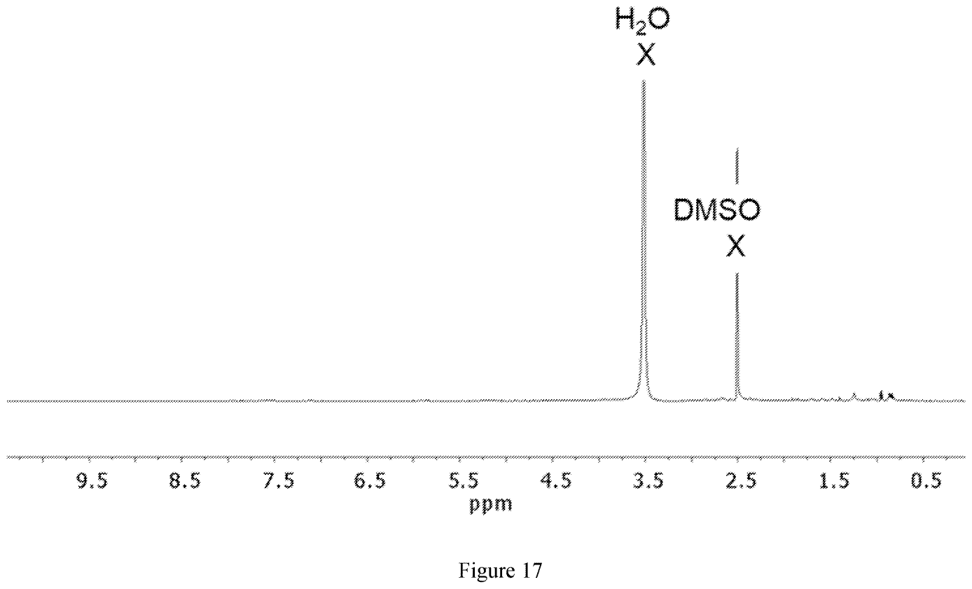

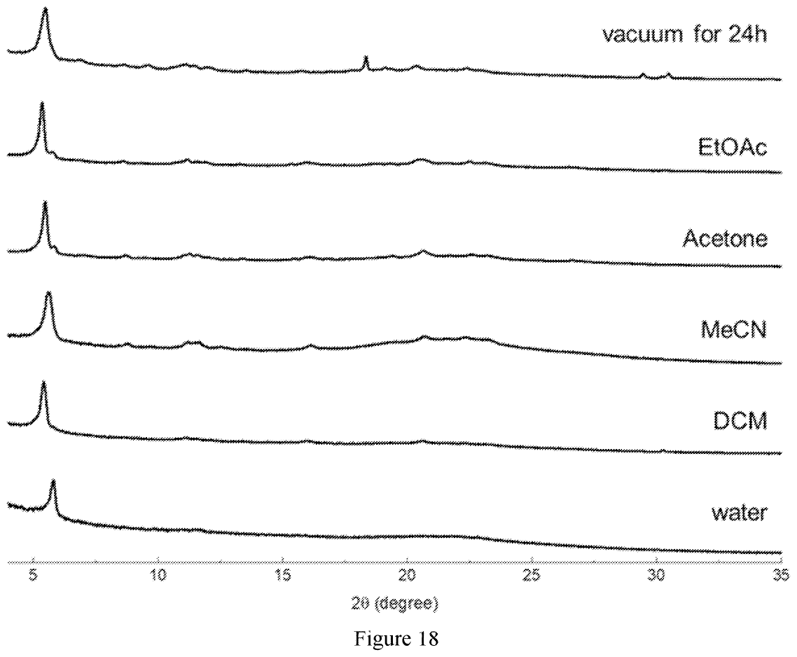

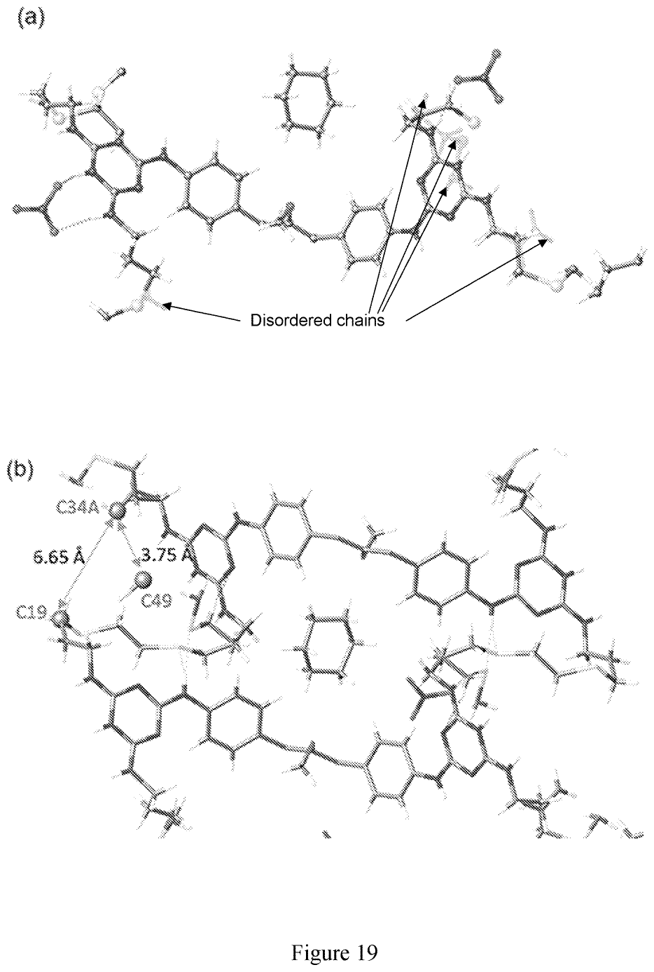

It was discovered that EDT could not replace the 1,4-dioxanes in the voids of 1·4H⁺·4NO₃⁻_{crystal}. Hence, the 1,4-dioxane molecules in 1·⁴H⁺·⁴NO₃⁻_{crystal} were first replaced by THE (FIG. 15) without diminishing the crystallinity. The THF-filled single crystals of 1·4H⁺·4NO₃⁻ were immersed in a cyclohexane solution of EDT (133.2 L/mL) for 3 d in the dark (FIG. 16). After UV irradiation, the crosslinked samples were subjected to ¹H NMR and elemental analyses (FIG. 17 and Table 3). Gradually increasing the concentration of EDT from 33.3 to 133.2 μL/mL, a close-to-stoichiometrically crosslinked H_{C}OF-7 was obtained (1·4H⁺·[NO₃⁻]_{4.0}·[EDT]_{3.95}). In the FT-IR spectra (FIG. 3b), the olefin bending band at 915 cm⁻¹ disappeared after crosslinking. Only trace thiol stretching band was found at 2600 cm⁻¹ in the Raman spectrum (FIG. 3c). In the solid-state ¹³C NMR spectrum (FIG. 3d), new carbon resonances at 30.1 ppm attributed to the dithioether were observed, and resonances attributed to the olefins (115 and 131 ppm) disappeared after crosslinking, indicating the complete allyl-to-thioether conversion. H_{C}OF-7 showed a nearly identical powder X-ray diffraction (PXRD) profile compared to that of 1·4H⁺·4NO₃⁻_{crystal}(FIG. 3e). In contrast to 1·⁴H⁺·⁴NO₃⁻_{crystal}, H_{C}OF-7 remained highly crystalline when exposed to water, dichloromethane, acetonitrile, acetone, open-air, and vacuum (FIG. 18). The greatly improved chemical stability of H_{C}OF-7 comes from the covalent thioether linkages.

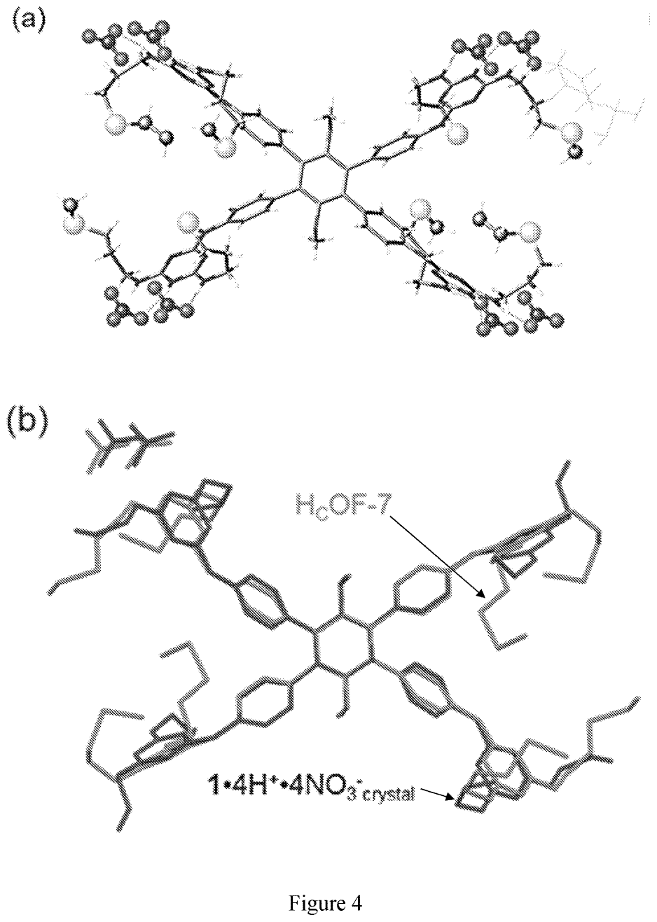

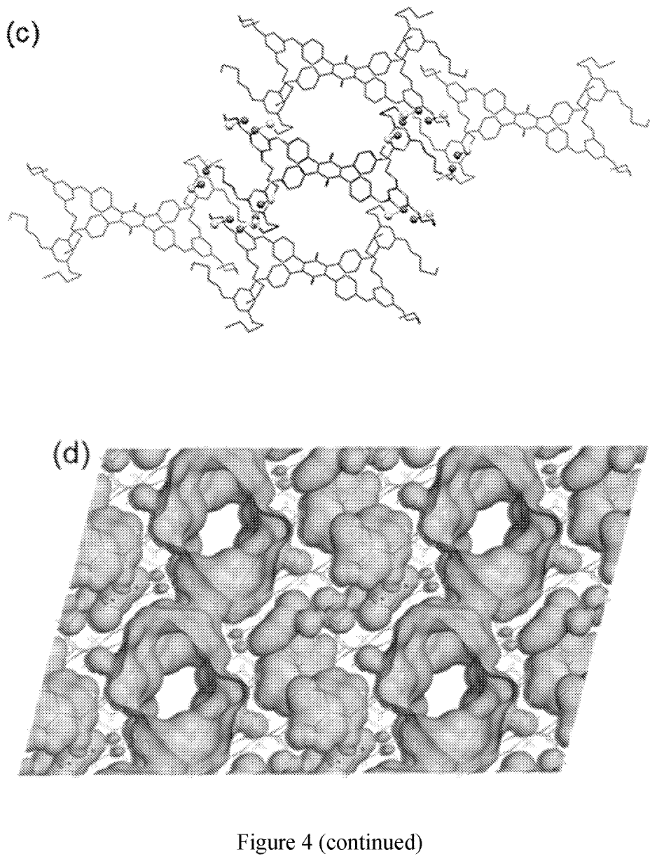

H_{C}OF-7 is suitable for SCXRD analysis (FIG. 4a), and its cell volume expanded by 7.3% compared to that of 1·4H⁺·4NO₃⁻_{crystal}. The hydrogen-bonded network of H_{C}OF-7 remained largely identical to 1·4H⁺·4NO₃⁻_{crystal}. Analysis of the overlaid structure (FIG. 4b) of 1·4H⁺·4NO₃⁻_{crystal} and H_{C}OF-7 showed that the O···NH hydrogen bonding distances between melaminium and nitrate dimers increased from 2.78 to 2.88 Å after crosslinking. The distance between the nitrates in the anion dimer increased from 3.27 to 3.48 Å. The larger hydrogen bond lengths and nitrate-nitrate distances suggest weaker hydrogen bonding interactions between the melaminiums and nitrate dimers in H_{C}OF-7, thus making anion exchange more favorable.

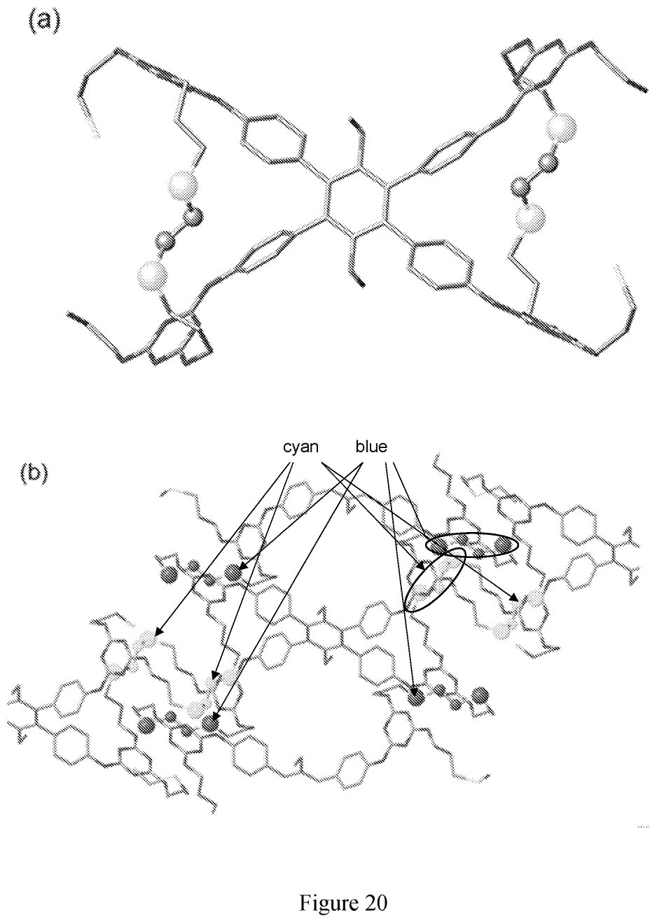

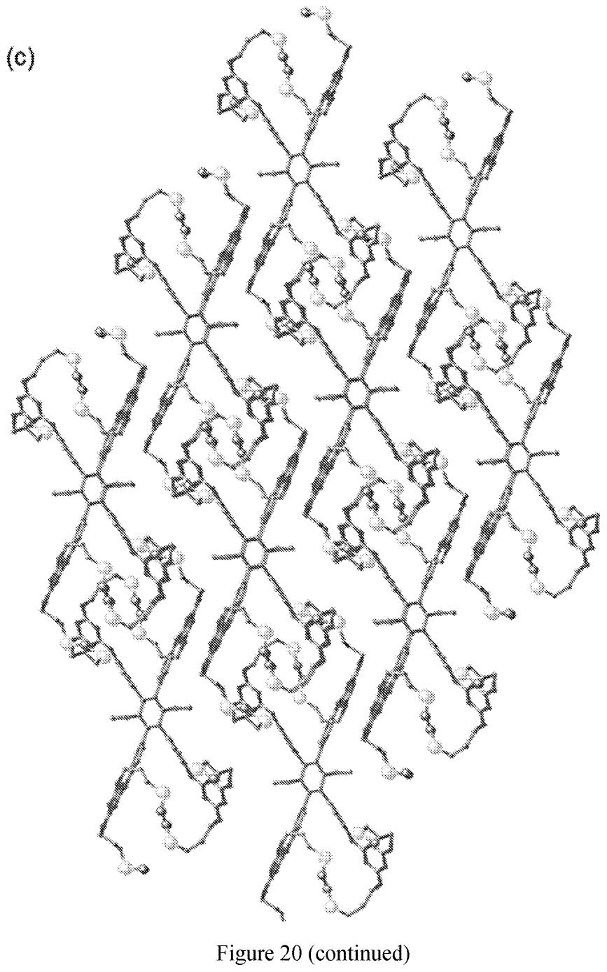

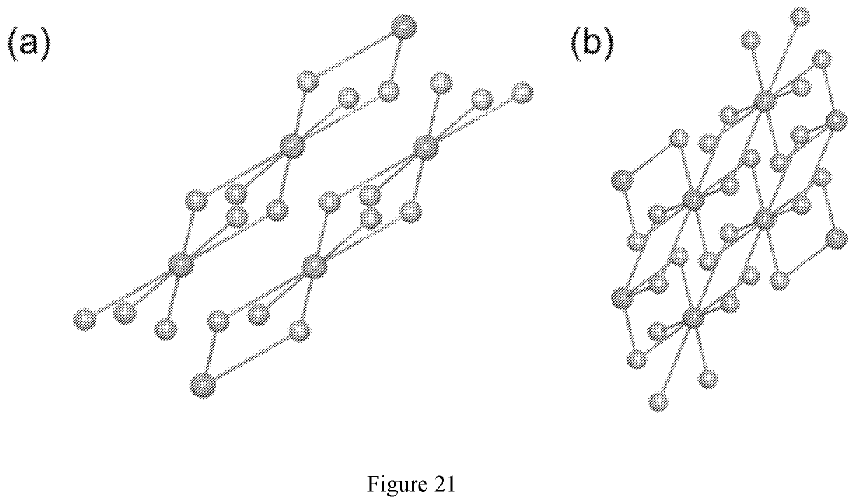

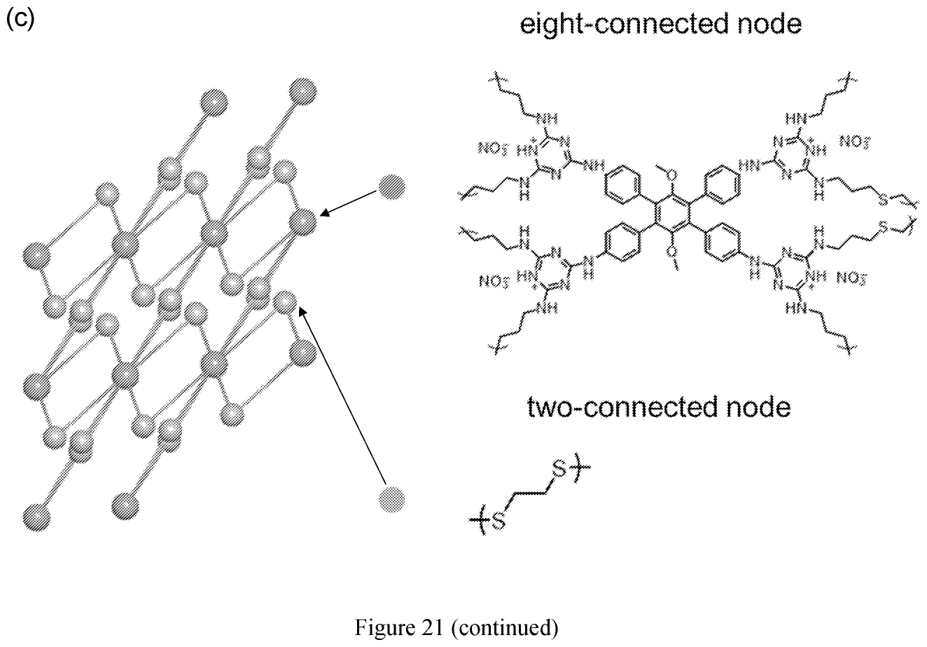

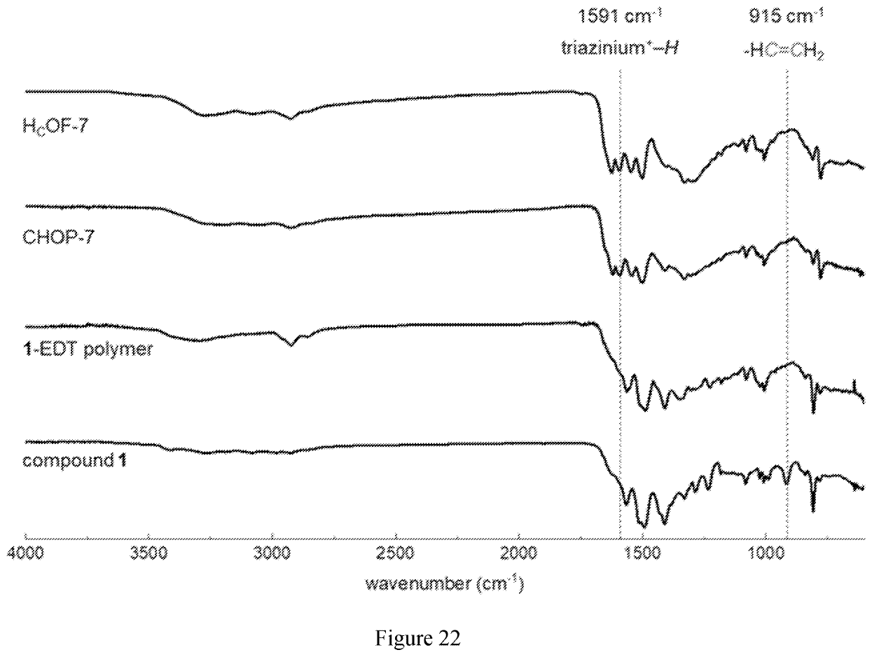

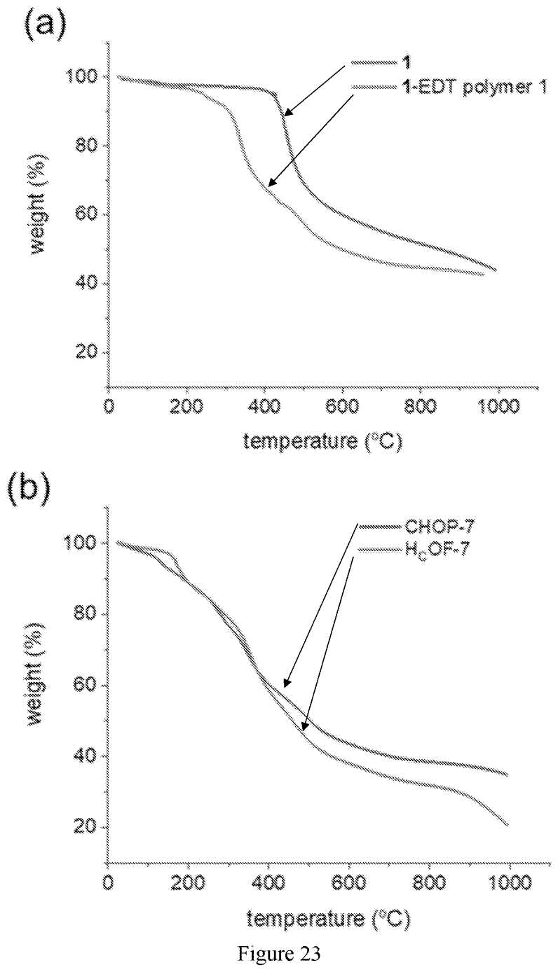

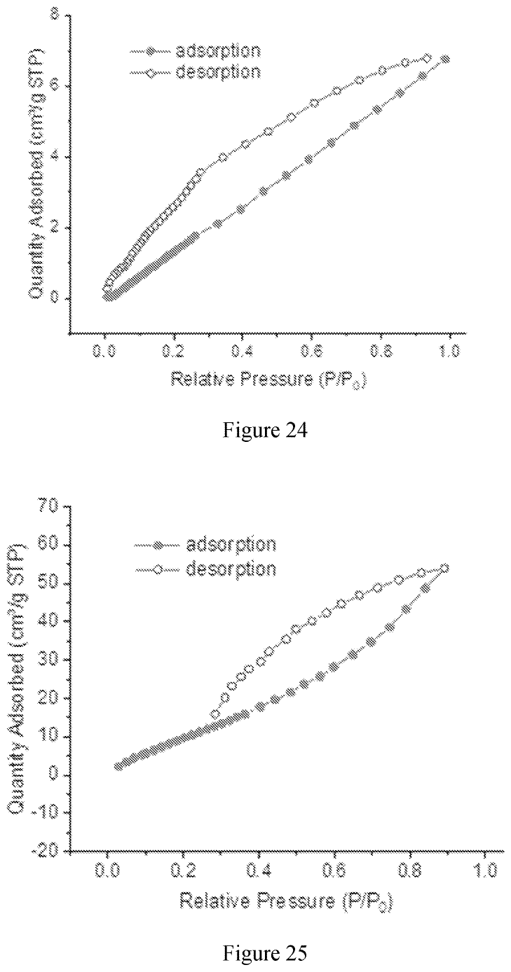

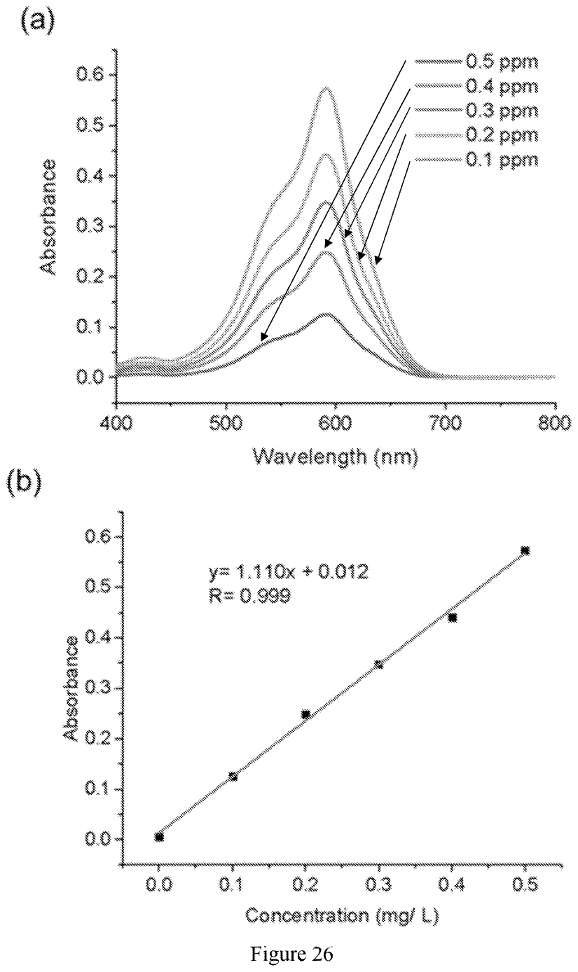

In the refined solid-state structure of H_{C}OF-7 (FIG. 4c), each 1·4H⁺ moiety is connected to four neighboring moieties via dithioether crosslinks. Electron densities attributed to the dithioether crosslinkages indicate the co-existence of several crosslinking paths (FIG. 20). The dithioether may be considered a two-connected linker and 1·4H⁺ moiety may be considered an eight-connected node of the covalently crosslinked network. The topology of H_{C}OF-7 is assigned as a 2-nodal 2D network with a point symbol of (4⁴·8¹⁶·128)(4)₄ (FIGS. 20-21). H_{C}OF-7 exhibits 1D channels along the b-axis with a pore aperture of 5.9×7.2 Å and void space of 20% (FIG. 4d), which are large enough for the adsorption of guest molecules such as I₂ (r~2.0 Å) and I⁻ (r~2.1 Å).

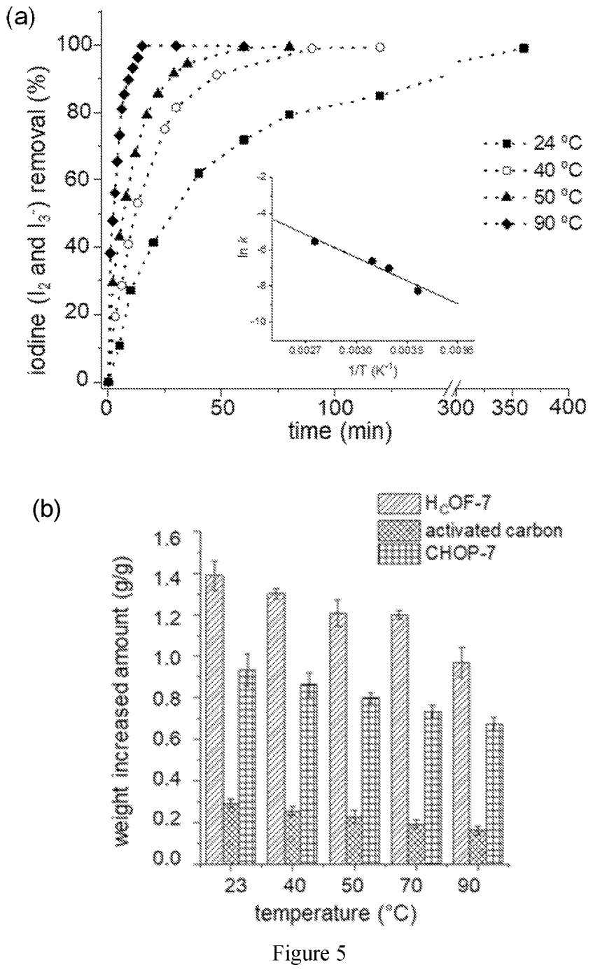

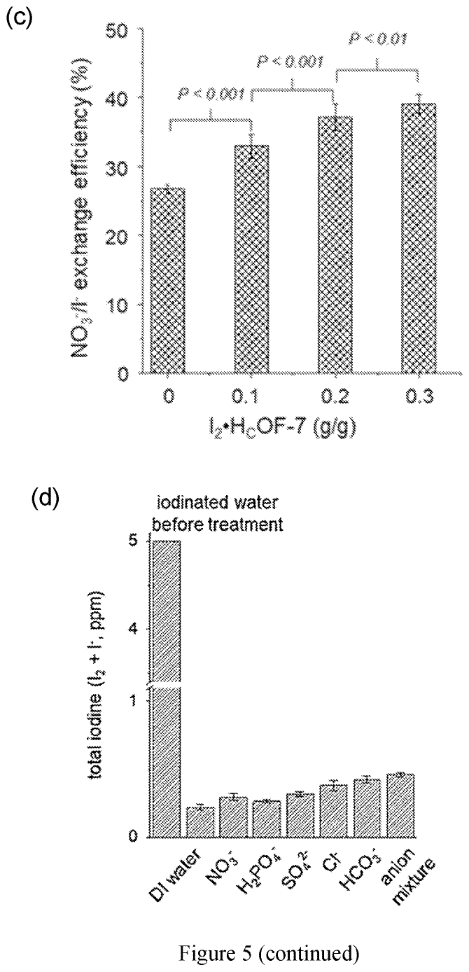

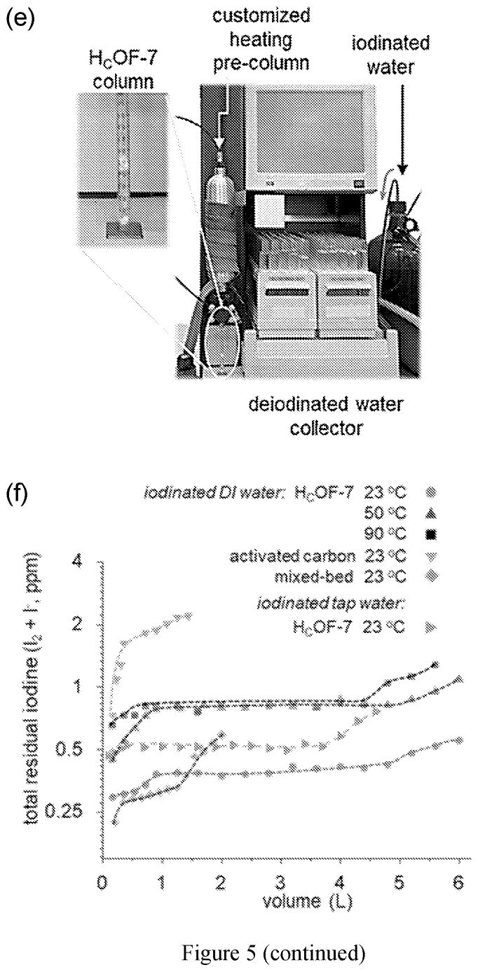

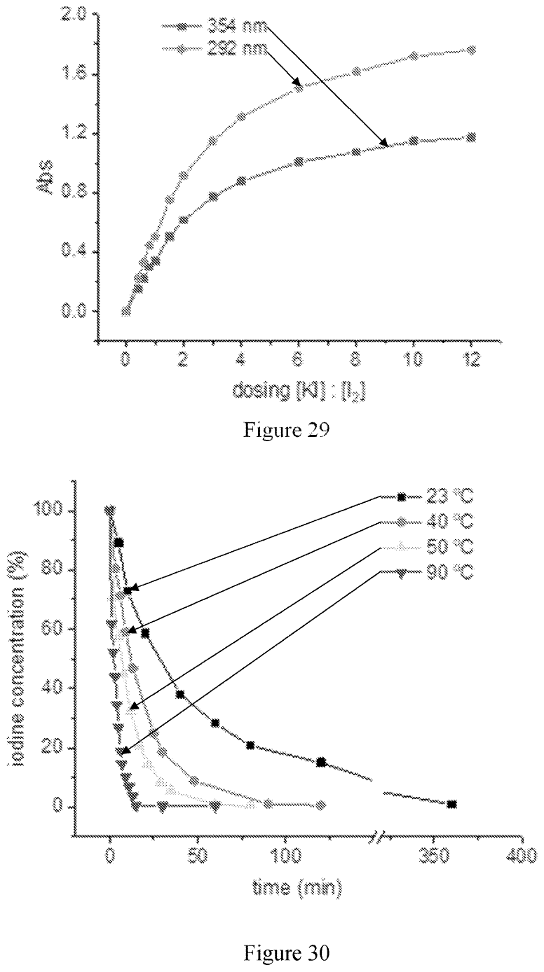

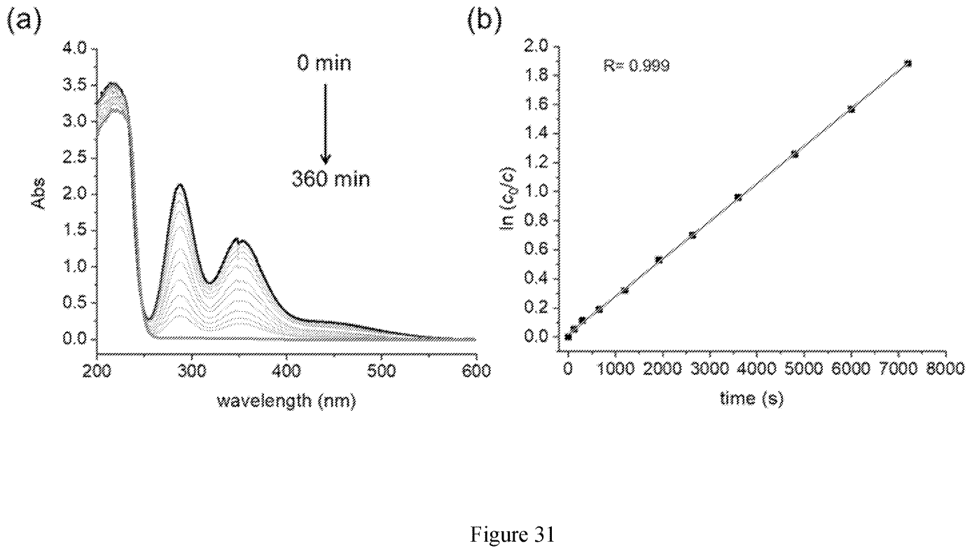

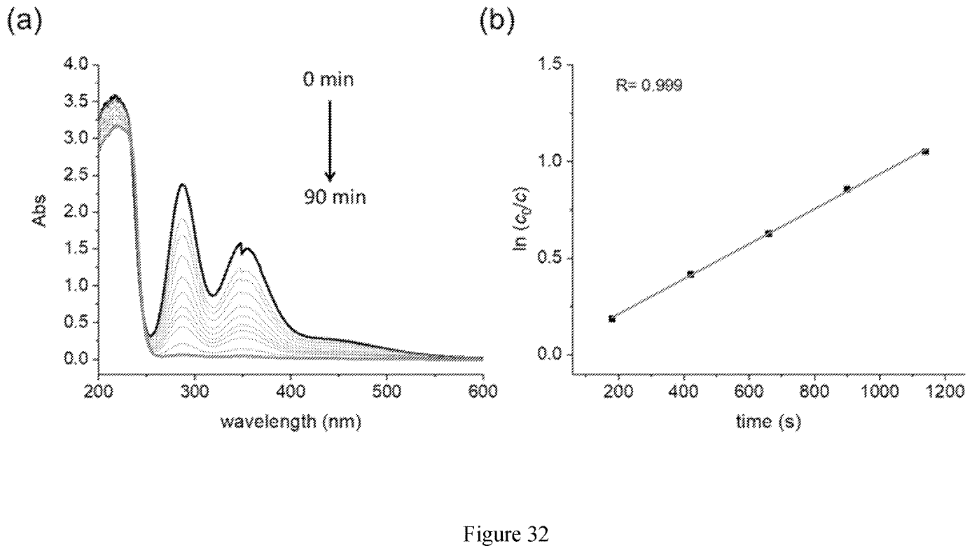

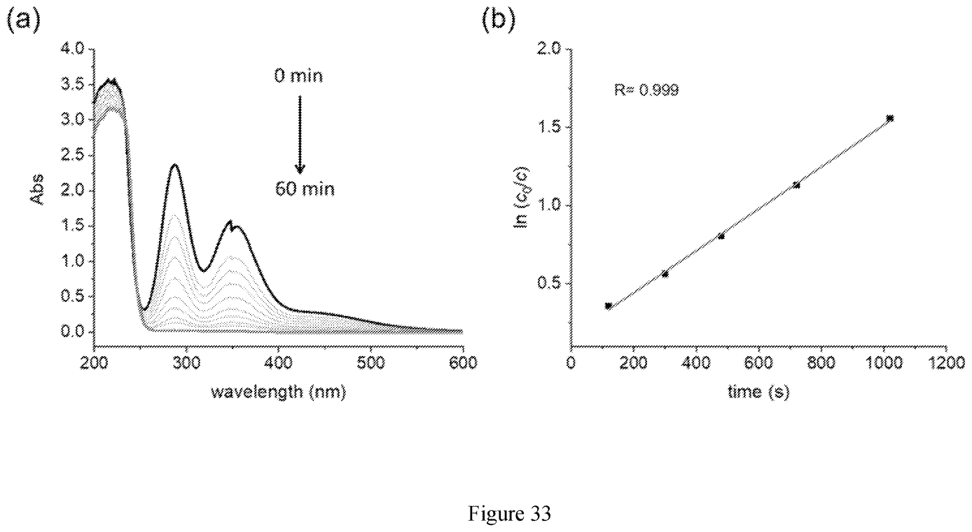

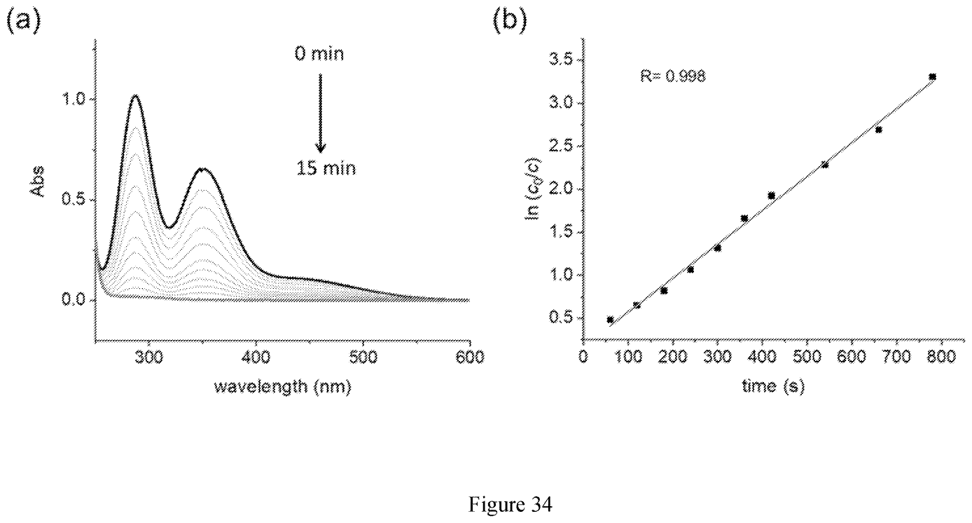

In the aqueous environment, I₂ is stabilized by an excess of KI via the triiodide equilibrium (I₂+I⁻ I₃) with an equilibrium constant of 723 M⁻¹. A UV/Vis titration in a solution of H₂O/MeOH=99:1 was performed and the equilibrium constant Kₐ was measured as 792 M⁻¹ at 23° C. (FIGS. 28-29). When H_{C}OF-7 (10 mg) was added to an I₂/KI solution (0.12 mM 12+0.5 mM KI, 15 mL), the absorption bands attributed to I₂ and I₃⁻ diminished completely, and the adsorption band of I⁻ decreased moderately in the UV-Vis spectra (FIGS. 31-34). The adsorption of iodine/triiodide (I₂/I₃⁻) is accelerated (FIG. 5a) at higher temperatures. Compared to the removal of >99 of iodine/triiodide in 6 h at 23° C., this process only takes 15 min at 90° C. The accelerated iodine/triiodide adsorption at higher temperatures is attributed to easier disruption of the hydrogen-bonded network and faster mass transport within the porous material. The adsorption of iodine/triiodide fits with the pseudo-first-order kinetics, and the activation energy barrier of iodine/triiodide adsorption is calculated as 35.3+6.0 kJ/mol (FIG. 5a, inset).

When H_{C}OF-7 was immersed in a concentrated I₂/KI solution (0.87 M 12+1.02 M KI), the weight-increased amount resulting from the total iodine uptake (I₂/I₃/I⁻) was measured as 1.39±0.07 g/g at 23° C. by gravimetric analysis (FIG. 5b). At higher temperatures, the weight-increased amounts of H_{C}OF-7 gradually reduced to 1.20+0.06 g/g, and 0.97±0.11 g/g, at 50 and 90° C., respectively. In comparison, the total iodine adsorptions of active charcoal measured under the same conditions are much lower, at 0.29±0.02 g/g at 23° C. and 0.16±0.02 g/g at 90° C., respectively (FIG. 5b). To reveal the contribution of the crystalline framework of H_{C}OF-7 for total iodine removal, an amorphous analog of H_{C}OF-7 was also synthesized, namely crosslinked hydrogen-bonded organic polymer (CHOP-7, Scheme 3), by crosslinking 1 with EDT followed by HNO₃⁻ protonation. Despite the nearly identical chemical composition to H_{C}OF-7, the total iodine uptakes of CHOP-7 at different temperatures were lower. The weight-increased amounts of CHOP-7 after the uptake of various iodine species were measured as 0.93+0.08 g/g at 23° C. and 0.67±0.03 at 90° C. (FIG. 5b). These results highlight the importance of the nitrate dimer containing crystalline framework in promoting total iodine removal.

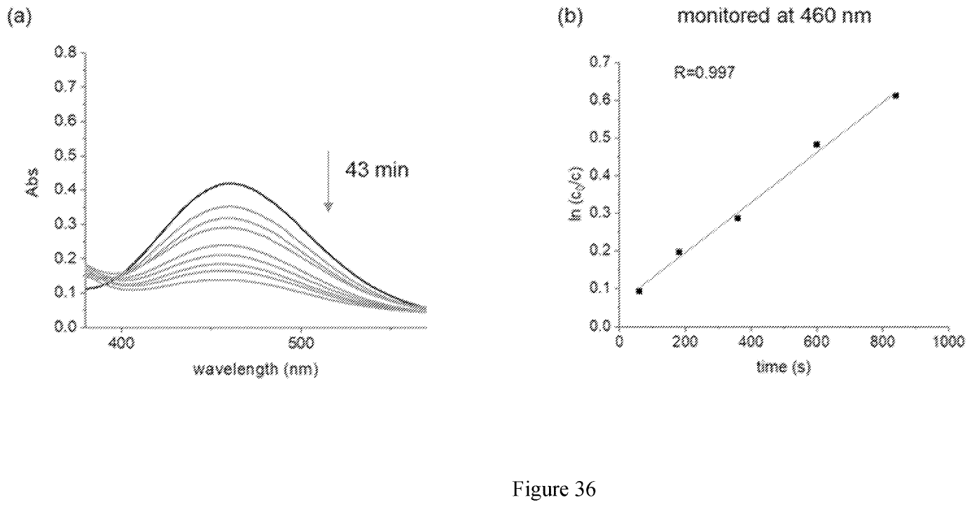

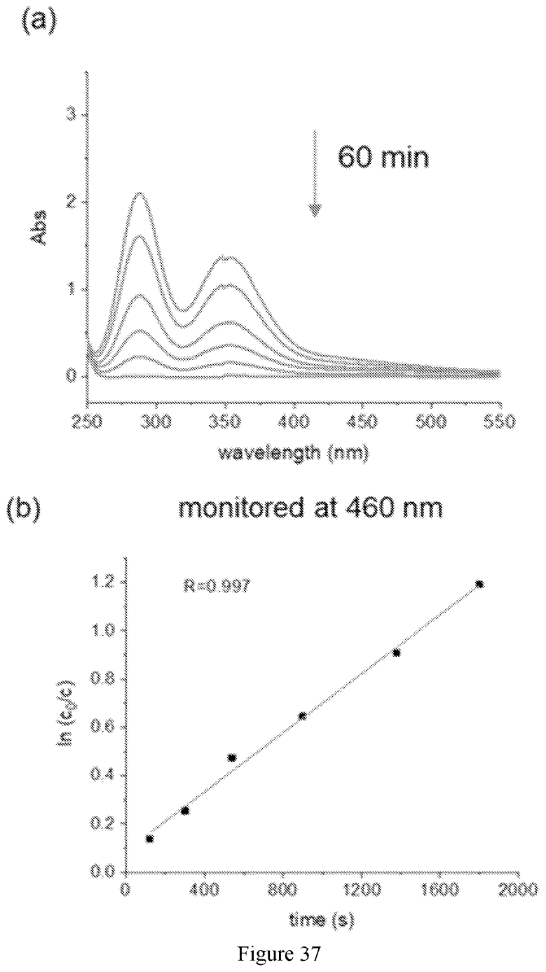

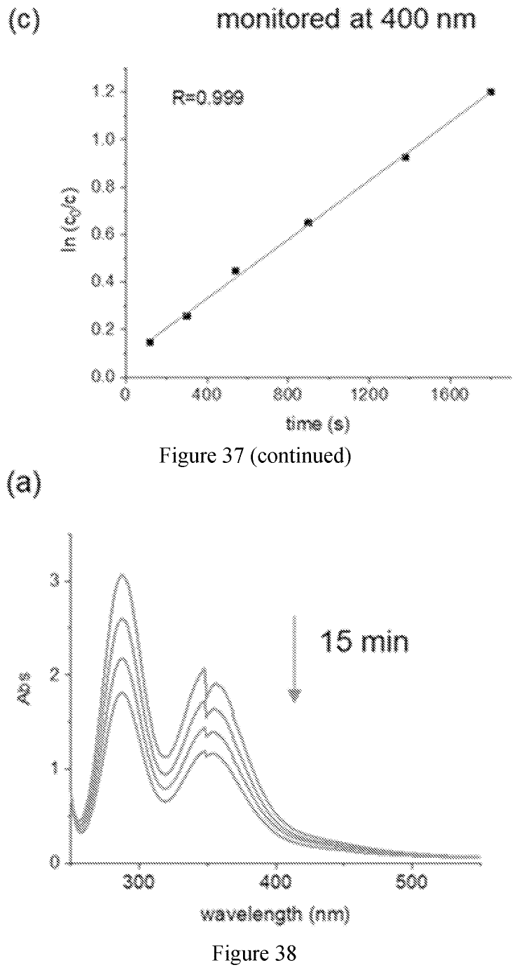

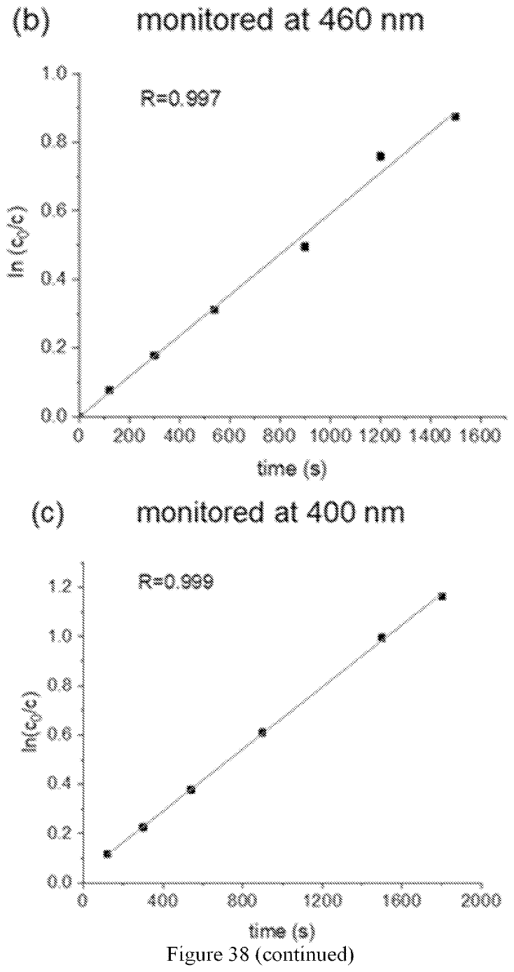

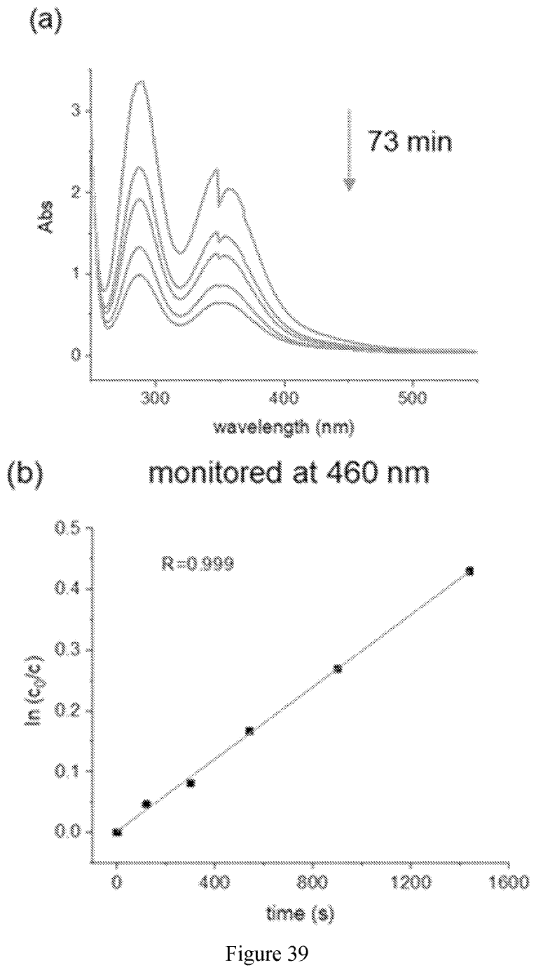

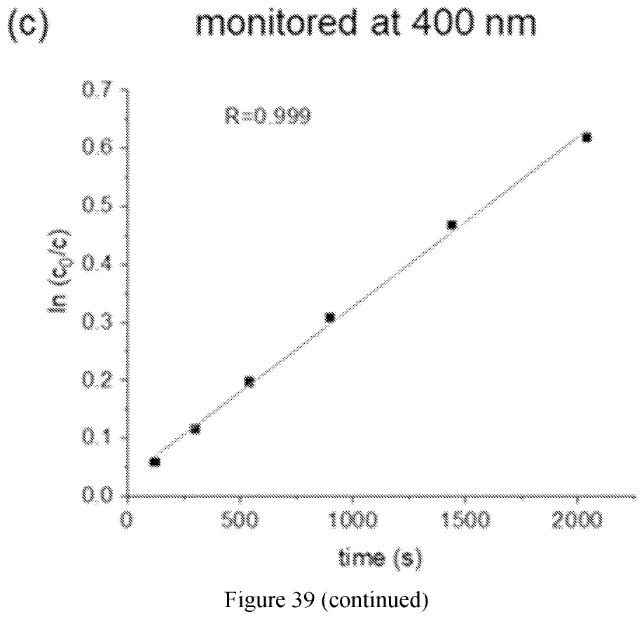

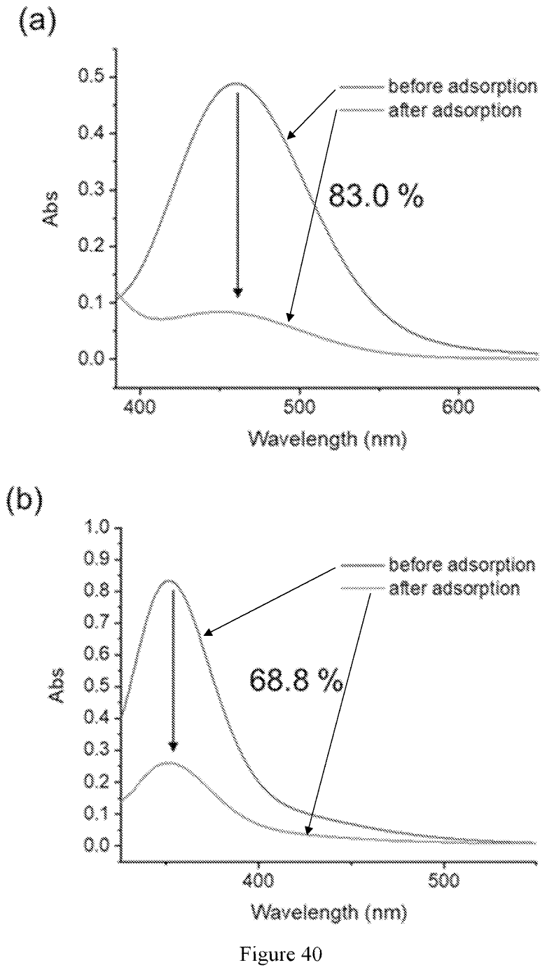

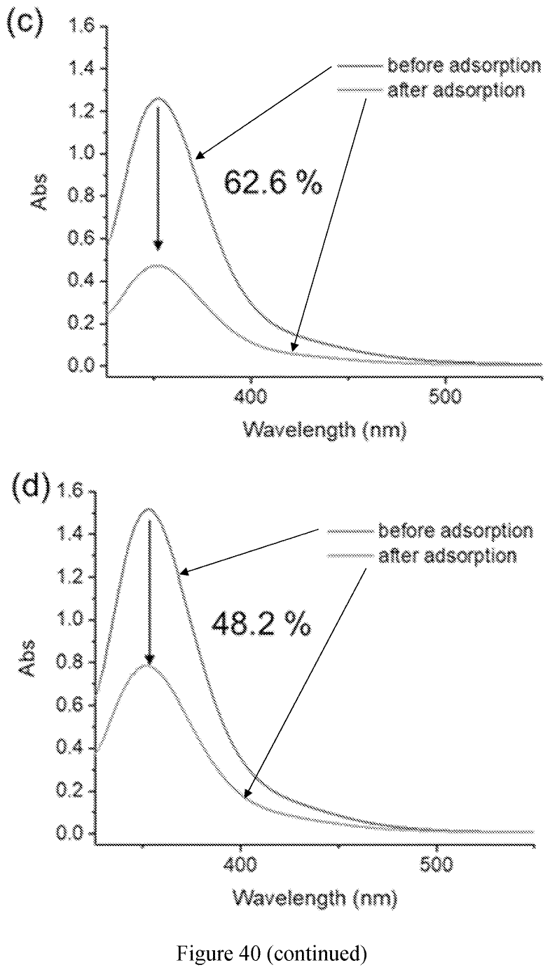

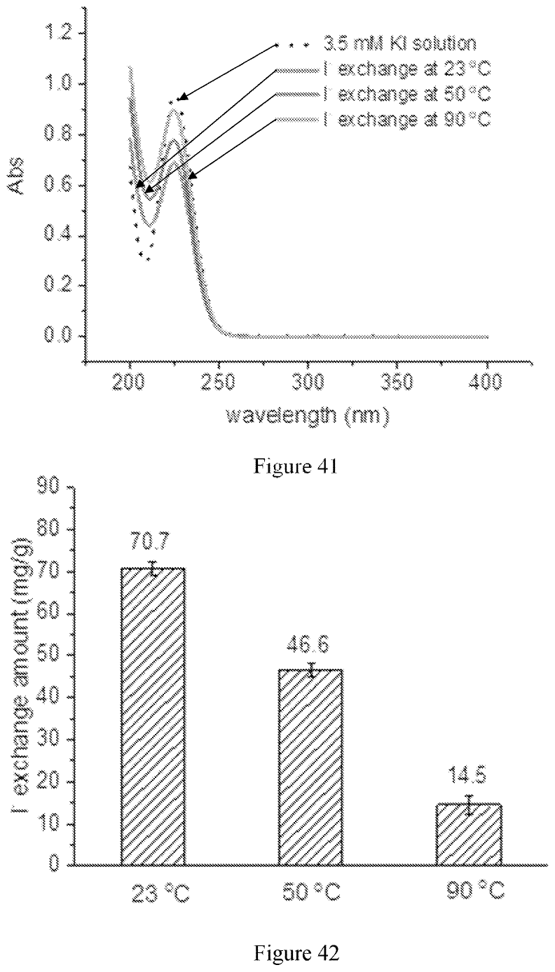

In principle, H_{C}OF-7 may remove various iodine species through the direct adsorption of I₃⁻, or the co-adsorption of I₂ and I⁻. To understand the adsorption process, the rates of iodine removal were measured in an H₂O/MeOH=99:1 solution in the presence of different equivalents of KI (Table 6 and FIGS. 36-39). In the absence of KI, the rate of 12 removal was measured as 6.65+0.30×10⁻⁴ s⁻¹ at 23° C. When I₂ was mixed with I₂ equiv. of KI to increase the population of I₃⁻ to 84% at the initial equilibrium, the iodine removal rate (accounting for I₂ and I₃⁻) decreased to 2.97±0.06×10⁻⁴ s⁻¹. Furthermore, the iodine removal efficiency of H_{C}OF-7 was reduced from 83% in the absence of KI to 48% in the presence of I₂ equiv. of KI (Table 7 and FIG. 40). The reduced iodine adsorption rates and efficiencies in the presence of KI indicated that the co-adsorption of I₂ and I⁻ is the major adsorption path, where H_{C}OF-7 adsorbs I₂ in solution via halogen bonding interactions between the I₂ and melaminium moieties, shifting the equilibrium away from the formation of I₃⁻.

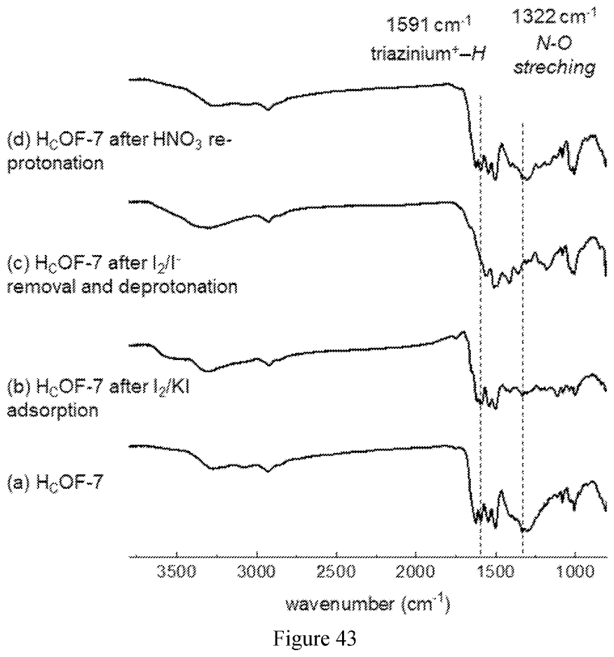

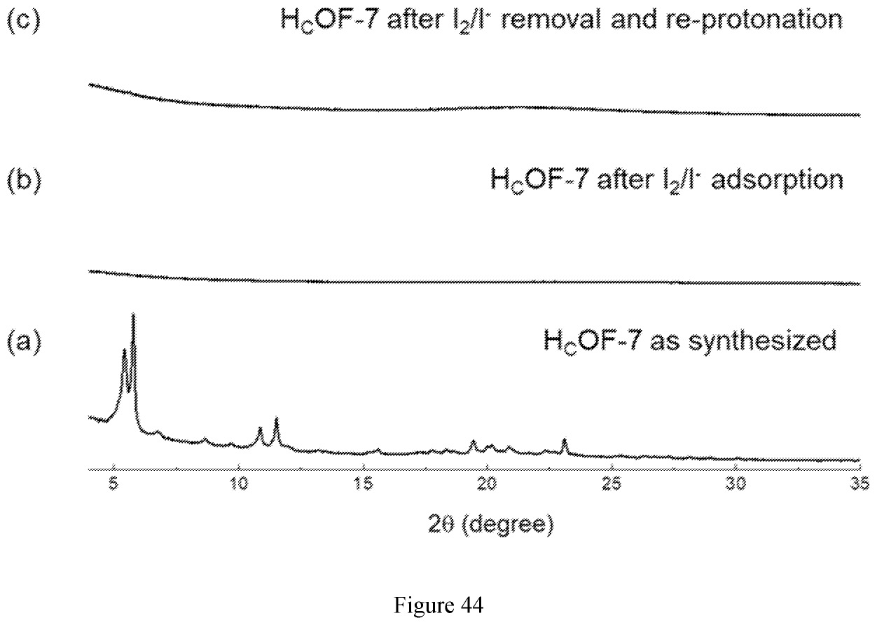

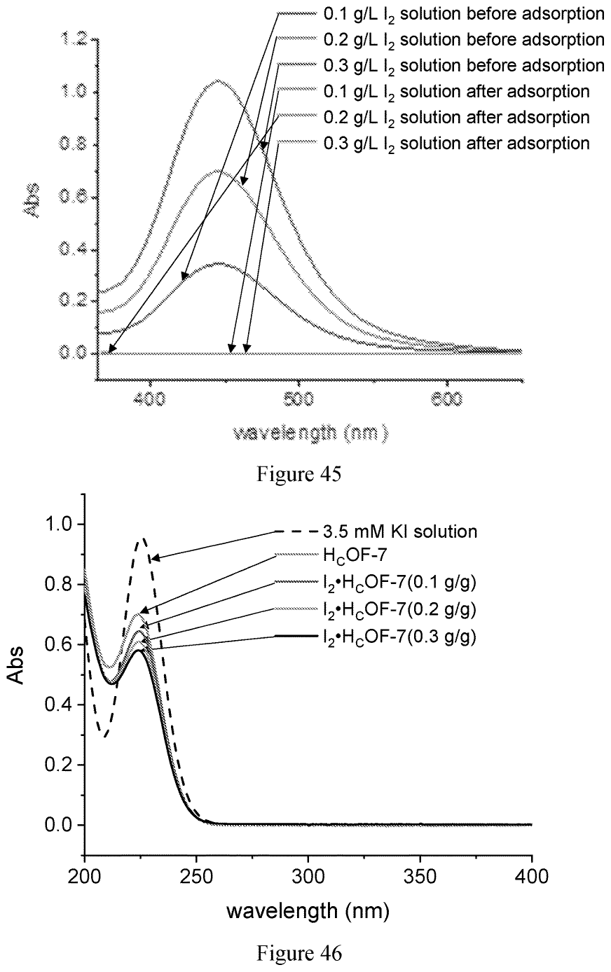

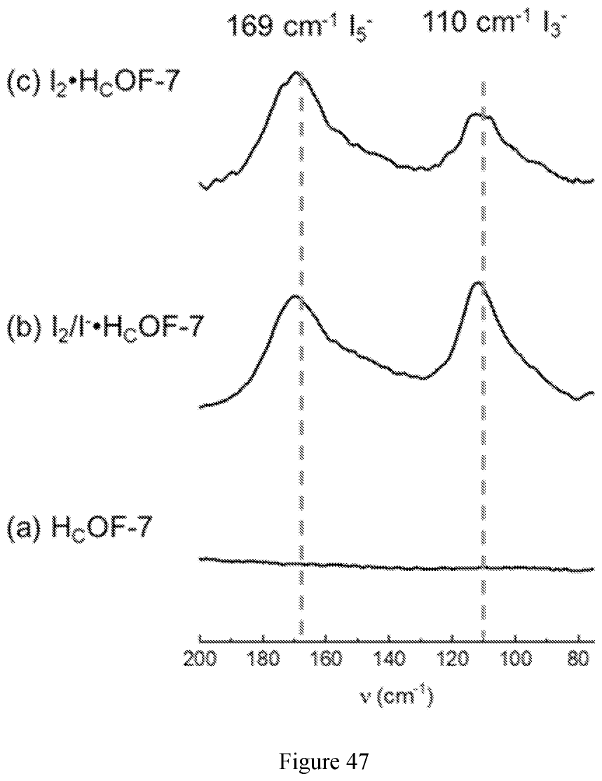

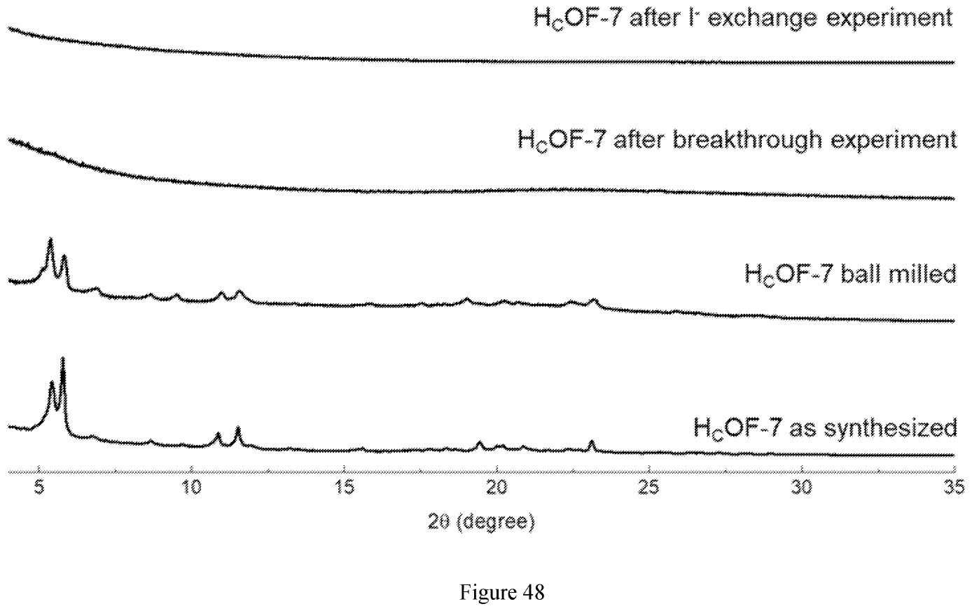

H_{C}OF-7 likely removes I⁻ through a nitrate-to-iodide (NO₃⁻ 1-) exchange. When H_{C}OF-7 (5 mg) was immersed in a KI aqueous solution (3.5 mM, NO₃⁻ I⁻ ratio=1:1), 27±1 of NO₃⁻ in H_{C}OF-7 was exchanged to I⁻ at 23° C. (70.7±1.8 mg/g, FIG. 5c). After the anion exchange, the N—O stretching band at 1322 cm⁻¹ attributed to the NO₃⁻ decreased significantly in the FT-IR spectra (FIG. 43). Despite a moderate NO₃⁻/I⁻ exchange efficiency at equal moles of NO₃⁻ and I⁻, it was noticed that the adsorbed I₂ in H_{C}OF-7 (I₂·H_{C}OF-7) promotes anion exchange (FIG. 5c). I₂·H_{C}OF-7 samples were prepared by immersing H_{C}OF-7 in the methanolic solutions of I₂ (FIG. 45). When samples of I₂·H_{C}OF-7 (0-0.3 g/g) were employed for the NO₃⁻/I⁻ exchange at 23° C., the anion exchange efficiency increased from 27±1% to 37±2% (FIG. 5c). These results indicate that despite iodine adsorption and NO₃⁻/I⁻ exchange taking place separately, the formation of polyiodide (13 and I₅⁻, FIG. 47) inside H_{C}OF-7 promotes the anion exchange efficiency. After the I₂ adsorption and NO₃⁻/I⁻ exchange, H_{C}OF-7 lost crystallinity due to the disruption of the hydrogen-bonded network (FIG. 44).

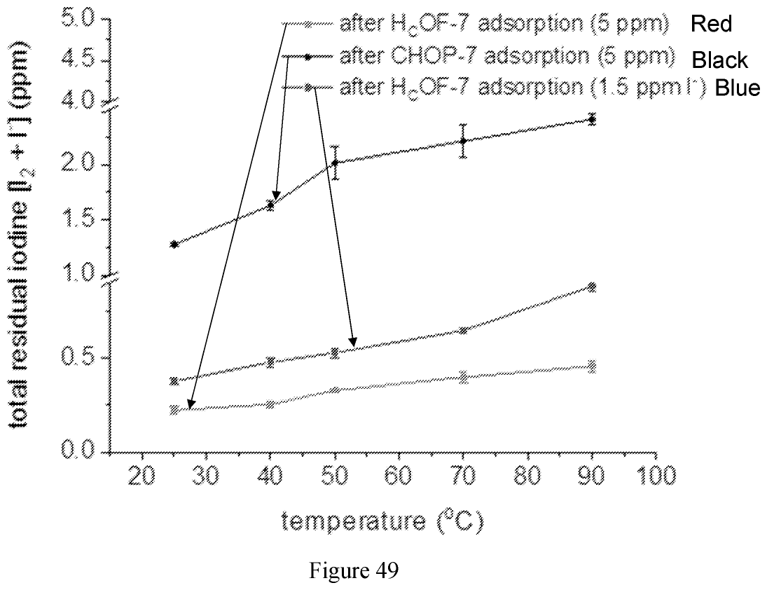

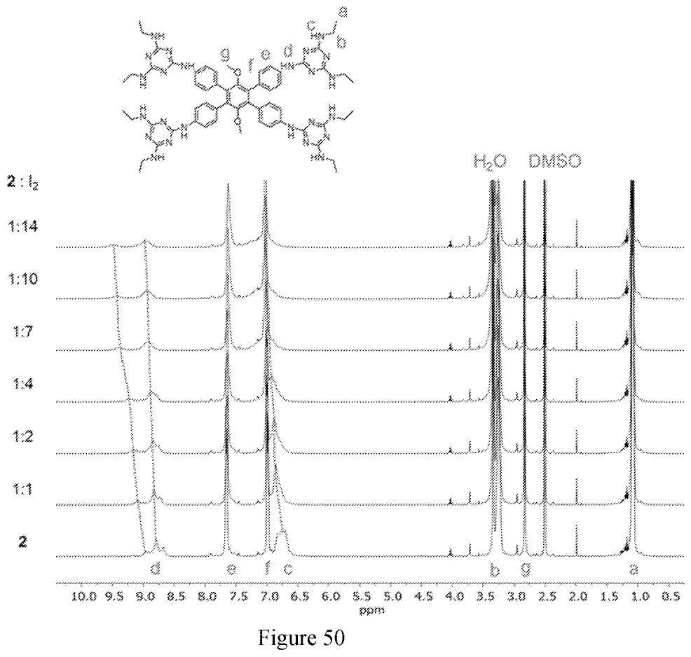

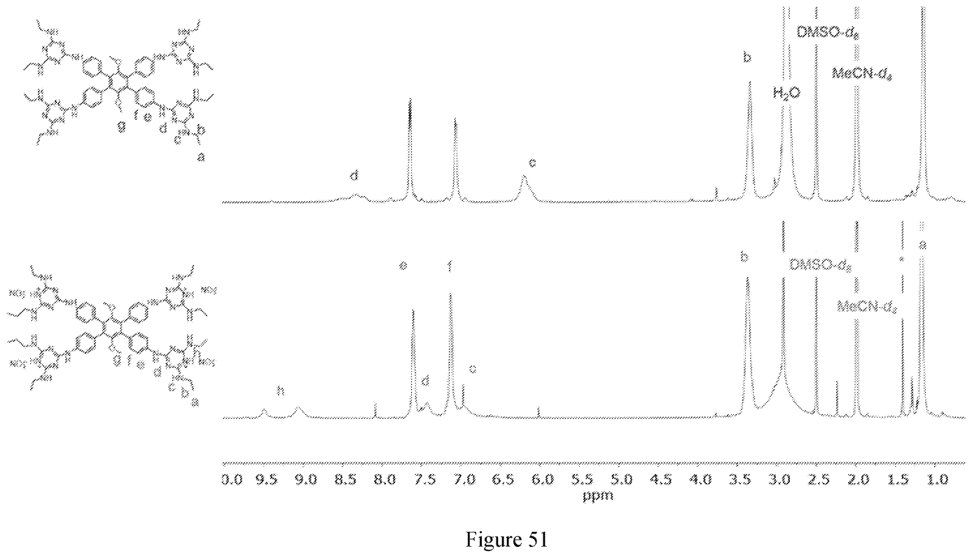

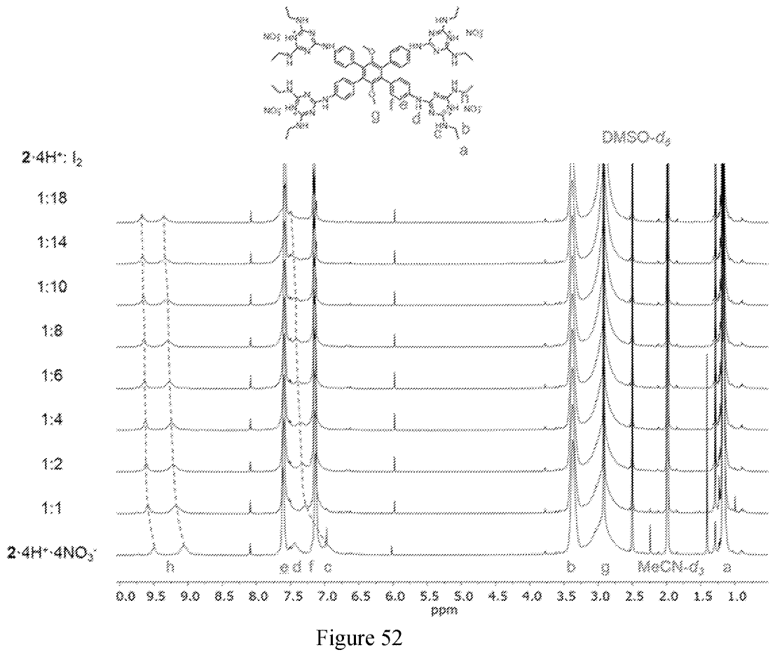

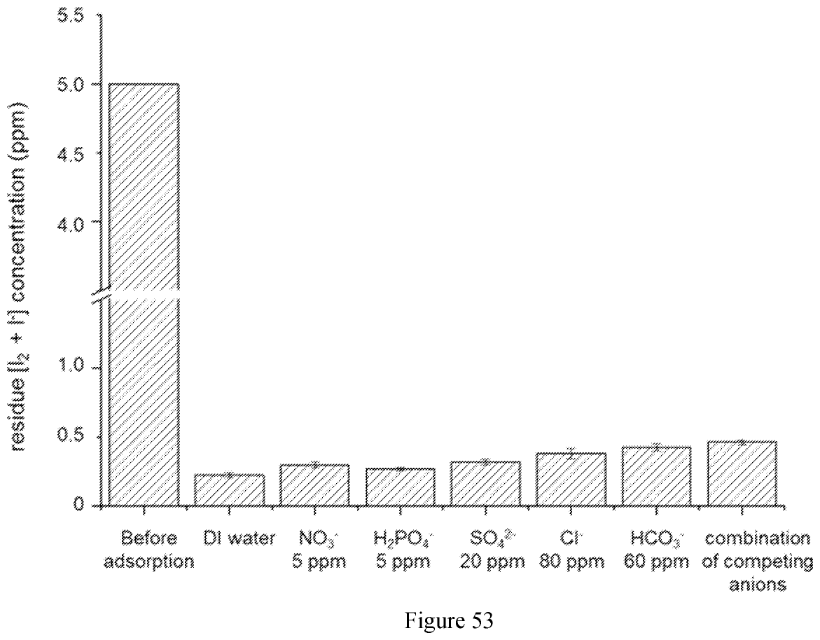

To mimic the iodine/iodide removal in water disinfection, an I₂/KI solution was prepared at 5 ppm (I₂: 3.5 ppm, I⁻: 1.5 ppm) and a KI solution at 1.5 ppm before iodine/iodide removal. At this concentration, the population of triiodide is negligible (Table 4). The total residual iodine (I₂+I⁻) was measured using the Leuco-crystal violet method (Scheme 4). H_{C}OF-7 showed excellent total iodine removal capabilities for the I₂/KI solutions, and the total residual iodine concentrations were measured as 0.22±0.02 (23° C.), 0.25±0.02 (40° C.), 0.32±0.01 (50° C.), 0.40±0.01 (70° C.), and 0.45±0.03 ppm (90° C.) (FIGS. 5d and 49). In contrast, the total residual iodine concentrations of H_{C}OF-7 for the KI solutions were measured as 0.38±0.02 (23° C.), 0.48±0.03 (40° C.), 0.53±0.03 (50° C.), 0.64±0.01 (70° C.), and 0.88±0.02 ppm (90° C.) (FIG. 49). These results further support a cooperative iodine/iodide adsorption in H_{C}OF-7. Furthermore, the total residual iodine concentrations of CHOP-7 for the I₂/KI solutions were measured between 1.06±0.02 (23° C.) and 2.03±0.03 ppm (90° C.), which are much higher than those of H_{C}OF-7 (FIG. 49). This comparison demonstrated the benefit of introducing crystalline framework architectures for collective iodine/iodide removal.

In natural water, anions such as NO₃⁻, H₂PO₄⁻, SO₄⁻, Cl⁻, and HCO₃⁻ may impact the total iodine removal efficiency of H_{C}OF-7. Therefore, to simulate co-existing anions in natural water, NO₃⁻ (5 ppm), H₂PO₄⁻ (5 ppm), SO₄⁻(20 ppm), Cl⁻ (80 ppm), HCO₃⁻(60 ppm) were added to the I₂/I⁻ solutions (I₂: 3.5 ppm, KI 1.5 ppm) individually and as a mixture. H_{C}OF-7 crystals (6 mg) were added to these solutions (3 mL). After 72 h, the total residual iodine concentrations (FIG. 5d) were measured as 0.30±0.02, 0.27±0.01, 0.32±0.02, 0.38±0.03, 0.43±0.03, 0.46±0.02 ppm, respectively. The results confirmed that the total iodine removal efficiency of H_{C}OF-7 remained high in the presence of various competing anions.

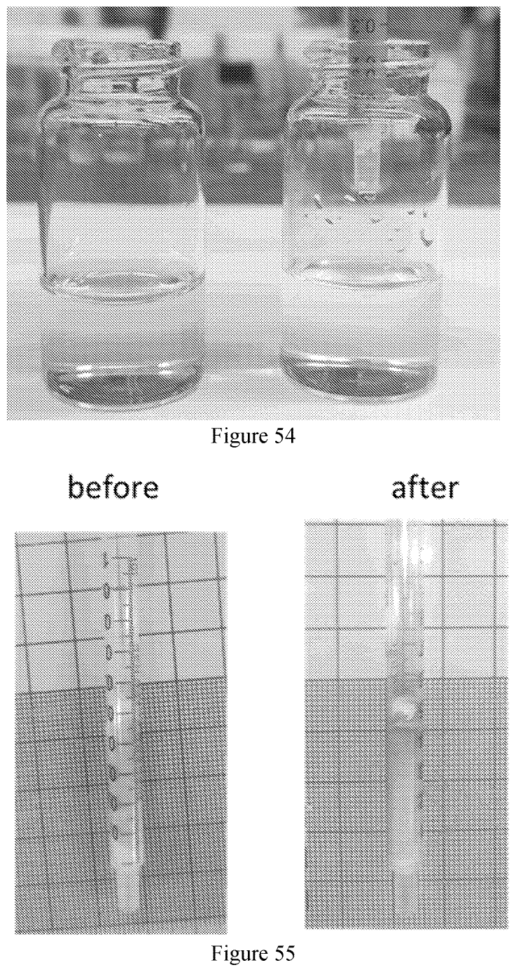

To quantitatively analyze the dynamic iodine removal capability of H_{C}OF-7 at different temperatures, H_{C}OF-7 columns were prepared for chromatographic breakthrough investigations (FIG. 5e). Ball-milled H_{C}OF-7 crystals (240 mg) were packed into a polypropylene plastic column and loaded onto an automatic column chromatography instrument (FIGS. 54-55). The intake 12/KI solution (5 ppm) was pre-heated to the desired temperatures in a customized pre-column (FIG. 5e) before passing through the H_{C}OF-7 column. Iodinated DI water was injected into the H_{C}OF-7 column continuously with a flow rate of 5 mL/min, and the total residual iodine concentrations were measured at different volume intervals. At 23° C., the total residual iodine concentrations gradually increased from 0.30 ppm to 0.40 ppm in the first 1.2 L and remained constant for the subsequent 4.8 L until the breakthrough. When the temperature was increased to 50° C., the total residual iodine concentrations increased from 0.58 ppm to 0.8 ppm for 4.8 L of iodinated water until breakthrough. At 90° C., the column quickly reached equilibrium in the first 0.72 L intake of iodinated water. The total residual iodine concentration was measured at 0.8 ppm for 4.4 L intake before breakthrough. The faster equilibrated dynamic adsorption at higher temperatures is consistent with the accelerated iodine adsorption rates measured in the temperature-dependent adsorption experiments (FIG. 5a). The decreased breakthrough volumes of H_{C}OF-7 columns at higher temperatures are also consistent with their reduced iodine adsorption capacities (FIG. 5b). It is worth noting that the breakthrough volumes of H_{C}OF-7 columns are much larger than the activated carbon and activated carbon/anion exchange resin mixed-bed columns (FIG. 5f). Furthermore, the high-temperature breakthrough results of H_{C}OF-7 columns are vital for the design of the next-generation iodine filter used in outer space, as the current design in the International Space Station requires pre-chilling of the hot water generated in the reactor before passing through the PWD and reheating water for hot beverages.

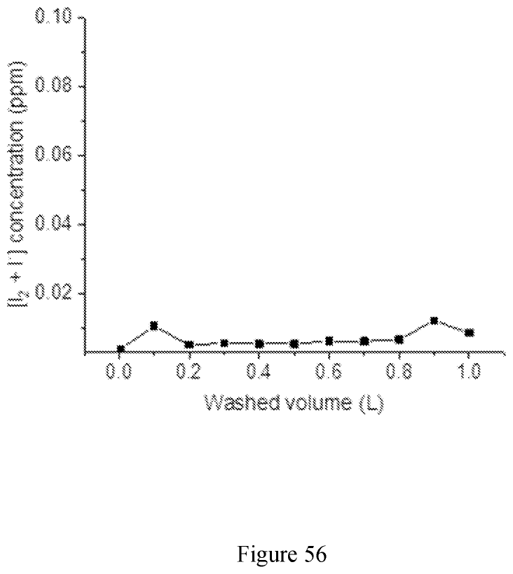

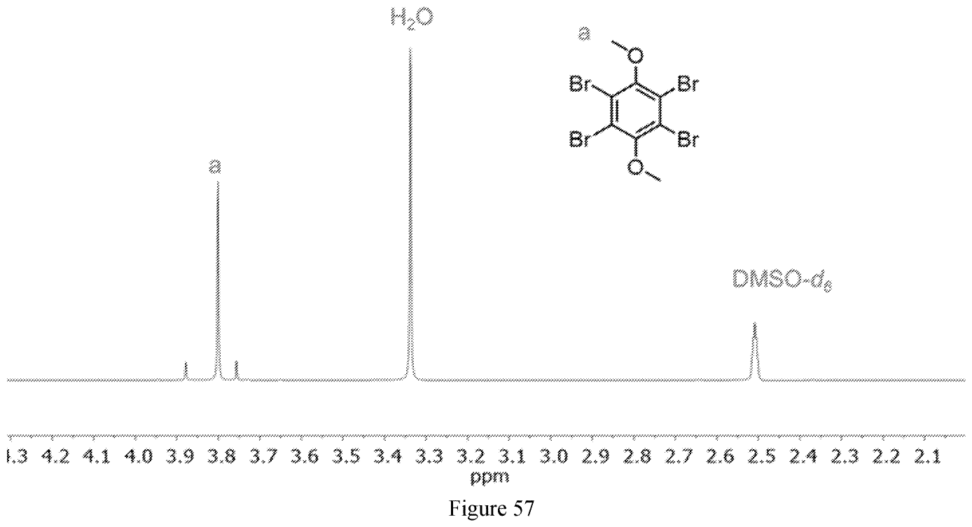

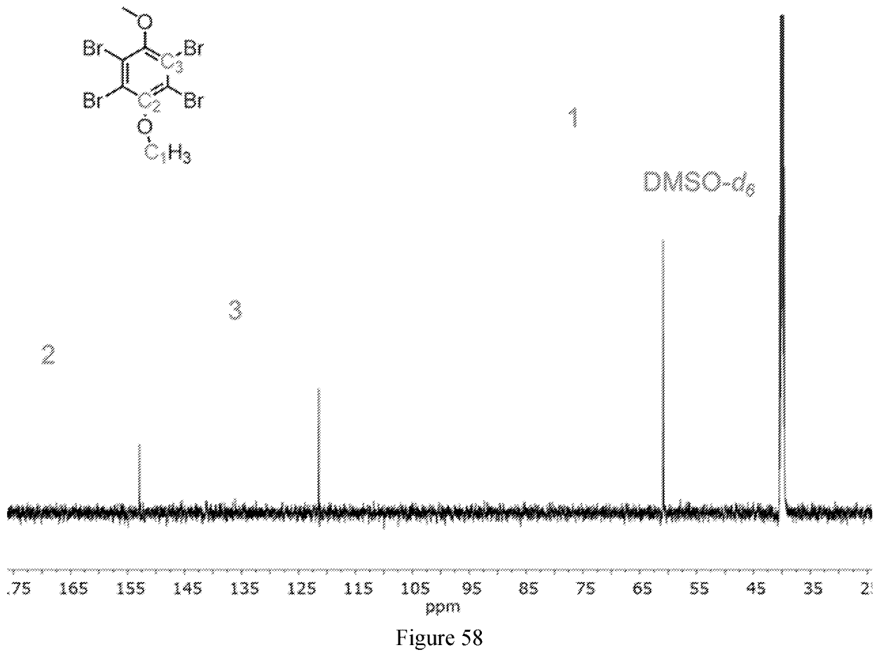

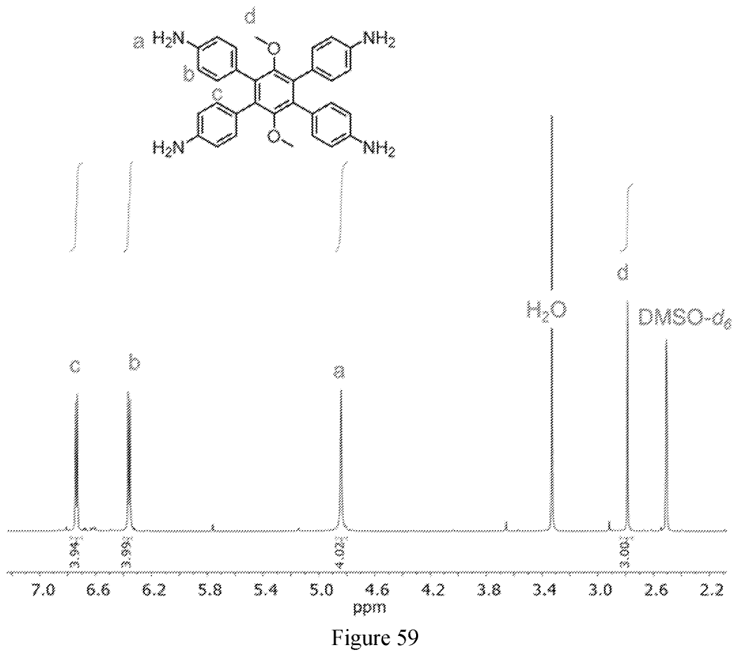

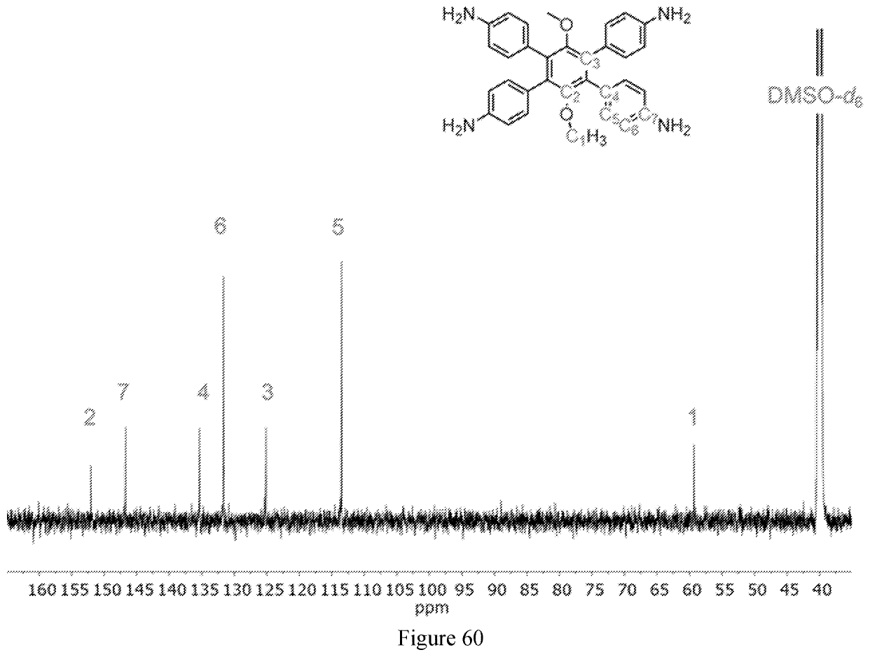

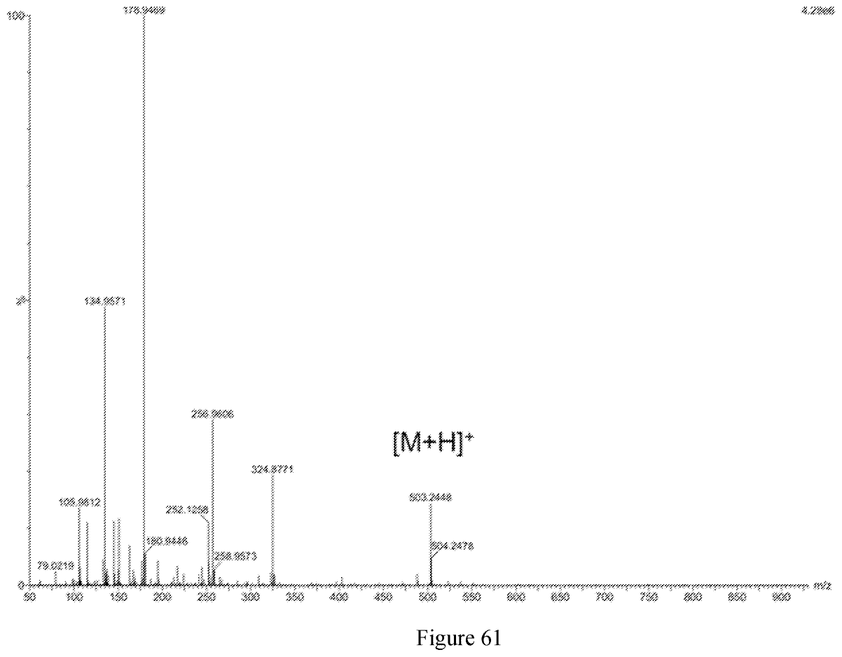

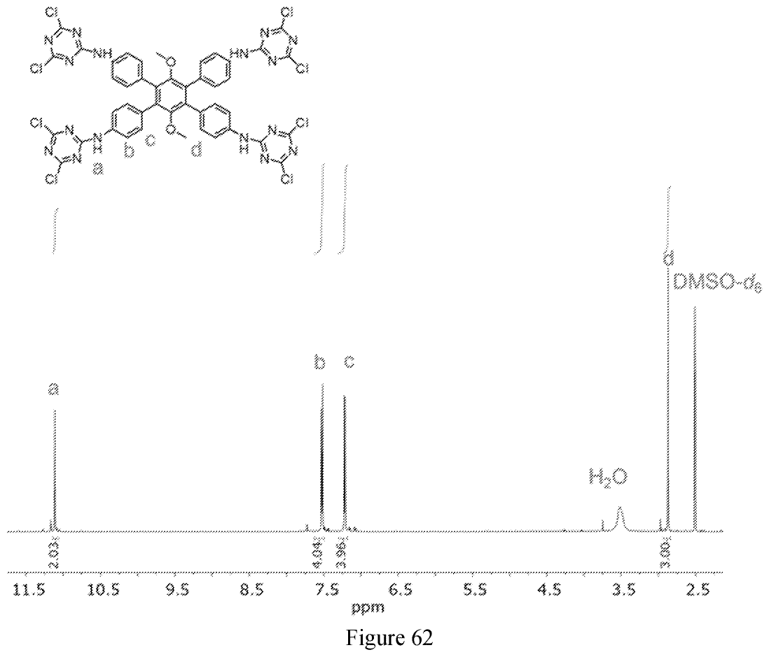

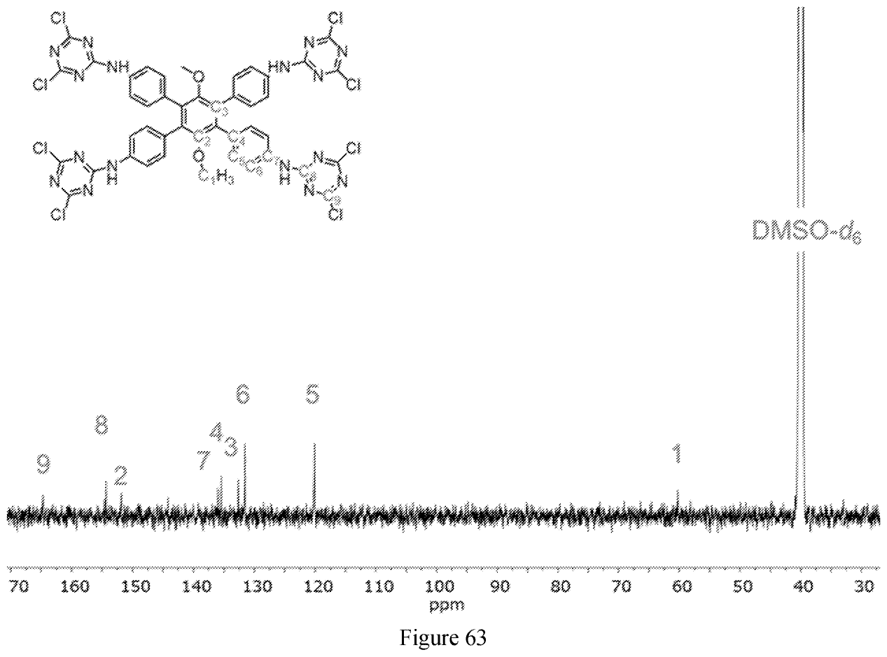

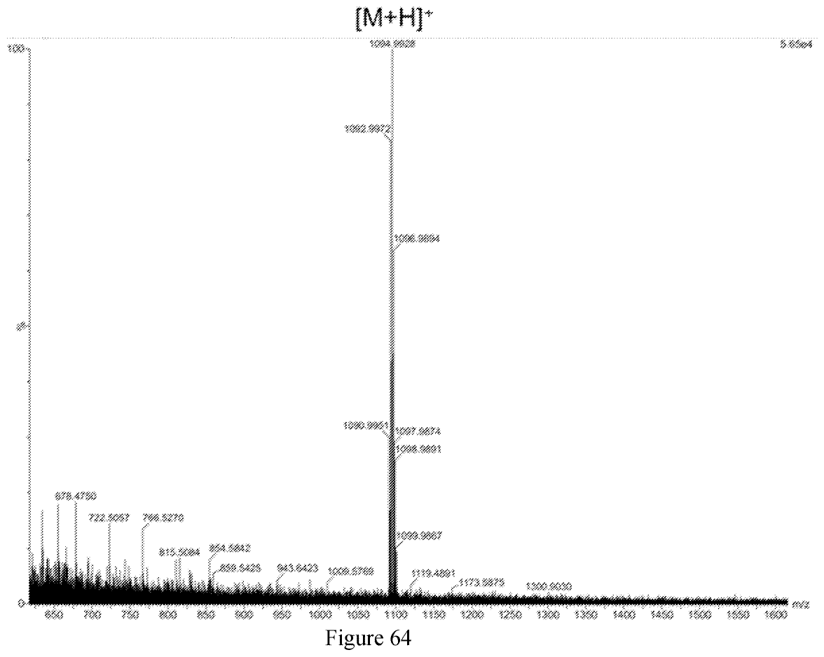

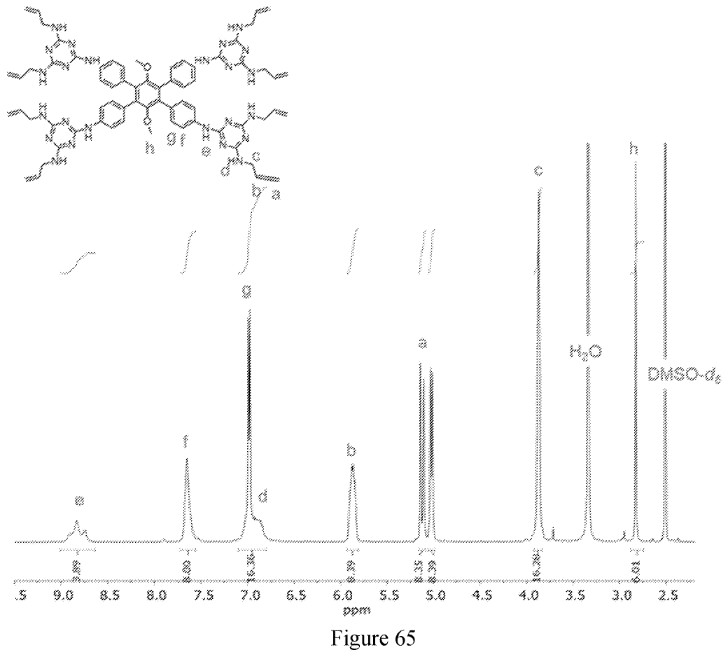

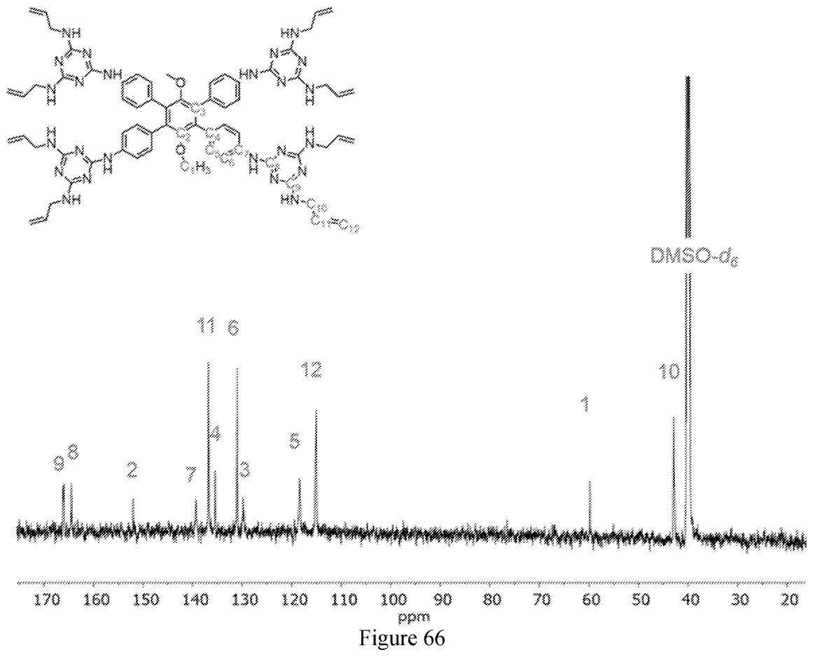

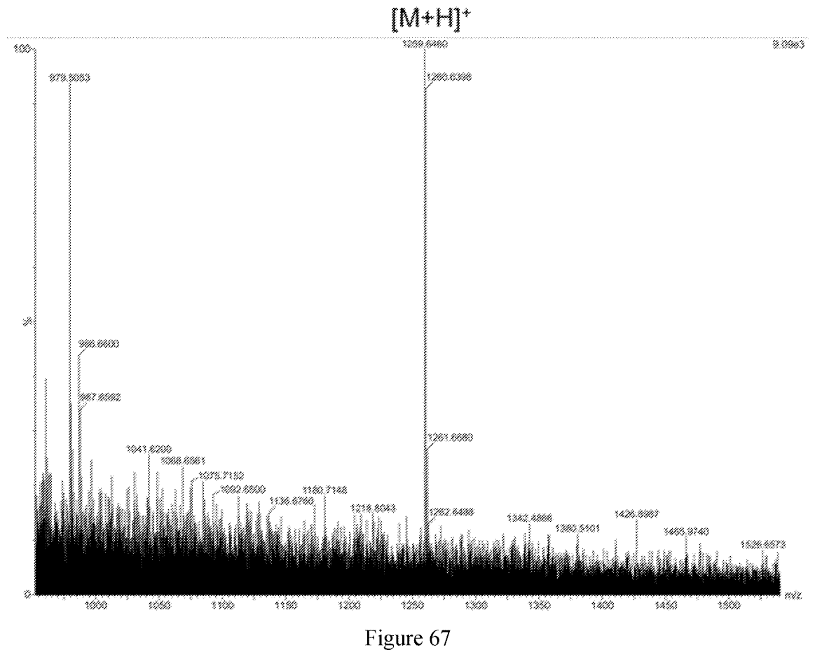

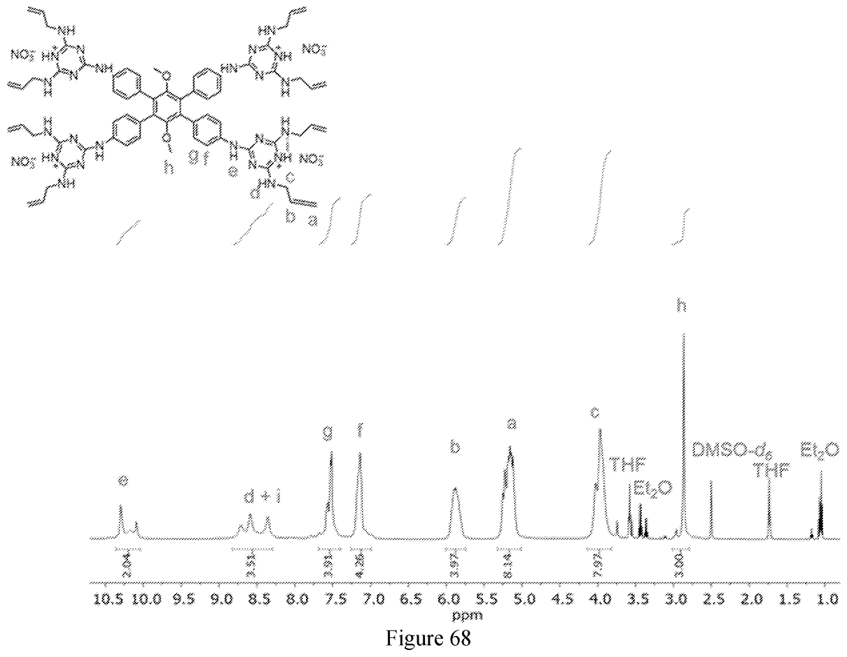

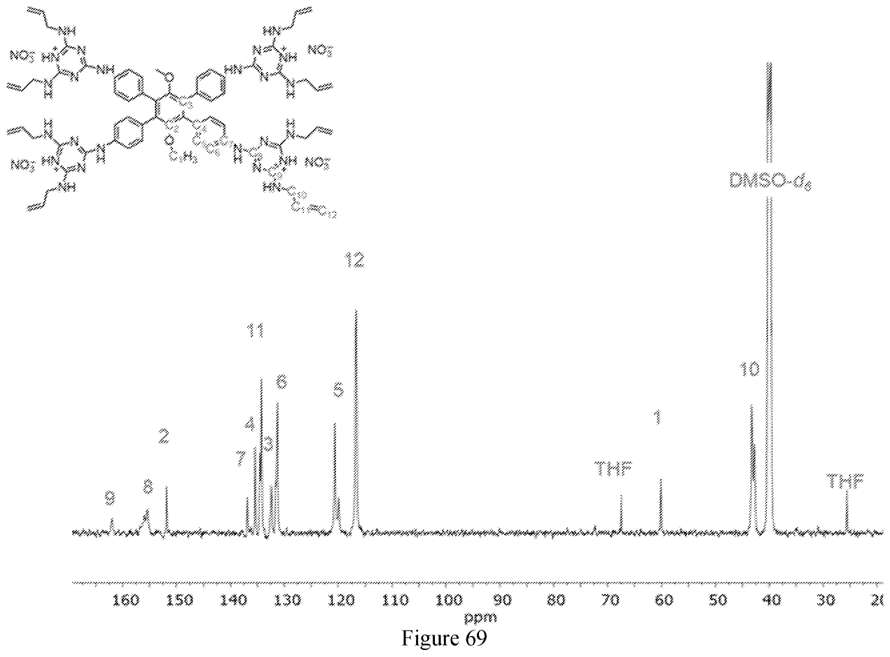

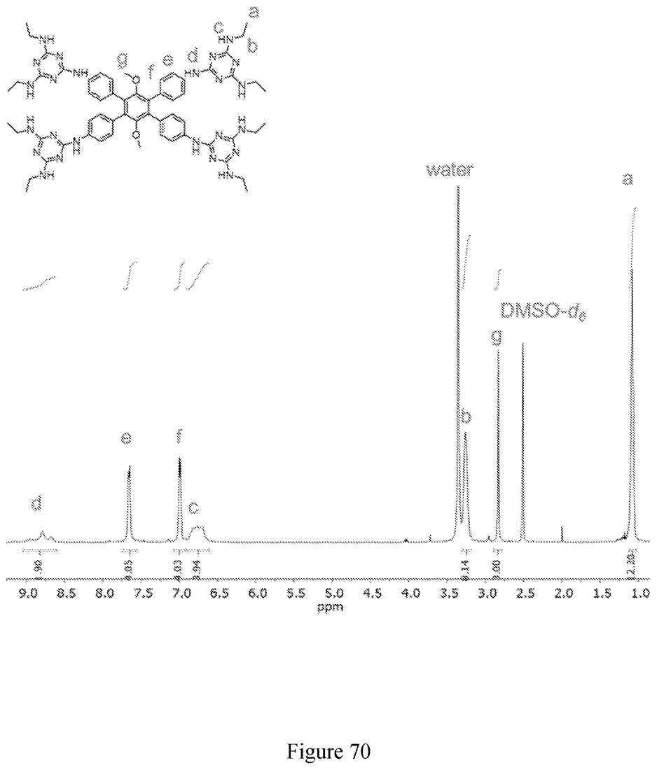

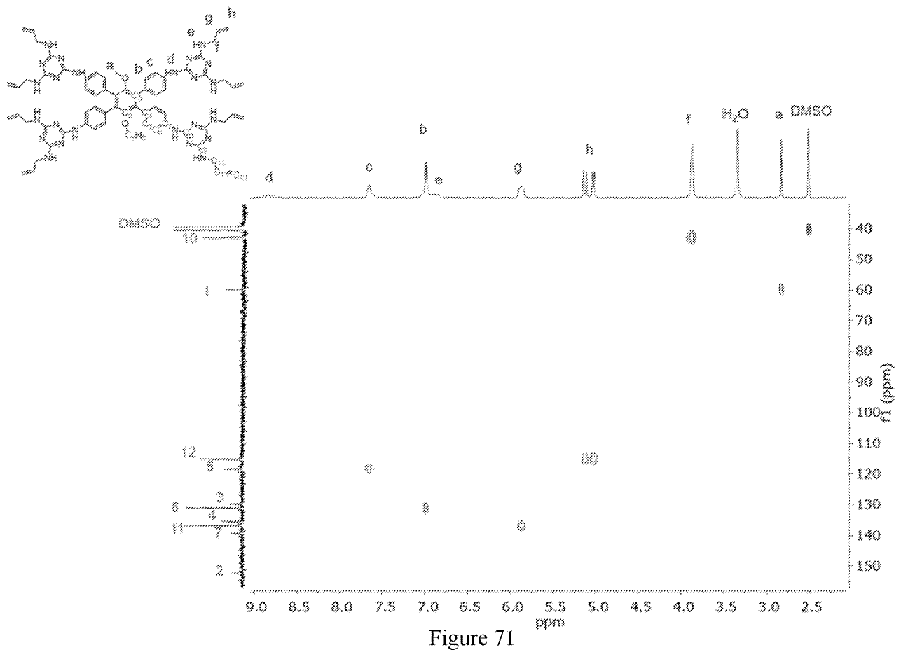

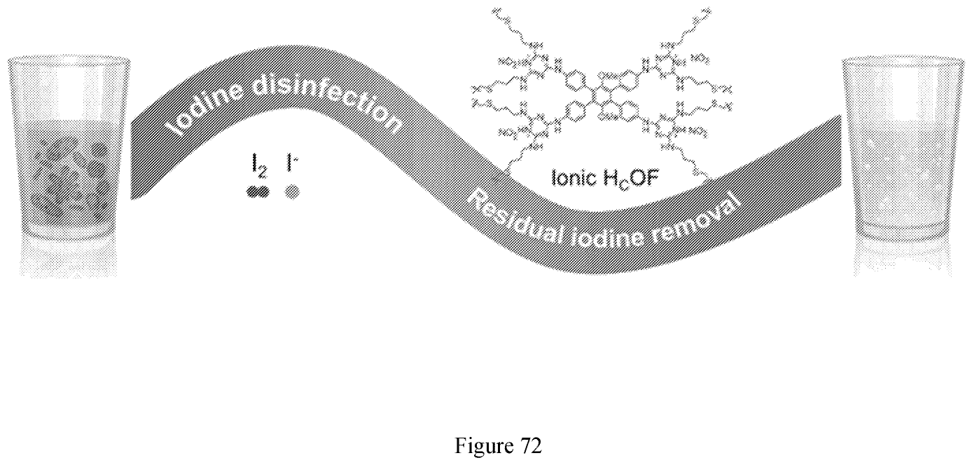

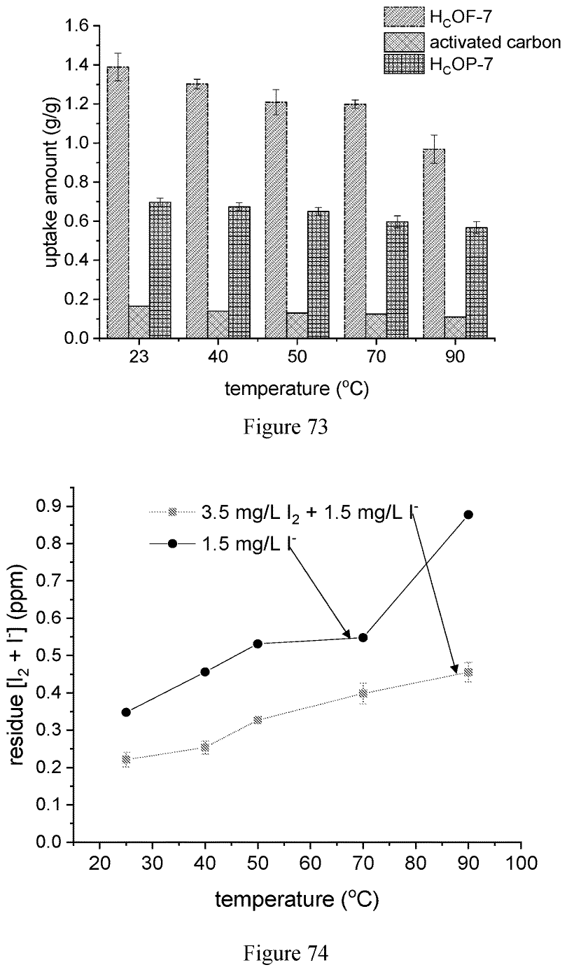

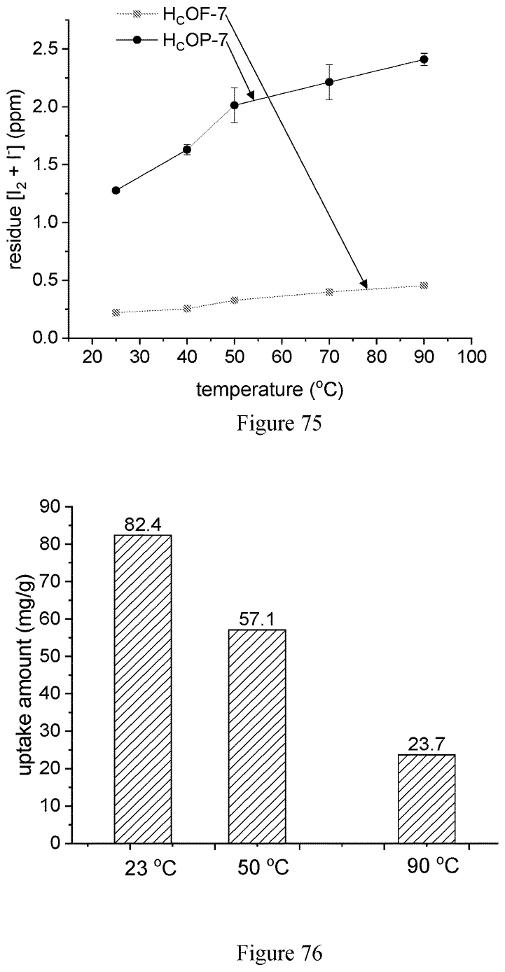

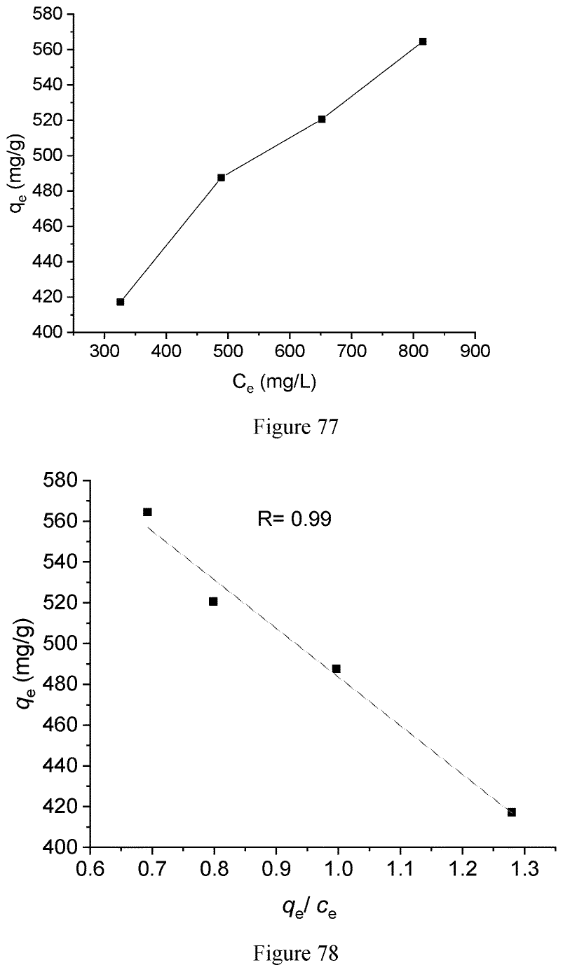

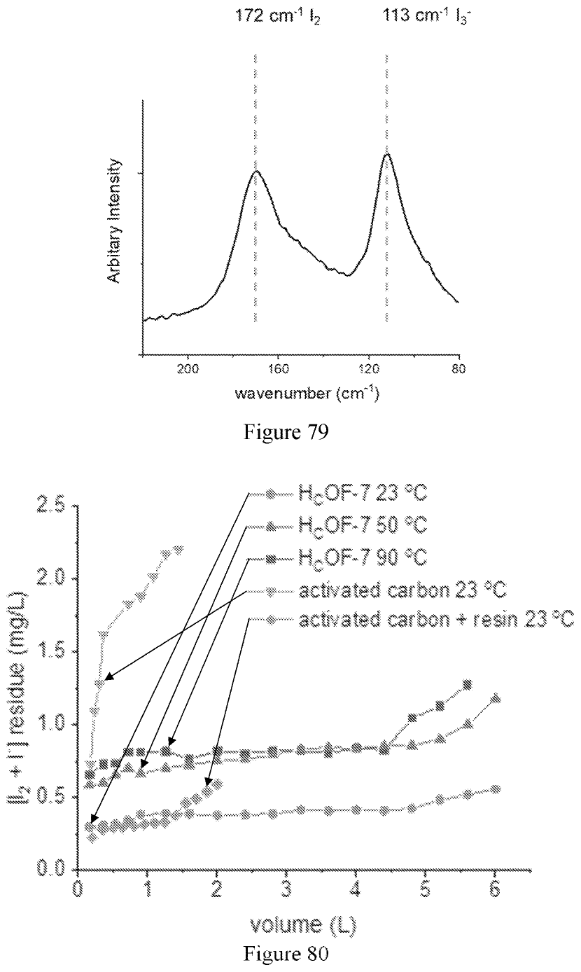

The breakthrough experiment was performed using iodinated tap water (I₂: 3.5 ppm, I⁻: 1.5 ppm) at 23° C. (FIG. 5f). The total residual iodine concentrations increased from 0.47 to 0.51 ppm for 3.7 L intake before breakthrough. Compared to iodinated DI water, the total iodine removal efficiency was maintained at ~90% (from 5 ppm of total iodine), and the breakthrough volume decreased moderately by 23%. After the breakthrough experiment, the adsorbed iodine and iodide species were well-retained in H_{C}OF-7. Possible Iodine leaching was tested by passing 1 L tap water through the iodine-containing H_{C}OF-7 column. No significant residual iodine was detected (<0.1 ppm, FIG. 56), suggesting that the used amorphous H_{C}OF-7 columns after the iodine and iodide remediation could be recycled for long-term storage of iodine/iodide.

### General Information

All chemical reagents and solvents were purchased from commercial suppliers, including Fisher Scientific, Sigma Aldrich, and VWR, and were used as received. ¹H NMR spectra were recorded on either a Bruker AVIII 500 MHz spectrometer or a Bruker AVIII 600 MHz Spectrometer and referenced to residual solvent peaks. Single crystal diffraction data were collected on an XtaLAB Synergy four-circle diffractometer (Dualflex HyPix detector). Elemental analysis was performed by Intertek Pharmaceutical Services (Whitehouse, NJ). UV/Vis spectroscopy was carried out on a Shimadzu UV-1800 UV/Vis spectrometer. Fourier transform infrared (FT-IR) spectra were recorded on a Jasco 6200 spectrometer. Powder X-ray Diffraction (PXRD) data were collected on the Rigaku MiniFlex powder X-ray diffractometer. Thermogravimetric analysis (TGA) was performed on a TA instrument discovery 55 with samples held in a platinum pan under a nitrogen atmosphere. Data were collected between room temperature and 1000° C. with a ramp rate of 10° C./min under a nitrogen atmosphere. Supercritical CO₂ activation was performed with a Samdri 795 Critical Point Dryer. Vapor sorption measurements were performed on a Micromeritics FLEX 3.0 surface area analyzer at 297 K.

### Synthesis of Monomers

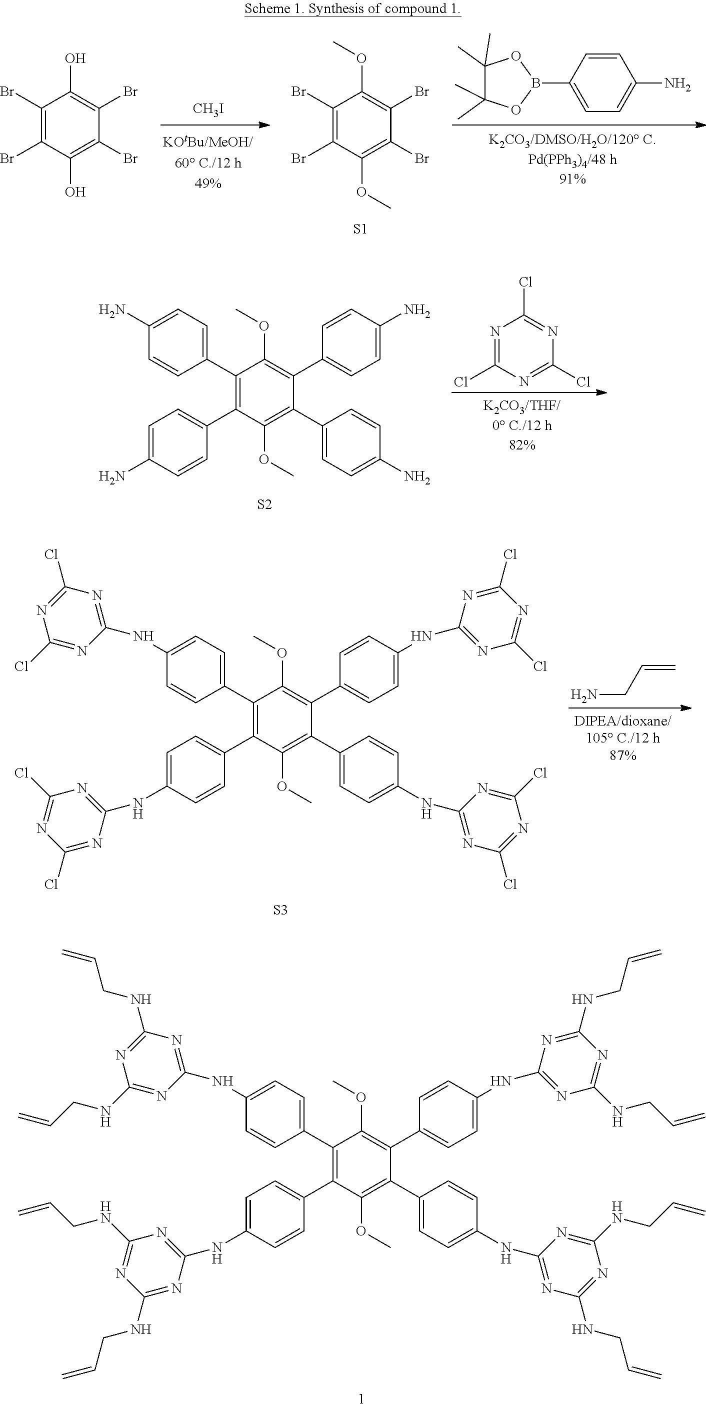

Synthesis of S2. 2,3,5,6-Tetrabromobenzene-1,4-diol (0.85 g, 2.0 mmol) was dissolved in MeGH (15 mL) in a 50 mL round bottom flask. Potassium tert-butoxide (0.45 g, 4.0 mmol) and iodomethane (1.2 g, 8.5 mmol) were added to the reaction. The mixture was heated to 50° C. under an N₂ atmosphere. After I₂ h, the formed white crystalline solid was collected by filtration and washed with distilled water (50 mL) to yield the product (0.44 g, yield: 49 O). ¹H NMR (DMSO-d₆, 500 MHz, 298K) δ (ppm): 3.80 (s, 6H). ¹³C NMR (DMSO-d₆, 150 MHz, 298K) δ (ppm): 153.34, 121.89, 61.36.

Synthesis of S2 Compound S1 (0.91 g, 2.0 mmol), 4-(4,4,5,5-tetramethyl-1,3,2-dioxaborolan-2-yl)aniline (1.86 g, 8.5 mmol) and potassium carbonate (1.2 g, 8.7 mmol) were added to a mixture of DMSO (80 mL) and distilled water (20 mL) in a 250 mL round bottom flask at room temperature. The mixture was degassed for 15 min before palladium tetrakis(triphenylphosphine) (35 mg, 0.03 mmol) was added. The reaction was degassed again through three cycles of freeze-pump-thaw before heating to 120° C. under an N₂ atmosphere. After 48 h, the reaction was cooled down to room temperature the solid residues were filtered off. Distilled water (200 mL) was added to the filtrate, and the crude product precipitated. This crude product was collected through filtration, washed with Et₂O (50 mL), and dried under vacuum to yield the product as a grey-colored solid (0.91 g, yield: 91%). ¹H NMR (DMSO-d₆, 500 MHz, 298K) δ (ppm): 6.74 (d, J=6.5 Hz, 8H), 6.36 (d, J=6.5 Hz, 8H), 4.84 (s, 8H), 2,79 (s, 611). ¹³C NMR (DMSO-d₆, 150 MHz, 298K) δ (ppm): 152.46, 147.19, 135.78, 132.10, 125.59, 113.93, 59.77. HR-ESI-MS: calculated for [M+H]⁺ m/z=503.2402, found m/z=503.2448.

Synthesis of S3. Cyanuric chloride (0.83 g, 4.5 mmol) and potassium carbonate (2.4 g, 17 mmol) were added to anhydrous THE (40 mL) in a 250 mL round bottom flask at 0° C. Compound S2 (1.0 g, 2.0 mmol) dissolved in THE (60 mL) was added to the reaction using a dropping funnel slowly over 15 min. The reaction was stirred for I₂ h, and the temperature was allowed to warm to room temperature. After then, the solid residue was filtered off. The filtrate was collected, and the organic solvent was removed under reduced pressure. The solid residue was washed thoroughly with distilled water (250 mL) to afford the product as yellow solid (1.8 g, yield: 82%). ¹H NMR (DMSO-d₆, 500 MHz, 298 K) δ (ppm): 11.11 (s, 4H), 7.52 (d, J=7.0 Hz, 8H), 7.22 (d, J=7.0 Hz, 8H), 2,87 (s, 6H). ¹³C NMR (DMSO-d₆, 150 MHz, 298K) δ (ppm): 154.35, 151.82, 135.94, 135.45, 132.62, 131.53, 120.10, 60.24. HR-ESI-MS: calculated for [M+H]⁺ m/z=1094.9947, found m/z=1094.9928.

Synthesis of 1. Compound S3 (1.1 g, 1.0 mmol), allylamine (0.91 g, 16.0 mmol), and N,N-diisopropylethylamine (1.0 g, 8 mmol) were dissolved in dioxane (100 mL) in a 250 mL round bottom flask. The reaction was heated to 105° C. under an N₂ atmosphere. The reaction was cooled down to room temperature after I₂ h, and distilled water (200 mL) was added to the reaction mixture to generate a light-yellow precipitate. The product was collected through filtration, washed with Et₂O (30 mL), and dried in the open air (1.1 g, yield: 87%). ¹H NMR (DMSO-d₆, 500 MHz, 298 K) δ (ppm): 8.83 (m, 4H), 7.65 (s, 8H), 6.98 (d, J=8.0 Hz, 8H), 6.89 (m, 8H), 5.87 (m, 8H), 5.12 (d, J=17.0 Hz, 8H), 5.02 (d, J=10.5 Hz, 8H), 3.87 (t, J=5.5 Hz, 16H), 2.83 (s, 6H). ¹³C NMR (DMSO-d₆, 150 MHz, 298K) δ (ppm): 165.96, 164.44, 151.99, 139.37, 136.77, 135.44, 131.01, 129.78, 118.40, 115.05, 59.80, 42.92. HR-ESI-MS: calculated for [M+H]⁺ m/z=1259.6500, found m/z=1259.6460.

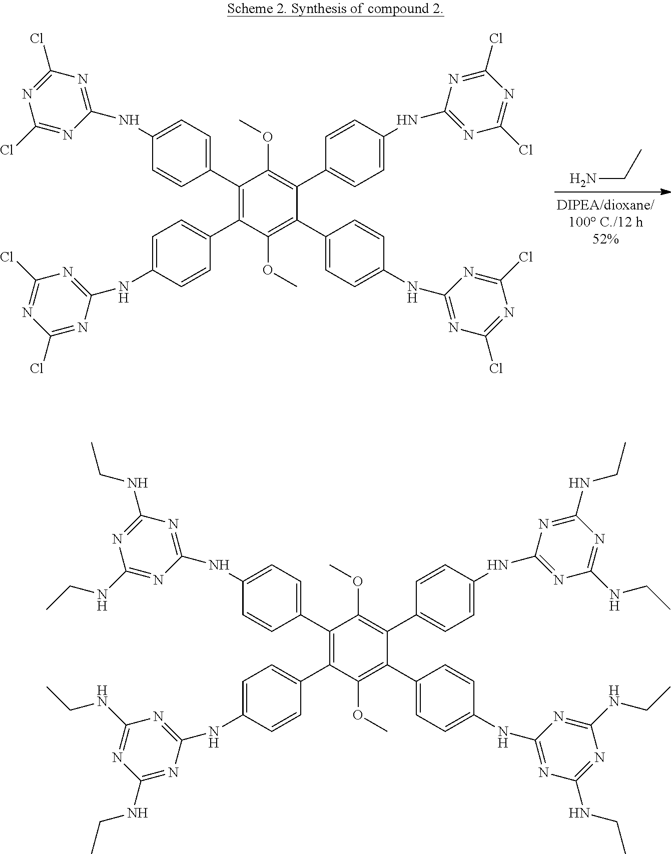

Synthesis of 2. Compound S3 (150 mg, 0.12 mmol) and ethyl amine THE solution (2M, 1 mg, 2 mmol), and N,N-diisopropylethylamine (250 mg, 2 mmol) were dissolved into 1,4-dioxane (30 mL) in a Schlenk tube. The Schlenk tube was sealed and heated to 100° C. for I₂ h. Then the solvents are removed under reduced pressure. The crude product was washed with Et₂O (30 mL) and distilled water (50 mL) to yield a light-yellow product (72.5 mg, yield: 52%). ¹H NMR (DMSO-d₆, 500 MHz, 298 K) δ (ppm): 8.78 (m, 4H), 7.65 (d, J=8.0 Hz, 8H), 6.98 (d, J=8.0 Hz, 8H), 6.78 (m, 8H), 3.25 (s, 16H), 2.82 (s, 6H), 1.07 (m, 24H).

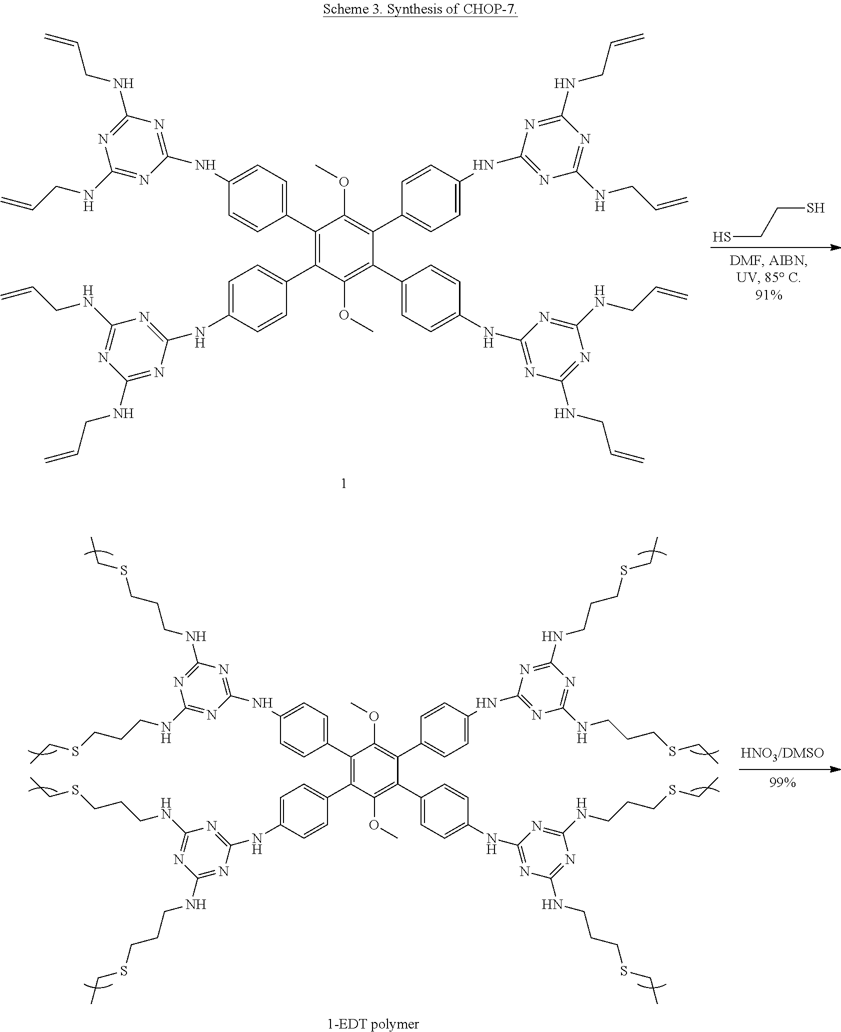

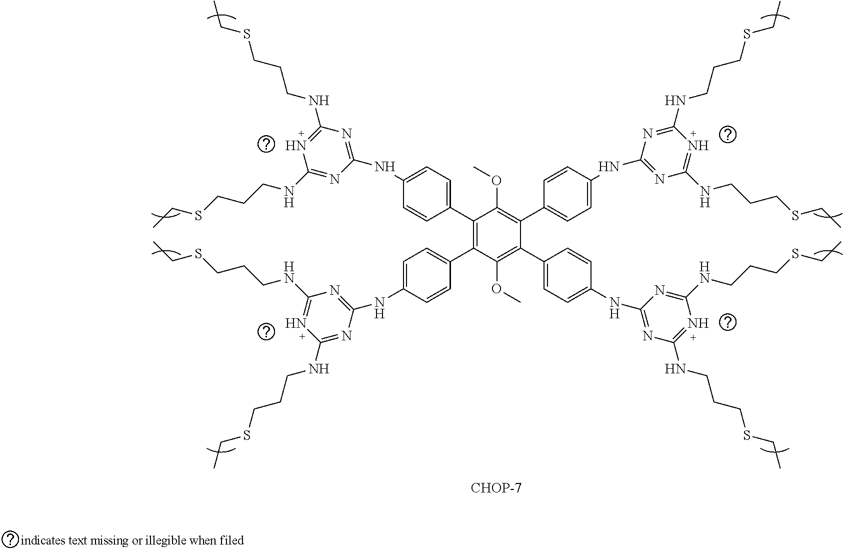

Synthesis of CHOP-7. Compound 1 (200.0 mg, 0.16 mmol) was dissolved in the NM (3 mL, anhydrous) in a Schoenk tube. EDT (63.1 mg, 0.67 mmol, 4.2 equiv.) and azobisisobutyronitrile (AIBN, 5.0 mg, 0.03 mmol) were added to the solution. The mixture was degassed and filled with N₂, irradiated under the UV light for 48 h, and heated at 85° C. for I₂ h. After that, the formed precipitate was collected by filtration and washed with DMSO (10 mL×3) and THE (10 mL×3). After freeze drying, the 1-EDT polymer was obtained (236.4 mg, 91%). The polymer was active by supercritical C₀₂ three times and characterized by IR, TGA, and elemental analysis. Elemental analysis: 1·[EDT]_{3.7}·[CO₂]_{1.9}, calculated: C, 54.89%, H, 5.73%, N, 19.87%, S, 14.02%; found: C, 56.72%, H, 5.66%, N, 18.02%, S, 12.17%.

The obtained polymer and fuming HNO₃ (90%, 1.5 g, 21.4 mmol) were mixed in DMSO (10 mL). After I₂ h, the solid was collected by filtration and washed with THE (10 mL×3) to yield the CHOP-7 as a yellow solid (311.0 mg, 99%).

### Preparation of Precursor Crystals

X-ray diffraction data of crystals were collected from XtaLAB Synergy Dualfiex single-crystal X-ray diffractometer at 100 K with Cu Ka radiation (λ=1.54184 Å). Multi-scan absorption corrections were applied in each case. The structures were solved by SHIELXT and refined with SHIELXL using the program Olex2. All non-hydrogen atoms of the monomers were refined anisotropically. The hydrogen atoms were modeled at geometrically constrained positions and refined using the riding model. Details of each crystal structure will be discussed in the section below. CCDC contains supplementary crystallographic data, which can be accessed through the Cambridge Crystallographic Data Centre at https://www.ccdc.cam.ac.uk/. The topology of 1·4H⁺·4NO₃⁻_{crystal} is solved by Topospro software. The nitrate dimer was simplified as one node to connect different 1·4H⁺ monomers. The 1·4H⁺·4NO₃⁻_{crystal} is crystallized in flu (fluorite) topology. Each 141 is connected with eight nitrate dimers, while each nitrate dimer is connected with four 1·4H.

Crystallization of 1_{crystal}. Compound 1 (50.0 mg, 0.04 mmol) was dissolved in the DMOS (5 mL) in a 20 mL vial. The vial was placed in a 100 mL vial with MeH for solvent diffusion at room temperature. Transparent block crystals of 1_{crystal} were obtained after 5 d.

TABLE 1
Single-crystal X-ray diffraction data of 1_{crystal}, 1 · 4H⁺ · 4NO₃⁻_{crystal}, and
HcOF-7.

| Identification code | 1_{crystal} | 1 · 4H⁺ · 4NO₃⁻_{crystal} | HcOF-7 |
|---|---|---|---|
| CCDC number | 2176150 | 2176149 | 2175909 |
| Empirical formula | C₆₈H₇₄N₂₄O₂ | C₉₂H₁₂₄N₂₈O₂₆ | _{C95}H₁₃₇N₂₈O₁₄S₈ |
| Formula weight | 1259.51 | 2038.18 | 2151.80 |
| Temperature/K | 100.00(10) | 100.00(10) | 100.00(10) |
| Crystal system | monoclinic | triclinic | triclinic |
| Space group | P2₁/n | P-1 | P-1 |
| al Å | 15.0148(13) | 10.3450(3) | 10.8379(2) |
| b/Å | 14.7706(8) | 15.3223(5) | 15.5881(3) |
| c/Å | 16.4854(11) | 16.9447(8) | 17.4865(3) |
| α/° | 90 | 77.089(4) | 76.293(2) |
| β/° | 103.120(8) | 77.183(3) | 72.832(2) |
| γ/° | 90 | 81.122(3) | 79.225(2) |
| Volume/Å³ | 3560.7(4) | 2537.20(17) | 2720.32(10) |
| Z | 2 | 1 | 1 |
| ρ_{calc}g/cm³ | 1.175 | 1.335 | 1.314 |
| μ/mm⁻¹ | 0.613 | 0.832 | 2.113 |
| F(000) | 1332.0 | 1082 | 1143.0 |
| Crystal size/mm3 | 0.1 × 0.1 × 0.05 | 0.3 × 0.2 × 0.2 | 0.1×0.08 × 0.05 |
| Radiation | CuKα (λ = | CuKα (λ = | CuKα (λ = |
| | 1.54184) | 1.54184) | 1.54184) |
| 2Θ range for data | 7.194 to 119.994 | 5.454 to 154.756 | 5.392 to 154.364 |
| collection/° | | | |
| Index ranges | −16 ≤ h ≤ 16, −16 | −13 ≤ h ≤ 10, −18 ≤ | −12 ≤ h ≤ 13, −19 ≤ |
| | ≤ k ≤ 12, −18 ≤ | k ≤ 19, −20 ≤ 1 ≤ 21 | k ≤ 18, −22 ≤ |
| | 1 ≤ 18 | | 1 ≤ 21 |
| Reflections collected | 17854 | 26975 | 35749 |
| Independent reflections | 5270 [Rᵢₙₜ = | 10154 [Rᵢₙₜ = | 10783 [Rᵢₙₜ = |
| | 0.1305, R_{sigma} = 0.1462] | 0.0556, R_{sigma} = 0.0603] | 0.0311, R_{sigma} = 0.0305] |
| Data/restraints/parameters | 5270/0/425 | 10154/472/769 | 10783/733/722 |
| Goodness-of-fit on F² | 0.924 | 1.198 | 1.699 |
| Final R indexes [I> = 2σ | R₁ = 0.0960, | R₁ = 0.1016, | R₁ = 0.1527, |
| (I)] | wR₂ = 0.2196 | wR₂ = 0.2857 | wR₂ = 0.4073 |
| Final R indexes [all data] | R₁ = 0.2426, wR₂ = | R₁ = 0.1240, | R₁ = 0.1745, |
| | 0.3023 | wR₂ = 0.3143 | wR₂ = 0.4298 |
| Largest diff. peak/hole/e | 0.20/−0.20 | 0.55/−0.51 | 0.70/−0.64 |
| Å⁻³ | | | |

Crystallization of 1·4H^{+·}4NO₃⁻_{crystal}. Monomer 1 (50.0 mg, 0.13 mmol) was dissolved in the mixture of 1,4-dioxane (5 mL) and fuming nitric acid (0.1 mL). The solution was filtered to remove any insoluble residues and then added to a 20 mL vial. This vial was placed in a 100 mL vial with Et₂O for solvent diffusion at room temperature. Yellow block crystals of 1·4H⁺·4NO₃⁻_{crystal} were obtained after 3 d.

PXRD investigation of the stability of 1·4H⁺·4NO₃⁻_{crystal}. The single crystals of 1·4H⁺·4NO₃⁻ (5 mg) were added to 3 mL 1,4-dioxane, cyclohexane, THF, Et₂, and EtOAc for 24 hours. PXRD profiles of each sample were collected. The crystallinity of 1·4H⁺·4NO₃⁻_{crystal} decreased significantly in Et₂O and EtOAc. In addition, the crystallinity of 1·4H⁺·4NO₃⁻_{crystal} significantly reduced in the open air.

TABLE 2
Distances of the nearby alkene carbon atoms in the lattice of
1•4H⁺•4NO₃^{^{−}} _{crystal}.

| alkene carbon | | symmetry | distance | alkene carbon | | symmetry | distance |
|---|---|---|---|---|---|---|---|
| atom | | operation | (Å) | atom | | operation | (Å) |
| C4 | C1 | x, y, z | 7.908 | C1 | C34 | 2 − x, 1 − y, 1 − z | 9.3479 |
| C4 | C34 | −1 + x, y, z | 8.0512 | C1 | C4 | 1 + x, y, z | 9.8179 |
| C4 | C1 | −x, 1 − y, 1 − z | 8.2764 | C1 | C4 | −1 − x, 2 − y, 1 − z | 9.8337 |
| C4 | C1 | −x, 2 − y, 1 − z | 8.6343 | C1 | C4 | x, y, 1 + z | 9.8929 |
| C4 | C31 | −x, 1 − y, −z | 8.6689 | C31 | C1 | −x, 1 − y, 1 − z | 4.4919 |
| C4 | C4 | −1 − x, 2 − y, 1 − z | 8.8349 | C31 | C34 | −1 + x, y, z | 6.7889 |
| C4 | C34 | −x, 1 − y, 1 − z | 9.3736 | C31 | C1 | 1 − x, 1 − y, 1 − z | 7.2433 |
| C4 | C31 | −1 + x, 1 + y, z | 9.4597 | C31 | C1 | 1 + x, y, −1 + z | 7.4341 |
| C4 | C34 | −2 + x, 1 + y, z | 9.4672 | C31 | C1 | x, y, −1 + z | 7.9848 |
| C4 | C31 | −x, 1 − y, 1 − z | 9.7334 | C31 | C4 | −x, 1 − y, −z | 8.6689 |
| C4 | C34 | 1 − 2 + x, y, z | 9.8049 | C31 | C34 | 2 − x, 1 − y, −z | 9.2472 |
| C4 | C1 | −1 + x, y, z | 9.8179 | C31 | C4 | 1 + x, −1 + y, z | 9.4597 |
| C4 | C1 | −1 − x, 2 − y, 1 − z | 9.8337 | C31 | C4 | −x, 1 − y, 1 − z | 9.7334 |
| C4 | C1 | x, y, −1 + z | 9.8929 | C31 | C31 | −x, 1 − y, −z | 9.8758 |
| C1 | C34 | 1 − x, 1 − y, 1 − z | 4.4617 | C34 | C1 | 1 − x, 1 − y, 1 − z | 4.4617 |
| C1 | C31 | −x, 1 − y, 1 − z | 4.4919 | C34 | C34 | 2 − x, 1 − y, 1 − z | 5.9856 |
| C1 | C31 | 1 − x, 1 − y, 1 − z | 7.2433 | C34 | C31 | 1 + x, y, z | 6.7889 |
| C1 | C31 | −1 + x, y, 1 + z | 7.4341 | C34 | C4 | 1 + x, y, z | 8.0512 |
| C1 | C4 | x, y, z | 7.908 | C34 | C1 | 1 + x, y, z | 8.2268 |
| C1 | C31 | x, y, 1 + z | 7.9848 | C34 | C31 | 2 − x, 1 − y, −z | 9.2472 |
| C1 | C34 | −1 + x, y, z | 8.2268 | C34 | C1 | 2 − x, 1 − y, 1 − z | 9.3479 |
| C1 | C4 | −x, 1 − y, 1 − z | 8.2764 | C34 | C4 | −x, 1 − y, 1 − z | 9.3736 |
| C1 | C1 | −x, 1 − y, 2 − z | 8.3866 | C34 | C4 | 2 + x, −1 + y, z | 9.4672 |
| C1 | C4 | −x, 2 − y, 1 − z | 8.6343 | C34 | C4 | 2 + x, y, z | 9.8049 |

### SCSC Synthesis of H_{C}OF-7.

Solvent exchange of 1·4H⁺·4NO₃⁻_{crystal}. In order to remove the dioxanes, single crystals of 1,4H⁺·4NO₃⁻ (10 mg) were immersed in THE and cyclohexane (10 mL×3) separately. After I₂ h, the crystals were filtered off and dried in the open air for 2 h. The obtained crystals were dissolved in DMSO-d₆ for ¹H NMR analysis. The result shows dioxane could be effectively replaced by THF, while cyclohexane cannot replace it. After THE exchange, 1·4H⁺·4NO₃⁻_{crystal} was immersed in cyclohexane (10 mL×3) for I₂ h. ¹H NMR shows THE remained.

Crosslinker diffusion. Single crystals of 1·4H⁺·4NO₃⁻_{crystal} were washed with THE (10 mL×3) for I₂ h to allow an extensive solvent exchange. A cyclohexane solution (3 mL) of 1,2-ethanedithiol (EDT, 300 μL) was added to the samples in a vial (~40 mg). After 72 h, the crystals were filtered off and dried in the open air for 6 h. The crystals were dissolved in DMSO-d₆ and characterized by ¹H NMR.

Optimization of the synthesis of single-crystalline H_{C}OF-7. In order to remove the dioxanes in 1·4H⁺·4NO₃⁻_{crystal}, single crystals were washed with THE three times (10 mL×3) to allow an extensive solvent exchange. A cyclohexane solution (3 mL) of 1,2-ethanedithiol (EDT) was added to the samples in a vial (~40 mg). The synthesis of H_{C}OF-7 was performed at various concentrations of EDT in cyclohexane solutions (33.3, 50, 58.3, 100, and 133.3 μL/mL) for the extensive crosslinking. The EDT-diffused crystal samples were kept in the dark for 72 h to allow for extensive EDT diffusion. Next, the vials were irradiated under UV light (medium-pressure 175-watt Hg lamp) for 48 h with forced air cooling. The crystal samples were collected and washed with an excess of THE and hexanes to remove the unreacted EDT. The H_{C}OF-7 crystals were further characterized by PXRD, JR spectrum, Raman spectrum, TGA, and solid-state ¹³C NMR, δ (ppm): 162.10, 155.40, 181.86, 132.59, 121.19, 119.12, 110.69, 60.19, 40.57, 30.07.

TABLE 3
Summary of the elemental analyses of HcOF-7 synthesized at various
EDT concentrations.

| concentration of | | | | Degree of |
|---|---|---|---|---|
| EDT | Composition | Cal. (%) | Found (%) | crossinking^{a} |
| 33.3 μL/mL | 1 · 4H⁺ · [NO₃⁻]₄ · | C 47.59, H | C 47.01, H | 76% |
| | [EDT]_{3.05} · [CO₂]_{3.1} | 5.35, N 19.97, | 5.02, N 20.27, | |
| | | S 9.82 | S 10.11 | |
| 50.0 μL/mL | 1.4H⁺ · [NO₃⁻]₄ · [EDT]_{3.1} · [CO₂]_{2.2} | C 48.02, H | C 48.29, H | 78% |
| | | 5.44, N 20.42, | 5.12, N 20.64, | |
| | | S 10.15 | S 10.46 | |
| 58.3 μL/mL | 1 · 4H⁺ · [NO₃⁻]₄ · | C 47.43, H | C 47.71, H | 83% |
| | [EDT]_{3.3} · [CO₂]_{2.95} | 5.34, N 20.06, | 5.05, N 20.09, | |
| | | S 10.61 | S 10.84 | |
| 100.0 μL/mL | 1 · 4H⁺ · [NO₃⁻]₄ · [EDT]_{3.8} · [CO₂]_{2.3} | C 47.26, H | C 47.78, H | 95% |
| | | 5.43, N 19.65, | 5.16, N 19.9, S | |
| | | S 12.09 | 12.36 | |
| 133.2 μL/mL | 1 · 4H⁺ · [NO₃⁻]₄ · | C 47.13, H | C 47.34, H | 99% |
| | [EDT]_{3.95} · [CO₂]_{2.25} | 5.43, N 19.6, S | 5.17, N 19.78, | |
| | | 12.52 | S 12.77 | |

^{a}Degree of cross-linking = n[EDT]/4 × 100%

### Porosity Analysis.

H_{C}OF-7 crystals (~45 mg) were immersed in a 20 mL vial with THE (15 mL). Then THE was piped out and refilled every 8 hours three times. After solvents exchanging, the H_{C}OF-7 crystals were activated under vacuum at 90° C. for 24 h. Gas/vapor sorption measurements were performed on a Micromeritics FLEX 3.0 surface area analyzer. The CO₂ sorption and other vapor sorption isotherms were measured at room temperature.

Iodine and iodide sorption investigations. The residue of iodine and iodide is determined by the Leuco-crystal violet method. The solution preparation and measurement procedures are described below.

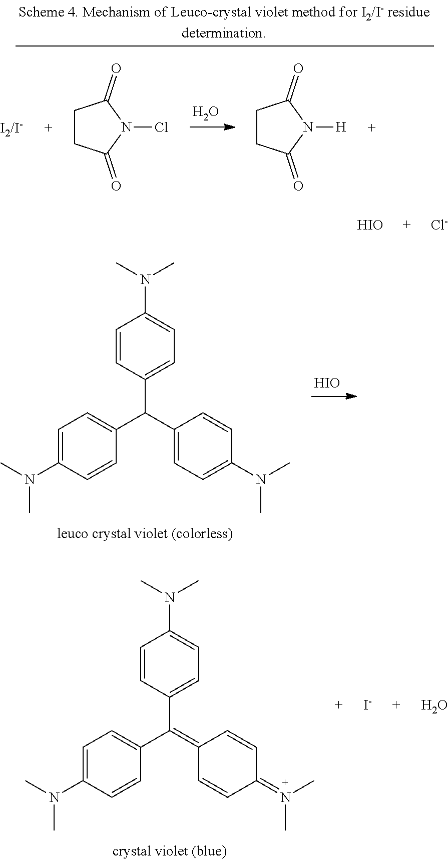

Preparation of the standard iodide solution. A 15 ppm I⁻ the stock solution was prepared by dissolving 19.6 mg of potassium iodide (dried at 105° C. for 1 h) in 1 L of deionized water. Then the solution was diluted to 0.1 to 0.5 ppm for the standard curve calibration.

Preparation of the buffer solution. A pH 4.0 buffer solution was prepared in a 50 mL volumetric flask by dissolving 1.70 grams of potassium dihydrogen phosphate (KH₂PO₄) in distilled water (30 mL). Phosphoric acid (85%, 1 mL) was added to the solution. Then the solution was diluted to exactly 50 mL.

Preparation of the Leuco-crystal violet solution. Phosphoric acid (85%, 0.25 mL), Leuco-crystal violet, 4,4/,4″-methylidynetris (25 mg, 0.067 mmol) were added to a 100 mL volumetric flask with distilled water (30 mL) and shaken until the solid completely dissolved. The solution was then diluted to exact 100 mL.

Preparation of the N-Chlorosuccinimide-Succinimide solution. N-chlorosuccinimide (100 mg, 0.75 mmol) and succinimide (1.0 g, 10.1 mmol) were dissolved in 75 mL distilled water in a 100 mL volumetric flask. Then the solution was diluted to 100 mL with distilled water.

Residual concentration of [I₂+I⁻ ] measurement. Distilled water (2 mL) and iodinated water (1 mL) were mixed in a 4 mL vial. Then the phosphate buffer solution (0.1 mL) and N-chlorosuccinimide-succinimide reagent solution (0.1 mL) were added to the vial. The solution was shaken after adding the Leuco-crystal violet solution (0.1 mL). The UV/Vis absorbance was measured at 592 nm at 25° C. exactly 10 min after Leuco-crystal violet was added. The residue of [I₂+I⁻ ] could be calculated based on the calibration curve.

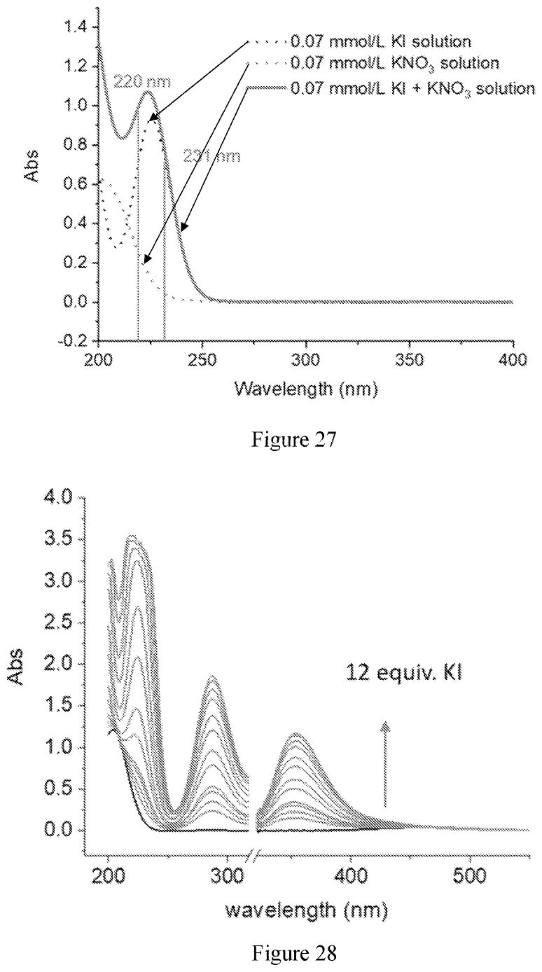

Dual-wavelength UV/Vis spectrometry is a simpler method to measure I⁻ concentration in the presence of NO₃⁻ interference. When I⁻ or NO₃⁻ is directly determined by UV/Vis spectrometry, the two anions interfere due to the absorption band overlap. Therefore, a dual-wavelength method with primary wavelength (220 nm) and secondary wavelength (231 nm) was used to determine NO₃⁻ and I⁻ in solution. Based on the UV/Vis spectra of standard KI (0.07 mmol/L) solution, standard KNO₃ (0.07 mmol/L) solution and KI (0.07 mmol/L)+KNO₃(0.07 mmol/L) mixture (FIG. 27), the linear equations were calculated as A_{220 nm}−A_{231 nm}=2.960 c(NO₃⁻), A₂₂₀ nm(NO₃⁻)=3.667 c(NO₃⁻), and A_{220 nm}(I⁻)=A_{220 nm}−A_{220 nm}(NO₃⁻)=10.666 c(I⁻). The result is in good agreement with the previously reported data.

Study of KI₃ Formation Equilibrium Constant in an H₂O/MeOH (99:1) Solution

To increase the solubility of iodine in the aqueous environment, an H₂O/MeOH (99:1) solution of I₂ was prepared. The equilibrium constant of KI₃ formation was measured by UV/Vis titration. I₂ (150 mg, 0.59 mmol) was dissolved in MeOH (10 mL), and 990 mL of H₂O was added to the solution. Different amounts of KI (0 to I₂ equiv.) were added to the solution, and the UV/Vis spectra were recorded using a 0.1 cm cuvette (FIG. 28-29). The peaks attributed to I₃⁻ at 292 and 354 nm were fitted with the 1:1 binding model. The equilibrium constant K in H₂O/MeOH (99:1) solution is calculated as 792±20 M⁻¹.

Different I₂/I⁻ solutions were prepared for the investigation of iodine/iodide uptake capacities, temperature-dependent adsorption rate determinations, and low-concentration total iodine removal. The concentrations of the I₂, I⁻, and I₃⁻ at equilibrium were calculated based on the equilibrium constant and listed in Table 4.

TABLE 4
Summary of the concentrations of I₂, I⁻ and I₃⁻
species at equilibrium.

| | input amounts | concentrations |
|---|---|---|
| experiments | of I₂ and I⁻ | of [I₂]/[I⁻]/[I₃⁻] |
| uptake | I₂: 0.87M | I₂: 0.0076M |
| capacity | KI: 1.02M | I⁻: 0.1576M |
| studies | | I₃⁻: 0.8624M |
| kinetic | I₂: 0.12 mM | I₂: 0.09 mM |
| studies | KI: 0.50 mM | I⁻: 0.47 mM |
| | | I₃⁻: 0.03 mM |
| Iodine | I₂: 3.5 mg/L 13.8 μM | I₂: 13.7 μM |
| residue | KI: 1.5 mg/L | I⁻: 11.7 μM |
| removal | 11.8 μM | I₃⁻: 0.12 μM |

Kinetic study of iodine adsorption. I₂/KI solution (0.12 mM 12±0.50 mM KI, 15 mL) was prepared and added to a 20 mL sealed vial with string. The concentration of I₂, I⁻, and KI₃ is calculated as 0.089, 0.470, and 0.030 mM, respectively. The sealed vials were heated to 23, 40, 50, 70, and 90° C. in the oil bath. When the temperature stabilized, 10 mg H_{C}OF-7 was added to the vials, and the timer was started. Periodically, 3 mL of the solution was piped out for concentration measurement by UV/Vis spectroscopy at 292 nm. The solution was added back into the vial after the measurement. A pseudo-first-order equation was used to fit the adsorption results at different temperatures (FIG. 31-34).

$$r = - \frac{d [ c ]}{dt} = k [ c ]$$

$$ln \frac{{c}_{0}}{[ c ]} = kt$$

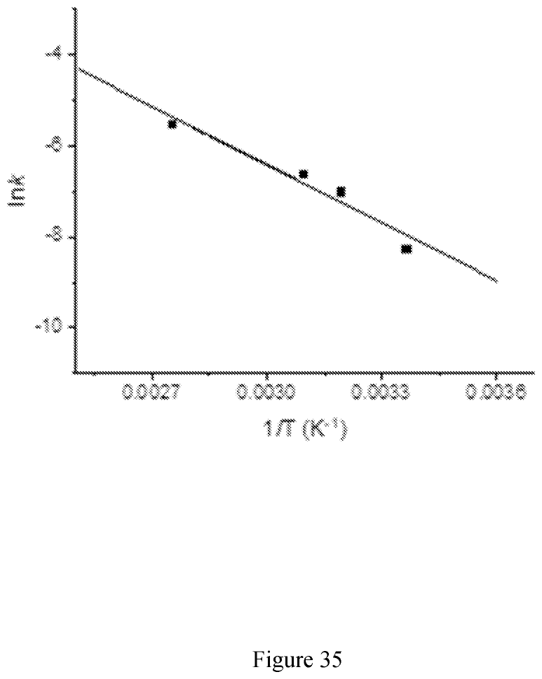

k: rate constant; [c]: concentration; co: initial concentration.
The obtained rate constant was further fitted by the Arrhenius equation (FIG. 35):

$$lnk = \frac{- {E}_{a}}{RT} + lnA$$

Eₐ: activation energy; k: rate constant; A: pre-exponential factor. The activation energy is calculated as 35.3±6.0 kJ/mol.

Iodine uptake amount measurements. To study the total iodine uptake of different absorbents at different temperatures in an aqueous environment, H_{C}O7-7 crystals (10 mg), activated carbon (15 mg), and CHOP-7 (10 mg) powder were soaked in a 3 mL I₂/KI concentrated aqueous solution (0.51 g KI and 0.66 g 12) in a 4 mL vial at 23, 40, 50, 70 and 90° C. for 48 h. The solid was collected by filtration, washed with excess water until the filtrate became colorless, and dried in the open air before weighing. The [I₂+I⁻ ] uptake amount was measured by the gravimetric method. The experiment was repeated three times. After adsorption at 23, 40, 50, 70 and 90° C., the H_{C}OF-7@[I₂+I⁻ ] were weighted as 23.9±0.7, 23.0±0.3, 22.1±0.6, 22.0±0.2, and 19.7±0.7 mg, respectively. The CHOP-7@[I₂+I⁻ ] obtained at 23, 40, 50, 70 and 90° C. were weighted as 19.3±0.8, 18.6±0.6, 18.0±0.3, 17.3±0.3, and 16.7±0.3 mg, respectively. The activated carbon@I₂ obtained at 23, 40, 50, 70 and 90° C. were weighed as 19.4±0.3, 18.8±0.3, 18.4±0.5, 17.9±0.3, and 17.4±0.3 mg, respectively.

Scheme 5. (a) The halogen bond interaction between I₂ and the triazine rings of H_{C}OF-7. (b) I₃⁻ or I⁻ exchange process with H_{C}OF-7.

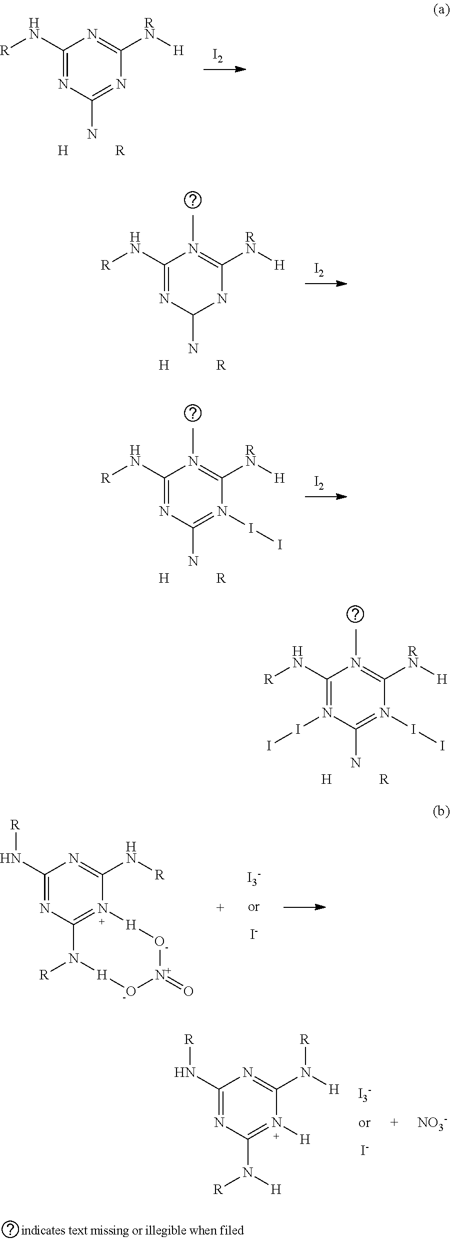

TABLE 5
List of porous materials and their iodine species uptake capacities
from aqueous solution.

| Type of materials | Compound name | Guest molecules | Capacity |
|---|---|---|---|
| HcOF | HcOF-1 | I₂ | 2.9 g/g |
| HcOF | HcOF-2 | I₂ | 3.2 g/g |
| HcOF | HcOF-3 | I₂ | 3.0 g/g |
| HcOF | HcOF-4 | I₂ | 3.6 g/g |
| POP | CaCOP1 | I₂ | 2.4 g/g |
| POP | CaCOP2 | I₂ | 2.81 g/g |
| POP | CaCOP3 | I₂ | 3.1 g/g |
| POP | C[4]P-BT | I₂ | 2.32 g/g |
| POP | C[4]P-BTP | I₂ | 3.24 g/g |
| POP | C[4]P-TTP | I₂ | 2.51 g/g |
| POP | C[4]P-BP | I₂ | 2.37 g/g |
| POP | C[4]P-TPE | I₂ | 2.99 g/g |
| POP | C[4]P-DPP | I₂ | 1.58 g/g |
| POP | CalCOP1 | I₂ | 2.32 g/g |
| POP | CalCOP2 | I₂ | 1.76 g/g |
| POP | CalCOP3 | I₂ | 0.35 g/g |
| POP | CalCOP4 | I₂ | 0.16 g/g |
| POP | TNHCP1 | I₂ | 0.73 g/g |
| POP | TNHCP2 | I₂ | 0.85 g/g |
| POP | TNHCP3 | I₂ | 0.72 g/g |
| MOF | [Mn₂(oxdz)₂(tphn) | I₂ | 1.1 g/g |
| | (H₂O)] · CH₃OH}ₙ | | |
| MOF | MBM-MOF | I₂ | 0.88 g/g |
| POP | Compound-1 | I₃⁻ | 3.5 g/g |
| POP | Compound-2 | I₃⁻ | 3.04 g/g |
| POP | NTP | I₃⁻ | 0.43 g/g |
| MOF | cadmium(II)-triazole MOF | I₃⁻ | 0.18 g/g |
| HcOF | HcOF-7 | I₂ + I⁻ | 1.39 g/g |
| resin | SiPyR-N4 | I⁻ | 0.15 g/g |
| resin | H.M.W. resin | I⁻ | 0.64 g/g |
| resin | D201 | I⁻ | 0.31 g/g |
| resin | Ag-D201 | I⁻ | 0.26 g/g |
| MOF | Ag₂O-Ag₂O₃@ZIF-8 | I⁻ | 0.23 g/g |
| MOF | MIL-101(Cr)-SO₃Ag | I⁻ | 0.24 g/g |
| MOF | AgII@MIL101 | I⁻ | 0.04 g/g |
| Nano particle | Ag₂O@Mg(OH)₂ | I⁻ | 0.37 g/g |
| Nano particle | Ag₂O@titanate nanolamina | I⁻ | 0.43 g/g |
| Nano particle | AgCl@calcium alginate | I⁻ | 0.11 g/g |
| aerogel | Ag@silica aerogel | I⁻ | 0.09 g/g |
| Activated carbon | Ag@activated carbon | I⁻ | 0.04 g/g |

Kinetic study of I₂ adsorptions in the presence of the different amounts of KI. There are two possible paths for collective iodine and iodide adsorption in H_{C}OF-7: (1) simultaneous adsorption of I₂ through halogen bonding interaction and nitrate-to-iodide anion exchange, and (2) nitrate-to-triiodide anion exchange in addition to I₂ adsorption. To reveal the adsorption path, I₂ aqueous solutions (1% MeOH) with different amounts of KI (0 to 12 equiv.) were prepared. The initial concentrations of [I₂], [I⁻ ], and [I₃⁻] are summarized in Table 6.

Specifically, I₂ (150 mg, 0.59 mmol) was dissolved in MeOH (10 mL), and 990 mL H₂O was added to dilute the solution. Stock solutions of 0.59 mM I₂ with 0, 0.59, 1.18, and 7.08 mM (0 to I₂ equiv.) of KI were prepared by adding 0, 98.0, 196.0 and 1176.5 mg KI to the I₂ solution. H_{C}OF-7 (10 mg) was added to each solution (15 mL) in a vial with stirring. 3 mL solution was periodically withdrawn for UV/Vis measurement (FIG. 36-39). The solution was added back to the vial after each measurement. The 460 and 400 nm absorbance were used to fit the pseudo-first-order kinetics (FIGS. 36-39), and the results were summarized in Table 6.

TABLE 6
The rate constants of total iodine (I₂ and I₃⁻) removal using HcOF-7.

| input amounts | concentrations of | rate constant |
|---|---|---|
| of I₂ and I⁻ | [I₂]/[I⁻]/[I₃⁻] | ( × 10⁻⁴ s⁻¹) |
| I₂: 0.59 mM | I₂: 0.59 mM | 6.65 ± 0.30 ^{a} |
| I₂: 0.59 mM | I₂: 0.438 mM | 6.11 ± 0.23 ^{a} |
| KI: 0.59 mM | I⁻: 0.438 mM | 6.20 ± 0.12 b |
| | I₃⁻: 0.152 mM | |
| I₂: 0.59 mM | I₂: 0.340 mM | 5.93 ± 0.21 ^{a} |
| KI: 1.18 mM | I⁻: 0.940 mM | 6.30 ± 0.05 ^{b} |
| | I₃⁻: 0.250 mM | |
| I₂: 0.59 mM | I₂:0.095 mM | 2.97 ± 0.06 ^{a} |
| KI: 7.08 mM | I⁻: 6.685 mM | 2.93 ± 0.06 ^{b} |
| | I₃⁻: 0.495 mM | |

^{^{a}}The rate constant is calculated using the absorbance at 460 nm.
^{b} The rate constant is calculated using the absorbance at 400 nm.

The static removal efficiency of I₂ in the presence of different amounts of KI. The static removal efficiency of I₂ in the presence of different amounts of KI (0 to 12 equiv.) was also investigated. In this investigation, the I₂ is more than the H_{C}OF-7 adsorption capacity.

Specifically, I₂ (200 mg, 0.79 mmol) was dissolved in MeOH (10 mL), and 990 mL of H₂O was added to dilute the mixture. Stock solutions of 0.79 mM I₂ with 0, 1.57, 3.94, and 9.45 mM of KI were prepared by adding 0, 260.6, 654.0, and 1568.7 mg KI to the 12 solution. To 50 mL of each solution in the vials, H_{C}OF-7 (5 mg) was added. After shaking for 72 h, the removal efficiency was calculated by measuring the UV/Vis absorbance before and after adding H_{C}OF-7 (FIG. 40). The results are summarized in Table 7. The I₂ removal efficiency continuously decreased from 83% to 48% in the presence of KI, suggesting H_{C}OF-7 adsorb I₂ and I⁻ collectively rather than removing 13 from the aqueous solution.

TABLE 7
Iodine (I₂ and I₃⁻) removal efficiency of HcOF-7

| | equilibrated | I₂/I₃⁻ |
|---|---|---|
| [I₂]₀/[I⁻]₀ | concentrations | Removal |
| concentrations | of [I₂]/[I⁻]/[I₃⁻] | efficiency |
| I₂: 0.79 mM | I₂: 0.79 mM | 83.0% ^{a} |
| I₂: 0.79 mM | I₂: 0.405 mM | 68.8% ^{b} |
| KI: 1.57 mM | I⁻: 1.192 mM | |
| | I₃⁻: 0.382 mM) | |
| I₂: 0.79 mM | I₂: 0.215 mM | 62.6% ^{b} |
| KI: 3.94 mM | I⁻: 3.364 mM | |
| | I₃⁻: 0.573 mM | |
| I₂: 0.79 mM | I₂: 0.099 mM | 48.2% ^{b} |
| KI: 9.45 mM | I⁻: 8.761 mM | |
| | I₃⁻: 0.688 mM | |

^{a}The removal efficiency is calculated based on the absorbance at 460 nm.
^{b}The removal efficiency is calculated based on the absorbance at 354 nm.

Investigation of NO₃— to I⁻ anion exchange in H_{C}OF-7. Activated H_{C}OF-7 (5 mg) crystals were added to 3 mL of 3.5 mM KI solution in a 4 mL vial. The amount of I⁻ in solution and NO₃⁻ in H_{C}OF-7 is kept at a 1:1 molar ratio. The samples were kept at room temperature (23° C.) or heated to desired temperatures (50 and 90° C.) in an oil bath. After 72 h, the residue iodine concentrations of the solutions and the amounts of I⁻ uptake were measured using the dual-wavelength UV/Vis spectroscopy method. The experiments were repeated four times.

Regeneration of H_{C}OF-7. To remove the guests, 12/I⁻ ·H_{C}OF-7 was deprotonated by NaOH (0.5 M) in DMSO/MeOH solution (V(DMSO): V(MeOH)=1:1) until the color of the crystals changed to light yellow. Then, H_{C}OF-7 was re-protonated by a DMSO solution of HNO₃⁻ (0.5 M, 10 mL). The re-protonated H_{C}OF-7 was washed with dioxane (10 mL×3) and THE (10 mL×3). The successful re-protonation was confirmed by FT-IR spectroscopy.

The regenerated amorphous H_{C}OF-7 was subjected to an iodine/iodide adsorption capacity study and a low concentration iodine/iodide removal investigation. The 12/I⁻ uptake of the regenerated H_{C}OF-7 from 12/KI solution (I₂: 0.87 M, KI: 1.02 M) was measured as 0.88±0.03 g/g, which is lower than that of as-synthesized H_{C}OF-7 (1.39±0.07 g/g). The residual iodine concentration (I₂+I⁻) reached 1.3±0.06 ppm after soaking the regenerated amorphous H_{C}OF-7 (6 mg) in 5 ppm 12/1KI (I₂: 3.5 ppm, I⁻: 1.5 ppm) solution at 23° C. for 72 h. For comparison, the residual iodine concentration (I₂+I⁻) of as-synthesized H_{C}OF-7 reached 0.22±0.02 ppm.

I₂·H_{C}OF-7 promoted NO₃— to I⁻ anion exchange. Preparation of I₂·H_{C}OF-7. Different amounts of I₂ (0.5, 1, and 1.5 mg) were dissolved in solvent mixtures consisting of MeOH/H₂O (2.5/2.5 mL) at room temperature before the addition of H_{C}OF-7 (5 mg). After 72 h, these solutions turned colorless, and the UV/Vis spectroscopy confirmed that iodine was completely adsorbed (FIG. 45). Next, I₂·HOF-7 samples were washed with MeOH/H₂O (5/5 mL×3) to remove any iodine stuck on the crystal surface. The I₂ uptake amounts of I₂·HOF-7 were calculated as 0.1, 0.2, and 0.3 g/g, respectively.

Different amounts of KI solution (3 mL, 3.5 mM) were added to these samples, and the molar ratio of NO₃⁻:I⁻ was kept at 1:1. After 72 h, the amounts of the exchanged I⁻ were measured using the dual-wavelength UV/Vis spectroscopy method (FIG. 46). These experiments were repeated four times. Tukey's test confirmed the honest significant differences. The results indicate that the confidence level of the differences between each iodide exchange group is 99% or higher (FIG. 5c). The NO₃⁻ to I⁻ exchange ratios of H_{C}OF-7, I₂·HOF-7 (0.1 g/g), I₂·HOF-7 (0.2 g/g), I₂·H_{C}OF-7 (0.3 g/g) are measured as 27±1%, 33±2%, 37±2%, and 39±1%, respectively.

Investigation of low concentration I₂/I⁻ removal in aqueous solutions. Static adsorption: The stock solution of the 12/I⁻ mixture (3.5 mg/L 12±1.5 mg/L I⁻) was prepared by dissolving I₂ (3.5 mg) and KI (1.96 mg) in 1 L of DI water. Based on the equilibrium constant, the concentrations of I₂, I⁻, and I₃⁻ were calculated as 3.48, 1.49, and 0.04 ppm, respectively. Since the concentration of I₃⁻ is two orders of magnitude less than the concentration of I₂, the contribution of I₃⁻ is negligible.

Activated H_{C}OF-7 (6 mg) crystals were added to 3 mL of I₂/I solution (3.5 mg/L 12±1.5 mg/L I⁻) or I⁻ solution (1.5 mg/L) in a 4-mL vial. The samples were kept at room temperature (23° C.) or heated to desired temperatures (40, 50, 70, and 90° C.) in an oil bath. After 72 h, the total iodine residues (I₂+I⁻) of the solution were determined by the Leuco-crystal violet method. As a reference, CHOP-7 (10 mg) was subject to similar measurements in the I₂/I⁻ solution (3.5 mg/L 12±1.5 mg/L I⁻) at 23, 40, 50, 70 and 90° C., respectively. The experiments were repeated three times.

I₂/I⁻ removal in the presence of competing anions. To investigate the I₂/I⁻ sorption in the presence of potential competing anions that simulates the natural water, NO₃⁻ (5 ppm), H₂PO₄ (5 ppm), SO₄⁻ (20 ppm), Cl⁻ (80 ppm), HCO₃⁻ (60 ppm) were added to I₂/I⁻ solution (I₂: 3.5 ppm, I⁻: 1.5 ppm) separately. H_{C}OF-7 crystals (6 mg) were added to these solutions (3 mL) that possess NO₃⁻, H₂P04, SO₄, Cl⁻, and HCO₃⁻, respectively. In addition, a mixture of NO₃⁻, H₂PO₄, SO₄⁻, Cl⁻, and HCO₃⁻ iodinated solution (3 mL) with the same concentrations mentioned above was prepared for iodine removal. After 72 h, the total iodine residue concentrations were measured as 0.30±0.02, 0.27±0.01, 0.32±0.02, 0.38±0.03, 0.43±0.03, 0.46±0.02 ppm, respectively by the Leuco-crystal violet method.

### Breakthrough Experiments.

H_{C}OF-7 column preparation. H_{C}OF-7 crystals (240 mg) were exchanged by THE (5×30 mL) and hexanes (5×30 mL) for 24 h, respectively. Then H_{C}OF-7 crystals and hexanes (10 mL) were distributed evenly into a ball-milling steel container with 3 ZrO₂ balls. After grinding by ball-milling at 50 Hz for 3 minutes, the crystals were filled into a plastic syringe (length: 27 mm, inner diameter: 4.5 mm). Both ends of the syringe are blocked with cotton. Before the iodine adsorption experiment, THE (30 mL) was passed through into the column to make the adsorbents close-packed.

Activated carbon and [activated carbon+resin] mixed-bed column preparation. Activated carbon (240 mg, Millipore Sigma) was ball-milled and activated at 120° C. for 24 h before use. Then, it was filled into a column (d: 4.5×1: 26 mm), with both ends capped by cotton. Before the breakthrough experiment, distilled water (50 mL) was passed through the column.

The anion exchange resin (130 mg, Dowex 1X2, 50-100 mesh) is immersed in the distilled water for 6 h before use. Then, the resin and activated carbon (130 mg) was packed into a column (d: 4.5×1: 30 mm), with both ends capped by cotton. Before the breakthrough experiment, distilled water (50 mL) was passed through the column.

Temperature-controlled breakthrough experiment. The breakthrough experiment setup is shown in FIG. 5. Iodine solution (I₂: 3.5 mg/L and I⁻: 1.5 mg/L) was prepared in a plastic bottle (4 L). A steel cartridge (300 mL) with the heating tape covered was connected to the entrance of the column. The flow rate was controlled at 5 mL/min. The temperature was adjusted by controlling the voltage of the heating tape. After the temperature was stabilized, the H_{C}OF-7 column was installed. The iodine solution passed through the H_{C}OF-7 column and was collected into the test tubes. The residual concentration of [I₂+I⁻ ] of the collected solution after the column was determined by the Leuco-crystal violet method (FIG. 5e).

Although the present disclosure has been described with respect to one or more particular embodiments and/or examples, it will be understood that other embodiments and/or examples of the present disclosure may be made without departing from the scope of the present disclosure.

1. An organic framework comprising a plurality of linked monomers comprising one or more 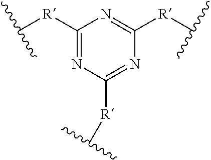
(“A group”), wherein R′ is —NH— or —O—, and the organic framework is at least 95% crystalline.

2. The organic framework according to claim 1, wherein the monomers further comprise: 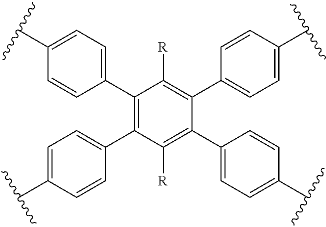
(“B group”), wherein each R is individually chosen from hydrogen, methoxy groups, ethoxy groups, alkoxy groups, alkylamino groups, alkyl ester groups, and alkyl groups; and each B group is covalently bonded to one or more A group.

3. The organic framework according to claim 2, wherein the B group has the following structure:

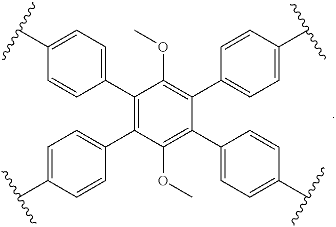 [SMILES: *c1ccc(-c2c(OC)c(-c3ccc(*)cc3)c(-c3ccc(*)cc3)c(OC)c2-c2ccc(*)cc2)cc1]

4. The organic framework according to claim 3, comprising:

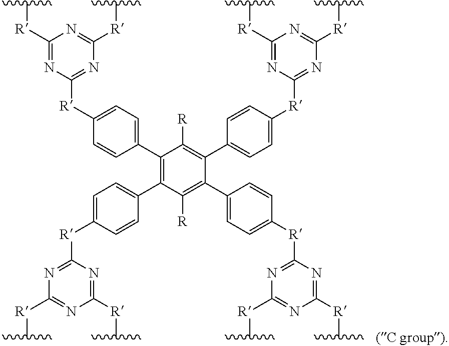

5. The organic framework according to claim 4, comprising:

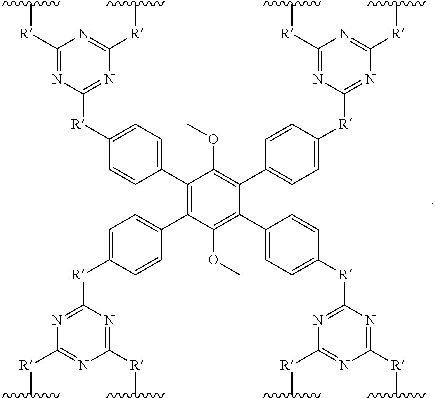

6. The organic framework according to claim 5, wherein the C groups are connected to other C groups via a crosslinking group.

7. The organic framework according to claim 5, comprising: 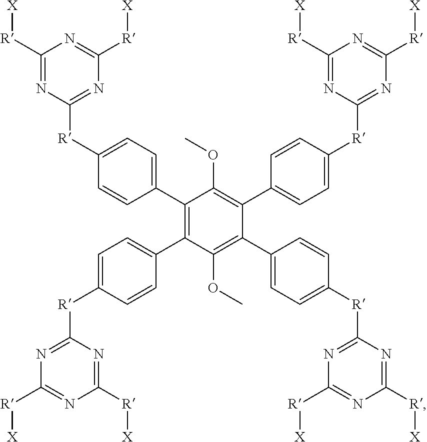
wherein each X is independently chosen from 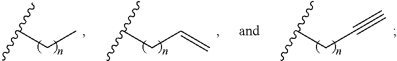
and n is 1, 2, or 3.

8. The organic framework according to claim 7, wherein the monomers are crosslinked via NO₃⁻ ions.

9. The organic framework according to claim 6, wherein the crosslinked C groups have NO₃⁻ bound thereto.

10. The organic framework according to claim 6, wherein the crosslinked C groups have I₂ and/or I⁻ and/or I₃⁻ bound thereto.

11. The organic framework according to claim 6, wherein the crosslinking group has the following structure: 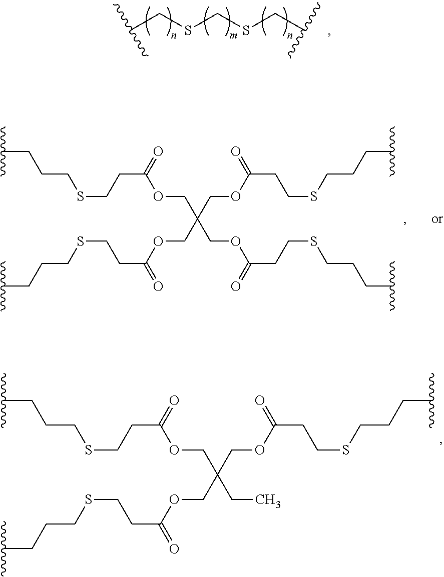
wherein n is 2 to 8 and m is 1 to 8.

12. The organic framework according to claim 11, wherein the crosslinking group has the following structure:

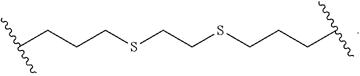 [SMILES: *CCCSCCSCCC*]

13. The organic framework according to claim 1, wherein the organic framework defines one or more apertures.

14. The organic framework according to claim 13, wherein the aperture has a longest linear dimension of 3-15 Å.

15. The organic framework according to claim 13, wherein the aperture is 6 Å×12 Å.

16. An article of manufacture comprising an organic framework according to claim 1.

17. The article of manufacture according to claim 16, wherein the article is a vessel, a column, a centrifuge tube, a filter, a fritted funnel, a syringe, or a filtration membrane.

18. A method for removing I₂ and/or I⁻ comprising contacting a medium comprising I₂ and/or I⁻ with an organic framework according to claim 1.

19. The method according to claim 18, wherein the medium is water.

20. The method according to claim 18, wherein the organic framework is a plurality of single crystals.

21. The method according to claim 18, wherein an article comprises the organic framework or the organic framework is disposed on a surface of the article.

22. The method according to 18, wherein the contacting is performed at a temperature greater than room temperature.

23. The method according to claim 22, wherein the temperature is at least 90° C.
